(19) United States
(12) Patent Application Publication
(10) Pub. No.: US 2026/0109162 A1
(43) Pub. Date: Apr. 23, 2026

(54) PRINTING DEVICE

(71) Applicant: SEIKO EPSON CORPORATION, TOKYO (JP)

(72) Inventors: Hirohisa KODAIRA, MATSUMOTO-SHI (JP); Yutaro HARADA, SHIOJIRI-SHI (JP); Chiaki SHIMADA, AZUMINO-SHI (JP)

(21) Appl. No.: 19/366,628

(22) Filed: Oct. 23, 2025

(30) Foreign Application Priority Data
Oct. 23, 2024 (JP) 2024-186460

(51) Int. Cl. B41J 13/00; B41J 3/60; B65H 7/02; B65H 29/60

(52) U.S. Cl. CPC B41J 13/0009; B41J 3/60; B65H 7/02; B65H 29/60; B65H 2601/11; B65H 2601/255

(57) ABSTRACT

A printing device includes two stackers ST1 and ST2. The first stacker ST1 is discharged with one surface of a medium facing upward. The second stacker ST2 is discharged with the other surface of the medium facing upward. In the case of double-sided printing and the discharge destination of the medium is the first stacker ST1, a page to be printed on a first surface P1 is set to a first page, and a page to be printed on a second surface P2 is set to a second page. In a case of the discharge destination of the medium is to be switched from the first stacker ST1 to the second stacker ST2 during printing, the pages to be printed on the first surface P1 are set to the second pages, and the pages to be printed on the second surface P2 are set to the first pages.

The present application is based on, and claims priority from JP Application Serial Number 2024-186460, filed Oct. 23, 2024, the disclosure of which is hereby incorporated by reference herein in its entirety.

### BACKGROUND

### 1. Technical Field

The present disclosure relates to a printing device including a transport section that transports a medium, a printing section that performs printing on the medium, and a stacker on which the discharged medium is stacked.

### 2. Related Art

For example, JP-A-6-127810 discloses a printing device including a transport section that transports a medium, a printing section that performs printing on the medium, and a plurality of stackers to which the printed medium is discharged. The printing device includes two paper discharge trays and a large-capacity paper sheet discharge device as the plurality of stackers. The two discharge trays function as a first stacker that discharges the medium with one surface of the medium facing upward and a second stacker that discharges the medium with the other surface opposite to the one surface facing upward. In this printing device, a stacker as a discharge destination to which the medium is discharged during printing is switched between the discharge trays and the large-capacity paper sheet discharge device.

However, in the printing device described in JP-A-6-127810, the discharge destination of the medium is not switched between two paper discharge trays functioning as the first stacker and the second stacker during printing. For example, in a case of the discharge destination of a medium M is switched between the first stacker and the second stacker, the page order, the orientation of a print surface, or the like is not aligned between a medium bundle discharged to the first stacker and a medium bundle discharged to the second stacker. Therefore, in a case of a user collects two medium bundles into one medium bundle, there is a problem that the user needs to perform an alignment operation of the medium, which may lead to a decrease in workability.

### SUMMARY

A printing device solves the above problem includes a printing section configured to perform printing on a medium; a transport section configured to transport the medium in a transport direction; a first stacker that is provided downstream of the printing section in the transport direction and to which the medium is discharged in a state where one surface of the medium faces upward; and a second stacker that is provided downstream of the printing section in the transport direction and to which the medium is discharged in a state where an other surface, which is a surface opposite to the one surface, faces upward, wherein assuming that in a case of double-sided printing, among the surfaces of the medium, a surface to be printed first is a first surface and a surface to be printed later is a second surface and assuming that in a case where a discharge destination of the medium is the first stacker, a page to be printed on the first surface is a first page, and a page to be printed on the second surface is a second page, then when the discharge destination of the medium is switched from the first stacker to the second stacker during printing, with respect to the medium that is to be discharged to the second stacker, a page to be printed on the first surface is set to the second page and a page to be printed on the second surface is set to the first page.

A printing device solves the above problem includes a printing section configured to perform printing on a medium; a transport section configured to transport the medium in a transport direction; a first stacker that is provided downstream of the printing section in the transport direction and to which the medium is discharged in a state where one surface of the medium faces upward; and a second stacker that is provided downstream of the printing section in the transport direction and to which the medium is discharged in a state where an other surface, which is a surface opposite to the one surface, faces upward, wherein assuming that in a case of double-sided printing, among the surfaces of the medium, a surface to be printed first is a first surface and a surface to be printed later is a second surface and assuming that in a case where a discharge destination of the medium is the first stacker, a page to be printed on the first surface is a first page, and a page to be printed on the second surface is a second page, then when the discharge destination of the medium is switched from the first stacker to the second stacker during printing, with respect to the medium that is to be discharged to the second stacker, a printing order is set in a descending order from a last page of all of the medium, and also a page to be printed on the first surface is set to the first page and a page to be printed on the second surface is set to the second page.

A printing device solves the above problem includes a printing section configured to perform printing on a medium; a transport section configured to transport the medium in a transport direction; a first stacker that is provided downstream of the printing section in the transport direction and to which the medium is discharged in a state where one surface of the medium faces upward; a second stacker that is provided downstream of the printing section in the transport direction and to which the medium is discharged in a state where an other surface, which is a surface opposite to the one surface, faces upward; and an inversion path that is provided downstream of the printing section in the transport direction and that is configured to invert the front and back of the medium, wherein assuming that in single-sided printing, a surface to be printed on is a first surface, then when the discharge destination of the medium is switched from the first stacker to the second stacker during printing, the medium that is to be discharged to the second stacker is set to be, after the first surface is printed on, transported to the inversion path and then discharged.

### BRIEF DESCRIPTION OF THE DRAWINGS

FIG. 1 is a schematic front view of a printing device according to a first embodiment, with a part of the printing device being cut away.

FIG. 2 is a schematic front cross-sectional view showing a transport state of a medium during single-sided printing.

FIG. 3 is a schematic front cross-sectional view showing a transport state of the medium during single-sided printing.

FIG. 4 is a schematic front cross-sectional view showing a transport state of the medium during double-sided printing.

FIG. 5 is a schematic front cross-sectional view showing a transport state of the medium during double-sided printing.

FIG. 6 is a schematic side view showing a stack sensor that detects a medium bundle stacked on a stacker.

FIG. 7 is a schematic side view showing the stack sensor that detects the medium bundle stacked on the stacker.

FIG. 8 is a block diagram showing an electrical configuration of the printing device.

FIG. 9 is a schematic diagram showing a flow of process in a stacker switch control during double-sided printing in a first comparative example.

FIG. 10 is a schematic diagram showing a flow of process in a stacker switch control during double-sided printing in a first example.

FIG. 11 is a schematic diagram showing a medium bundle stacked on a stacker in the stacker switch control according to the first comparative example.

FIG. 12 is a schematic diagram showing a medium bundle stacked on a stacker in the stacker switch control in the first example.

FIG. 13 is a schematic diagram showing the orientation of the medium bundle discharged to two stackers.

FIG. 14 is a schematic plan view of the two stackers shown in FIG. 13 as viewed from above.

FIG. 15 is a schematic diagram showing print job data and reconstruction data for the stacker switch control.

FIG. 16 is a schematic diagram showing notification information displayed on a display section.

FIG. 17 is a schematic diagram showing a flow of process in a stacker switch control during double-sided printing in a second comparative example.

FIG. 18 is a schematic diagram showing a flow of process in a stacker switch control during double-sided printing in a second example.

FIG. 19 is a schematic diagram showing a medium bundle stacked on a stacker in the stacker switch control during double-sided printing in the second comparative example.

FIG. 20 is a schematic diagram showing a medium bundle stacked on a stacker in the stacker switch control during double-sided printing in the second example.

FIG. 21 is a schematic diagram showing a flow of process in a stacker switch control during single-sided printing in a third comparative example.

FIG. 22 is a schematic diagram showing a flow of process in a stacker switch control during single-sided printing in a third example.

FIG. 23 is a schematic diagram showing a medium bundle stacked on a stacker in the stacker switch control during single-sided printing in the third comparative example.

FIG. 24 is a schematic diagram showing a medium bundle stacked on a stacker in the stacker switch control during single-sided printing in the third example.

FIG. 25 is a schematic diagram showing a flow of process in a stacker switch control during single-sided printing in a fourth comparative example.

FIG. 26 is a schematic diagram showing a flow of process in a stacker switch control during single-sided printing in a fourth example.

FIG. 27 is a schematic diagram showing a medium bundle stacked on a stacker in the stacker switch control during single-sided printing in the fourth comparative example.

FIG. 28 is a schematic diagram showing a medium bundle stacked on a stacker in the stacker switch control during single-sided printing in the fourth example.

FIG. 29 is a schematic diagram showing a flow of process in a stacker switch control during double-sided printing in a fifth example in a second embodiment.

FIG. 30 is a schematic diagram showing a medium bundle stacked on a stacker in the stacker switch control during single-sided printing according to the fifth example.

FIG. 31 is a schematic diagram showing notification information displayed on the display section.

FIG. 32 is a schematic diagram showing a flow of process in a stacker switch control during double-sided printing in a sixth example in the second embodiment.

FIG. 33 is a schematic diagram showing a medium bundle stacked on a stacker in the stacker switch control during double-sided printing according to the sixth example.

FIG. 34 is a schematic diagram showing notification information displayed on the display section.

FIG. 35 is a schematic front view of a printing device including a post-processing device according to a third embodiment, with a part of the printing device being cut away.

FIG. 36 is a block diagram showing an electrical configuration of the printing device including the post-processing device.

### DESCRIPTION OF EMBODIMENTS

### First Embodiment

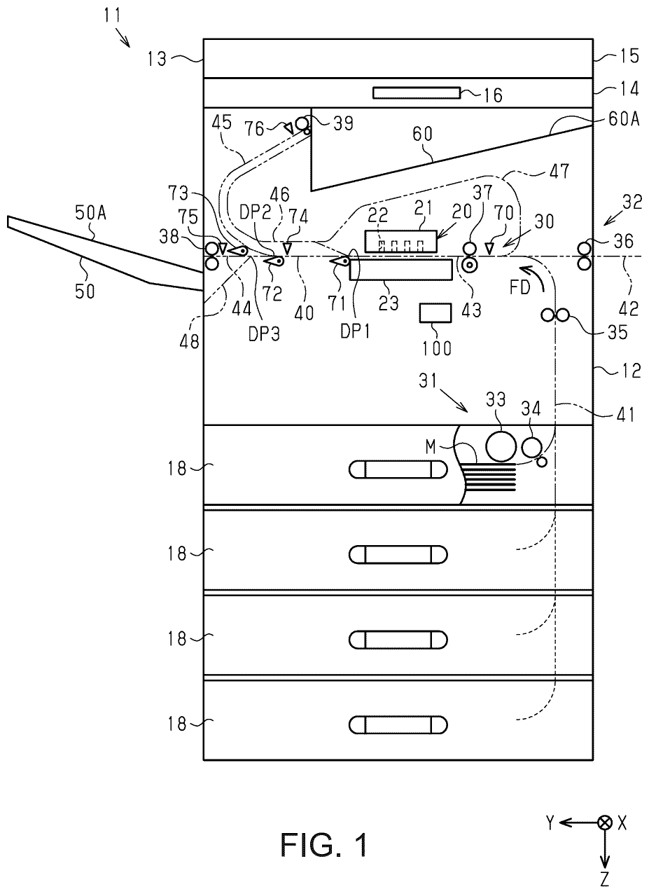

Hereinafter, a first embodiment of a printing device will be described with reference to FIG. 1 to FIG. 28. In FIG. 1 to FIG. 5, assuming that a printing device 11 is placed on a horizontal plane, the direction of gravity is indicated by a Z-axis, and the directions along the horizontal plane are indicated by an X-axis and a Y-axis. The X-axis, the Y-axis, and the Z-axis are orthogonal to each other. In the following description, a depth direction X parallel to the X-axis is parallel to a width direction of a medium to be printed, and thus is also referred to as a width direction X. A direction parallel to the Z-axis is also referred to as a vertical direction Z.

As shown in FIG. 1, the printing device 11 of the present embodiment is, for example, an ink-jet printer. The printing device 11 includes a housing 12. The housing 12 may have a bottomed box shape that is open upward. An image reading section 13 may be disposed at the upper end of the housing 12 so as to cover the opening. The image reading section 13 is a scanner that reads a document. The image reading section 13 includes a scanner section 14 and a cover 15 that can be opened and closed with respect to a document table (not shown) constituting an upper surface of the scanner section 14. An automatic document feeder (not shown) capable of consecutively feeding the documents may be provided on the upper section of the cover 15. As described above, the printing device 11 may be a multifunction device including the image reading section 13 (scanner).

The printing device 11 may include a notification section that notifies information. The notification section may be, for example, a display section 16 that displays information. In FIG. 1, when the front side of the printing device 11 is defined as the front side, the display section 16 may be disposed at a position adjacent to the front side of the image reading section 13. The display section 16 may constitute a part of a operation panel. On a display screen of the display section 16, for example, various menus, various messages, and information such as the operation status of the printing device 11 are displayed. A user stands facing the front of the printing device 11, and can check the display content of the display section 16 and operate the operation panel.

The printing device 11 includes one or more medium accommodation sections 18 in a lower section of the housing 12. In the example shown in FIG. 1, the printing device 11 includes a plurality of (for example, three) medium accommodation sections 18. The medium accommodation section 18 can accommodate plural sheets of medium M. The medium accommodation section 18 may be, for example, a cassette. The medium accommodation section 18 is attachable to and detachable from the housing 12. The user removes the medium accommodation section 18 from the housing 12 to replenish the medium M and replace the medium M with medium M of a different type or size. Note that the type of the medium M includes plain paper, recycled paper, photographic paper, cardboard, and the like. The size of the medium M includes A4 size, A3 size, B5 size, and the like.

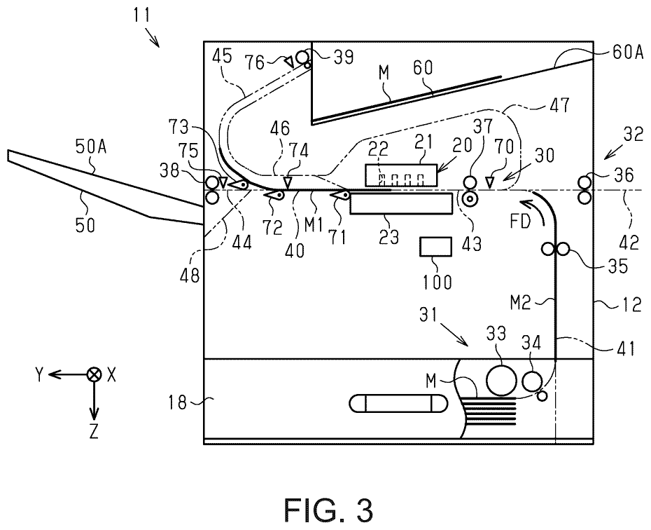

The printing device 11 includes a printing section 20 that performs printing on the medium M, and a transport section 30 that transports the medium M in a transport direction FD. The transport section 30 includes a transport path 40 along which the medium M is transported. The transport section 30 transports the medium M along the transport path 40. The transport section 30 includes a plurality of rollers 33 to 39 disposed along the transport path 40, and one or more motors as drive sources to drive the plurality of rollers 33 to 39. The motor includes a first feeding motor (not shown), which is a drive source of the rollers 33, 34 of a first feeding section 31, a second feeding motor (not shown), which is a drive source of the roller 36 of a second feeding section 32, and one or more transport motors 30M (see FIG. 3), which are drive sources of the rollers 35 to 39 of the transport system.

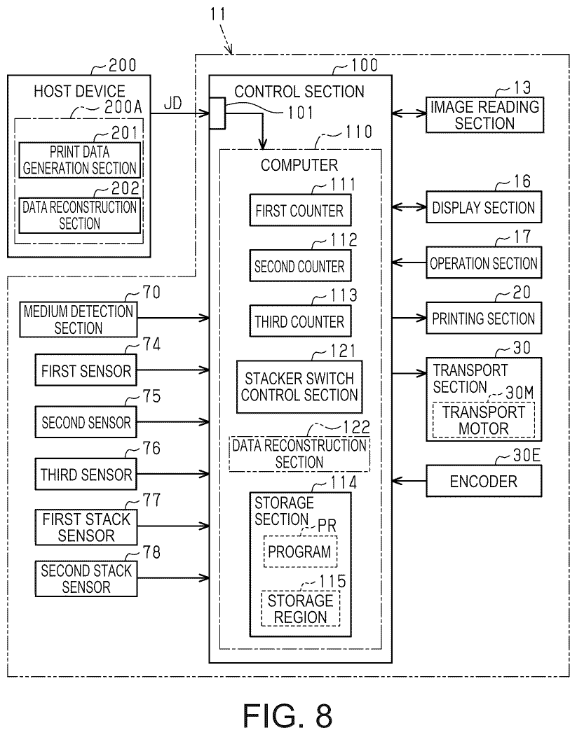

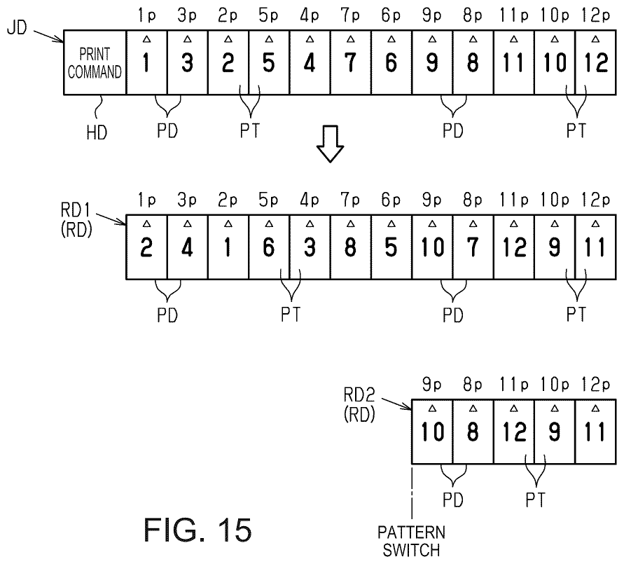

The printing device 11 includes a control section 100. The control section 100 controls the printing device 11. The control section 100 controls the display section 16, the printing section 20, and the transport section 30. The control section 100 receives print job data JD (see FIG. 8 and FIG. 15) from a host device 200 (see FIG. 8) that is communicably connected to the printing device 11. The print job data PD (hereinafter, also simply referred to as a “print job JD”) is a print instruction from the user to the printing device 11. The control section 100 controls the printing device 11 based on the print job JD. The print job JD includes print surface information indicating whether the print surface of the medium M is a single surface or both surfaces, number of print sheets information indicating the number of print sheets, and discharge destination information indicating a stacker (tray) of a discharge destination. The control section 100 can perform, based on the print job JD, single-sided printing in which printing is consecutively performed on only one side of plural sheets of medium M or double-sided printing in which printing is consecutively performed on both sides of plural sheets of medium M.

As shown in FIG. 1, the printing section 20 is disposed at a position facing the transport path 40 at a printing position in the middle of the transport path 40. A support member 23 capable of supporting the medium M is disposed at a position on the opposite side of the printing section 20 with the transport path 40 interposed therebetween. The support member 23 may be a transport belt or a platen. The printing section 20 prints characters or images on the medium M transported along the transport path 40. The printing device 11 includes two stackers 50 and 60 to which the printed medium M is discharged. The printed medium M is discharged to one of the two stackers 50 and 60. One of the two stackers 50 and 60, which is the discharge destination, is designated by the print job JD. In the present embodiment, when a predetermined condition indicating that transport to one of the stackers is not possible is established while the print job is being executed, the stacker of the discharge destination may be switched to the other of the two stackers 50 and 60. Note that the stacker switch control will be described in detail later.

The printing section 20 has a print head 21. The print head 21 has one or more nozzles 22 that open on a surface (nozzle forming surface) facing the transport path 40. The print head 21 in the example shown in FIG. 1 has a plurality of nozzles 22. The plurality of nozzles 22 may include, for example, a nozzle that ejects black ink. The plurality of nozzles 22 may include a plurality of nozzles that individually eject a plurality of colors of ink for color printing.

The printing device 11 may be a line printer or a serial printer. In a case where the printing device 11 is a line printer, the print head 21 is configured by a line head. The line head has an elongated shape having a length in which printing can be performed on the entire region in the width direction of the medium M having an assumed maximum width in the width direction X parallel to the width direction of the medium M. The nozzles 22 are arranged at a constant nozzle pitch in the width direction X for each type of ink (ink color) to be ejected. The print head 21 formed of the line head can simultaneously eject ink to the entire region in the width direction of the medium M. The transport section 30 transports the medium M at a constant transport speed according to a printing mode. The printing section 20 prints on the medium M by ejecting ink from the nozzles 22 toward the medium M transported at a constant transport speed.

On the other hand, in a case where the printing device 11 is the serial printer, the printing section 20 includes a carriage that is movable in the width direction X (scanning direction). The print head 21 is mounted on the carriage in a state of facing the transport path 40. Printing is performed on the medium M by alternately performing a printing operation for one pass performed by the print head 21 ejecting ink from the nozzles 22 in the process of the carriage moving in the scanning direction and a transport operation of transporting the medium M in the transport direction FD to the printing position of the next pass.

### Configuration of Transport Path 40

Next, the transport path 40 will be described with reference to FIG. 1. The transport path 40 includes two feed paths 41 and 42, a print path 43, and two discharge paths 44 and 45. The two feed paths 41 and 42 are positioned upstream of the print path 43 in the transport direction FD. The two discharge paths 44 and 45 are positioned downstream of the print path 43 in the transport direction FD. The two feed paths 41 and 42 are different paths having different supply sources of the medium M. When the two feed paths 41 and 42 are distinguished from each other, one will be referred to as the first feed path 41 and the other as the second feed path 42. The two discharge paths 44 and 45 are paths having different stackers 50 and 60 as discharge destinations of the medium M. When the two discharge paths 44 and 45 are distinguished from each other, one will be referred as the first discharge path 44 and the other as the second discharge path 45.

The print path 43 is a path including the printing position facing the printing section 20. The printing section 20 performs printing on the medium M in the process of being transported along the print path 43. The printing device 11 may have a single-sided printing function of printing on one side (first surface) of the medium M. The printing device 11 may have a double-sided printing function of printing on both sides (first surface and second surface) of the medium M. The printing device 11 of the present embodiment has a single-sided printing function and the double-sided printing function.

The transport path 40 in the printing device 11 having the double-sided printing function further includes a switchback path 46 and an inversion path 47. The switchback path 46 is provided downstream of the print path 43. The print path 43 branches into a first discharge path 44 and the switchback path 46 at a branch position DP1 at a downstream edge thereof. The inversion path 47 is a path for transporting the medium M to a position upstream of the printing section 20 while inverting the medium M. The downstream edge of the inversion path 47 join at a position on the upstream side of the printing section 20 in the print path 43.

The first discharge path 44, which is one of the branch destinations of the print path 43 branching at the branch position DP1, branches from the second discharge path 45 at a branch position DP2 in the middle of the first discharge path 44. Further, the first discharge path 44 may branch off from a third discharge path 48 at a branch position DP3 downstream of the branch position DP2.

Path selection members 71 to 73 (flaps) capable of selecting a path through which the medium M is transported are disposed at positions corresponding to the branch positions DP1 to DP3. The first path selection member 71 selects at the branch position DP1 either the first discharge path 44 or the switchback path 46 as a path of the transport destination of the medium M. The second path selection member 72 selects at the branch position DP2 either the first discharge path 44 or the second discharge path 45 as a path of the transport destination of the medium M. The third path selection member 73 selects at the branch position DP3 either the first discharge path 44 or the third discharge path 48 as a path of the transport destination of the medium M. A path of the discharge destination of the medium M on which printing was performed is selected by the path selection members 71 to 73.

The first path selection member 71 selects the first discharge path 44 as a path through which the medium M on which all printing of one surface or both surfaces is completed is discharged. For the medium M on which printing was completed on the first surface (one side) when single-sided printing is designated, or for the medium M on which printing was completed on both sides of the first surface and the second surface when double-sided printing is designated, the first discharge path 44 is selected by the path selection member 71 as the path of the discharge destination.

On the other hand, for the medium M on which printing was completed on only the first surface (one side) using double-sided printing, the switchback path 46 is selected as the path of the discharge destination by the first path selection member 71. The medium M is transported in a switchback transport in which the medium M is sent downstream along the switchback path 46 and then sent back upstream. By this switchback transport, the medium M is transported to the inversion path 47 with a trailing edge thereof as a leading edge.

The second path selection member 72 selects either the first discharge path 44 or the second discharge path 45 as a path of discharge destination according to one of the two stackers 50 and 60 to which the medium M is to be discharged. When the discharge destination of the medium M is the stacker 50, the third path selection member 73 selects the first discharge path 44 as the path of the discharge destination. Note that when the printed medium M is discharged to a device other than the stacker 50 and 60, the third path selection member 73 selects the third discharge path 48 as the discharge destination of the medium M.

### Configuration of Transport Section 30

Next, the configuration of the portion other than the transport path 40 of the transport section 30 will be described with reference to FIG. 1. As shown in FIG. 1, the transport section 30 includes a first feeding section 31 and a second feeding section 32. The first feeding section 31 performs a feeding operation of sending out the medium M accommodated in the medium accommodation section 18 downstream in the transport direction FD one sheet at a time. The first feeding section 31 has the feed roller 33 that feeds the uppermost single sheet of medium M in the medium accommodation section 18. The feed roller 33 may be, for example, a pickup roller (pick roller). The separation roller pair 34 is disposed downstream of the feed roller 33 in the transport direction FD. The separation roller pair 34 separates the medium M into individual sheets. The separated single sheet of medium M is transported downstream in the transport direction FD along the first feed path 41 by one or more transport roller pairs 35 provided along the first feed path 41.

The second feeding section 32 feeds the medium M from the outside to the inside of the housing 12. The second feeding section 32 includes the feed roller 36 that feeds the medium M along the second feed path 42. The second feeding section 32 feeds, for example, the medium M placed on a medium placement section (not shown) attached to the outside of the housing 12 along the second feed path 42. The medium placement section may be, for example, a feed tray. The second feeding section 32 may be configured to feed one medium M placed on the feed tray, or may be configured to feed plural sheets of medium M placed on the feed tray one sheet at a time. The second feed path 42 may be connected to a large-capacity medium supply device (not shown) disposed outside the housing 12. In this case, the second feeding section 32 may be configured to feed the medium M supplied one sheet at a time from the large-capacity medium supply device along the second feed path 42. Note that the printing device 11 may separately include a feed path for the feed tray and a feed path for the large-capacity medium supply device. In this case, the two feed paths may be configured to join each other in the middle and then be connected to the print path 43.

The transport section 30 has a plurality of transport roller pairs 35 disposed along the path in a portion other than the feed paths 41 and 42 in the transport path 40. The transport section 30 has a transport roller 37 (resist roller) at a position upstream of the printing section 20 in the transport direction FD. The transport roller 37 performs skew removal of the medium M before the medium M is transported to the printing section 20. The transport roller 37 is positioned downstream of the joining position of the print path 43 and the inversion path 47. Therefore, the skew removal can also be performed on the medium M that was inverted through the inversion path 47.

As shown in FIG. 1, the printing device 11 includes a medium detection section 70 at a position upstream of the printing section 20 in the transport direction FD on the transport path 40. The medium detection section 70 detects a leading edge or the trailing edge of the medium M. When the medium detection section 70 detects the leading edge of the medium M, the leading edge of the medium M reaches the transport roller 37 immediately after the detection, and the skew removal of the medium M is performed by the transport roller 37. The transport roller 37 that has finished skew removal rotates, and transports the medium M toward the printing position where printing is performed by the printing section 20. The control section 100 acquires the position of the medium M on the transport path 40 by measuring the transport distance by which the medium M is transported, with the position of the medium M detected by the medium detection section 70 as a starting point.

As shown in FIG. 1, the printing device 11 includes a plurality of (for example, three) sensors 74 to 76 capable of detecting the medium M on the transport path 40 at a position downstream of the printing section 20 in the transport direction FD. The three sensors 74 to 76 are a first sensor 74, a second sensor 75, and a third sensor 76. The first sensor 74 is a sensor that can detect that the trailing edge of the medium M has passed through the branch position DP1. The second sensor 75 is a that sensor can detect the medium M on the first discharge path 44 at a position downstream of the branch position DP2. The third sensor 76 is a sensor that can detect the medium M on the second discharge path 45 at a position downstream of the branch position DP2.

### About Two Stackers

Next, the two stackers to which the medium M is discharged will be described with reference to FIG. 1. The two stackers 50 and 60 are provided downstream of the printing section 20 in the transport direction FD. One of the two stackers is the face-up stacker 50 to which the medium is discharged in a state where the print surface (face) on which printing was performed last before the medium is discharged faces upward. The other of the two stackers is the face-down stacker 60 to which the medium is discharged in a state where the print surface (face) on which printing was performed last before the medium is discharged faces downward.

In a case of single-sided printing, the medium is discharged to the face-up stacker 50 with the print surface facing upward. The medium is discharged to the face-down stacker 60 in a state where the print surface faces downward.

Assuming that in a case of double-sided printing, among the surfaces of the medium M, a surface to be printed first is the first surface and a surface to be printed later is the second surface. The medium M is discharged to the face-up stacker 50 in a state where the print surface on which printing was performed on the second surface of the medium M faces upward. The medium M is discharged to the face-down stacker 60 in a state where the print surface on which printing was performed on the second surface of the medium M faces downward.

### Printing Operation in Single-Sided Printing

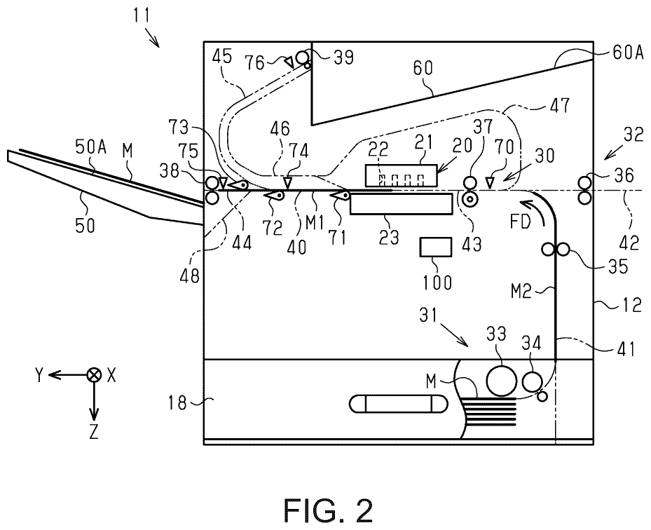

Next, single-sided printing in the printing device 11 will be described with reference to FIG. 2 and FIG. 3. FIG. 2 shows a case where the discharge destination of the medium M is the face-up stacker 50. FIG. 3 shows a case where the discharge destination of the medium M is the face-down stacker 60. In each drawing, the sheets of medium M being transported in the housing 12 are labeled by reference symbols M1 and M2 in the order of being fed. Note that hereinafter, the face-up stacker 50 is also referred to as “FU stacker 50”, and the face-down stacker 60 is also referred to as “FD stacker 60”.

As shown in FIG. 2, the medium M fed from the medium accommodation section 18 is discharged to the FU stacker 50 through the first feed path 41, the print path 43, and the first discharge path 44. The medium M is stacked on a stack surface 50A of the FU stacker 50 in a state in which the print surfaces face upward.

As shown in FIG. 3, the medium M fed from the medium accommodation section 18 is discharged to the FD stacker 60 through the first feed path 41, the print path 43, the first discharge path 44, and the second discharge path 45. The medium M is stacked on a stack surface 60A of the FD stacker 60 in a state where the print surfaces face downward.

### Printing Operation Using Double-Sided Printing

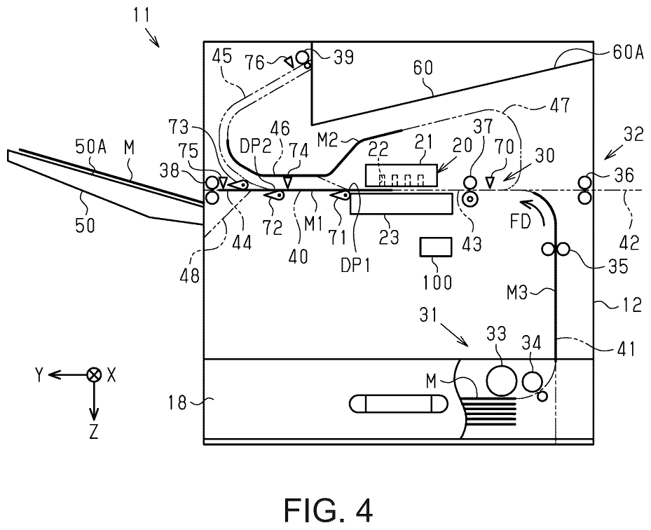

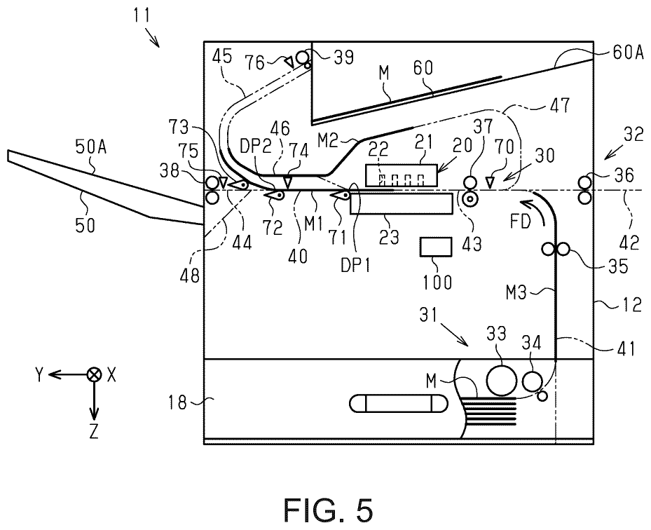

Next, double-sided printing in the printing device 11 will be described with reference to FIG. 4 and FIG. 5. FIG. 4 shows a case where the discharge destination of the medium M is the FU stacker 50. FIG. 5 shows a case where the discharge destination of the medium M is the FD stacker 60. In each drawing, the sheets of medium M being transported in the housing 12 are labeled by reference symbols M1, M2, and M3 in the order of being fed.

As shown in FIG. 4, the medium M fed from the medium accommodation section 18 is discharged to the FU stacker 50 through the first feed path 41, the print path 43, the first discharge path 44, and the second discharge path 45. The medium M is stacked on a stack surface 50A of the FU stacker 50 in a state in which the print surfaces face upward.

### About Stacker Switching

In the printing device 11 of the present embodiment, the discharge destination of the medium M may be switched from the first stacker ST1 to the second stacker ST2 during printing. When a predetermined condition is satisfied during printing, the control section 100 switches the discharge destination of the medium M from the first stacker ST1 to the second stacker ST2. Either the FU stacker 50 or the FD stacker 60 designated as the discharge destination in the print job JD is set as the first stacker ST1. When the first stacker ST1 is the FU stacker 50, the second stacker ST2 is the FD stacker 60. On the contrary, when the first stacker ST1 is the FD stacker 60, the second stacker ST2 is the FU stacker 50. That is, one of the two stackers 50 and 60 to which the medium M is discharged first is the first stacker ST1, and the other to which the medium M is discharged later, after the discharge destination stacker is switched, is the second stacker ST2.

The user designates printing conditions when instructing the printing device 11 to perform printing. The printing conditions include the type, size, print color, and print surface of the medium M. The printing conditions further include information about the stacker (tray), which is the discharge destination. The stacker of the discharge destination may be selected and designated by the user, or may be automatically selected on the printing device 11 side in a case of the tray automatic selection is set. In either case, the information is included in print condition information as information relating to the stacker (tray) of the discharge destination. The stacker designated as the discharge destination in the print condition information is the first stacker ST1, and the stacker that is a switching destination in a case of the stacker needs to be switched is the second stacker ST2. Note that switch condition for switching the stacker will be described later.

### About Detection of Stack Amount of First Stacker ST1

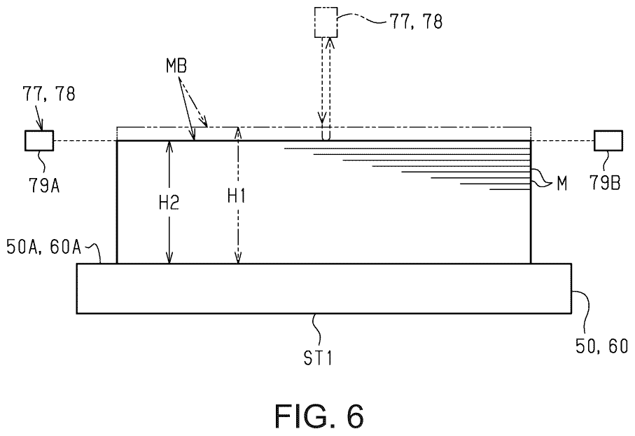

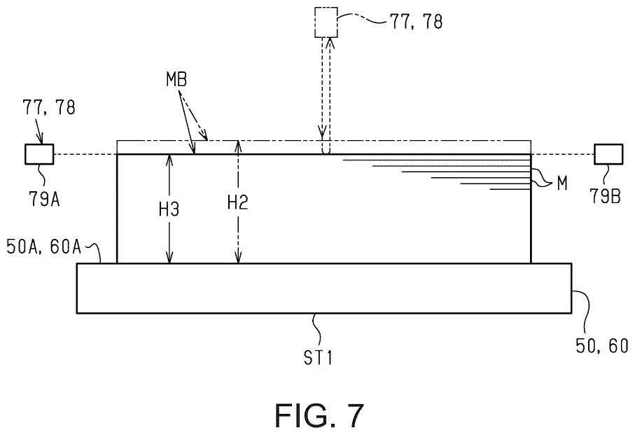

Next, a configuration for detecting a stack amount of the first stacker ST1 will be described with reference to FIG. 6 and FIG. 7. The printing device 11 includes a detection section that detects the stack amount of the first stacker ST1. In the present embodiment, it includes a first stack sensor 77 and a second stack sensor 78 shown in FIG. 6 and FIG. 7 as the detection section. The first stack sensor 77 detects the stack amount of the FU stacker 50. The second stack sensor 78 detects the stack amount of the FD stacker 60.

When the first stacker ST1 is the FU stacker 50, the first stack sensor 77 is the detection section. When the first stacker ST1 is the FD stacker 60, the second stack sensor 78 is the detection section. The detection methods of the two stack sensors 77 and 78 serving as the detection sections may be the same or different.

FIG. 6 and FIG. 7 show an example in which the two stack sensors 77 and 78 use the same detection method. The maximum amount of the stack amount (maximum stack amount) of each of the stackers 50 and 60 may be the same or different. The maximum stack amount of each of the stackers 50 and 60 is set to a second height corresponding to a first height, which is a height from the lower end of the stack surfaces 50A and 60A to a discharge port. The stack surfaces 50A and 60A are inclined surfaces whose positions are higher toward the downstream side in the discharge direction of the medium M. The higher a medium bundle is stacked on the stack surfaces 50A and 60A, the earlier the timing at which the medium M to be discharged from the discharge port contacts the upper surface of the medium bundle and receives frictional resistance from the upper surface. The maximum amount is set to the maximum height that can ensure the edge section of the medium bundle is aligned despite this type of frictional resistance. Therefore, the maximum amount (nominal maximum amount) set by the manufacturer is set to a height lower, by a margin number of sheets, than the maximum amount (actual maximum amount) of the limit that can be actually aligned.

FIGS. 6 and 7 show detection methods of the two stack sensors 77 and 78 used as detection sections that detect the stack amount of the first stacker ST1, without particularly distinguishing the difference in the maximum stack amount of each stacker 50 and 60. Therefore, in practice, an actual maximum amount H1 (FIG. 6) and the nominal maximum amount H2 (FIG. 7) are different between the FU stacker 50 and the FD stacker 60.

The first stack sensor 77 is a stack amount sensor that detects the stack amount of the FU stacker 50. When the FU stacker 50 is the first stacker ST1, the first stack sensor 77 as the detection section detects the stack amount of the first stacker ST1. The second stack sensor 78 is a stack amount sensor that detects the stack amount of the FD stacker 60. When the FD stacker 60 is the first stacker ST1, the second stack sensor 78 as the detection section detects the stack amount of the first stacker ST1. The stack amount detected by the stack sensors 77 and 78 may be the stacking height of the medium bundle MB or the number of stacked sheets of the medium bundle MB.

When it is detected that the stack amount of the first stacker ST1 is equal to or greater than a predetermined threshold during printing, the printing device 11 may be configured to switch the discharge destination of the medium M from the first stacker ST1 to the second stacker ST2. The threshold may be values smaller than the maximum amount that can be stacked on the first stacker ST1. Here, the maximum amount is the actual maximum amount H1. This is because, if the amount of the medium bundle is smaller (lower) than the actual maximum amount H1, or even if the amount of the medium bundle is larger (higher) than the nominal maximum amount, the alignment of the medium bundle is guaranteed. Therefore, the nominal maximum amount H2 may be the threshold (FIG. 6), a value smaller than the nominal maximum amount H2 may be the threshold (FIG. 7), or the threshold may be larger than the nominal maximum amount H2.

At the time when it is detected that the stack amount of the first stacker ST1 becomes equal to or larger than the threshold during printing, the medium M on which printing was performed, or on which printing is being performed, is present in the transport path 40 (see FIG. 2 to FIG. 5). The medium M that was printed on or, on which printing is being performed, in the transport path 40 at the time of the detection is printed in a printing order (page order) applied to the medium to be discharged to the first stacker ST1. Therefore, it is the medium that should be discharged later to the first stacker ST1. Further, after detection, a data construction process may be performed involving rearrangement of the print data to be printed on the medium M to be discharged to the second stacker ST2. In this case, even during the waiting time until the data construction process is completed, printing of the medium M progresses in the printing order in which the medium M should be discharged to the first stacker ST1.

Therefore, after detection, a predetermined number of sheets of medium M are discharged to the first stacker ST1. Even when a predetermined number of sheets of medium M is discharged after detection, the threshold is set to a value at which the stack amount of the first stacker ST1 does not exceed the maximum amount. That is, the threshold may be a value smaller than the maximum amount by a predetermined number of sheets. The predetermined number of sheets may be a predetermined value within a range of 1 to 5 sheets, for example.

FIG. 6 shows an example in which the maximum amount (nominal maximum amount) at the time of full stack is detected as a threshold. FIG. 7 shows an example of detecting the stack amount smaller than the maximum amount at the time of full stack. First, the detection method of the stack sensors 77 and 78 will be described, and then the threshold will be described.

As shown in FIG. 6 and FIG. 7, the stack sensors 77 and 78 may be a transmissive sensor indicated by solid line in the drawings or may be a reflective sensor indicated by two dot chain line in the drawings. The stack sensors 77 and 78 that are transmissive sensors are disposed at a predetermined height at which the upper end of the medium bundle at the stacking height of the detection target can be detected. The transmission type sensor includes a light emitting section 79A and a light receiving section 79B. The light emitted from the light emitting section 79A is blocked by the upper end of the medium bundle MB that reached the stacking height H2. As a result, the light receiving section 79B can no longer receive the light, thereby detecting that the medium bundle MB has reached the threshold.

On the other hand, the stack sensors 77 and 78 that are reflective sensors are, for example, distance sensors. The reflective sensor is disposed at an upper position facing the stack surfaces 50A and 60A of the stackers 50 and 60. The reflective sensor receives a reflected wave obtained by receiving a detection wave that was output toward the upper surface of the medium bundle MB (including when only one sheet of medium is present) stacked on the stack surfaces 50A and 60A of the stackers 50 and 60 and that was reflected from the upper surface The reflective sensor detects the distance to the upper surface of the medium bundle MB based on the detection signal of the received reflected wave. The reflected wave may be an electromagnetic wave (light) or a sound wave (sound) such as ultrasonic waves.

In the example shown in FIG. 6, the threshold detected by the stack sensors 77 and 78 is the nominal maximum amount H2 at the time of full stack. Even if the number of sheets is higher than the nominal maximum amount H2, there is a margin number of sheets that can guarantee the alignment of the medium bundle MB up to the actual maximum amount H1. The number of sheets is detected earlier by the margin number of sheets (=H1-H2) before the actual maximum amount H1 is reached. The margin number of sheets is larger than the predetermined number of sheets to be discharged to the first stacker ST1 after the stack amount detected by the stack sensors 77 and 78 reaches the threshold. In the example shown in FIG. 6, when the detection distance of the stack sensors 77 and 78 that are reflective sensors becomes equal to or less than the target distance when the medium bundle MB is at the stacking height H2, the control section 100 determines that the stack amount of the medium bundle MB is equal to or greater than the threshold.

In the example shown in FIG. 7, a threshold H3 detected by the stack sensors 77 and 78 is smaller than the nominal maximum amount H2 at the time of full stack. The number of sheets corresponding to the difference (H2-H3) is detected earlier before the full stack is reached. The difference in the number of sheets is set to a value equal to or greater than a predetermined number of sheets of the medium M to be discharged to the first stacker ST1 after detection of the threshold. In the example shown in FIG. 7, when the detection distance of the stack sensors 77 and 78 that are reflective sensors reaches the target distance when the medium bundle MD is at the stacking height H2, the control section 100 determines that the stack amount of the medium bundle MB has reached the threshold. Note that the threshold may be set for each type of medium M (medium type), may be set for each group of medium M thickness, or may be set to the number of sheets according to the medium M having the maximum thickness.

### Electrical Configuration of Printing Device 11

Next, an electrical configuration of the printing device 11 will be described with reference to FIG. 8.

As shown in FIG. 8, the printing device 11 includes the control section 100, the image reading section 13, the display section 16, an operation section 17, the printing section 20, and the transport section 30. The transport section 30 includes the transport motor 30M that is a drive source of the rollers 37 to 39 for transport (see FIG. 1). The printing device 11 includes, as an input system, the medium detection section 70, the first sensor 74, the second sensor 75, the third sensor 76, the first stack sensor 77, the second stack sensor 78, and an encoder 30E.

The display section 16 may be a touch panel. In this case, the touch panel function of the display section 16 may constitute a part or all of the operation section 17. A part or all of the operation section 17 may be a mechanical switch.

The control section 100 includes a computer 110. The computer 110 includes a first counter 111, a second counter 112, a third counter 113, and a storage section 114.

The first counter 111 counts a value indicating the position of the medium M on the transport path 40, with the position where the medium detection section 70 detects the medium M as a start point (origin). The first counter 111 is reset when the medium detection section 70 detects the medium M. For example, pulse edges of a pulse signal input from an encoder (not shown) that outputs a number of pulses proportional to the rotation amount of the transport motor 30M are counted.

The control section 100 estimates the current position of the medium M from the count value of the first counter 111. The control section 100 detects a jam of the medium M when any of the first to third sensors 74 to 76 does not detect the medium M even though the determination position (jam determination value) obtained by adding a predetermined margin to the estimated position is a position that should be detected by any of the first to third sensors 74 to 76.

The second counter 112 counts the number of stacked sheets of medium M stacked on the first stacker ST1. The printing device 11 may include a medium presence and absence sensor (not shown) that can detect the presence or absence of the medium M on the stack surface of the first stacker ST1. When the medium bundle is removed from the stack surface of the first stacker ST1 and the medium presence and absence sensor is in a non-detection state, the second counter 112 is reset. The control section 100 detects that the medium M was discharged to the first stacker ST1 based on the count value of the first counter 111 or on the detection signal of a discharge sensor. The control section 100 increments the second counter 112, for example, each time it is detected that the medium M is discharged to the first stacker ST1. The control section 100 acquires the stack amount (number of stacked sheets) of the first stacker ST1 from the count value of the second counter 112.

The third counter 113 counts the number of print start sheets on which the printing section 20 starts printing during printing in which printing of the number of print sheets instructed by the print job JD is executed. The third counter 113 is reset each time the control section 100 receives the print job JD. The third counter 113 increments the count value, for example, each time printing of one sheet is started during execution (during printing) of the print job JD. The third counter 113 counts the number of sheets for which printing has started for each print job JD. The count value of the number of sheets for starting printing is the total number of sheets of the number of sheets on which printing was completed and the number of sheets in which printing is ongoing. The control section 100 refers to the count value of the third counter 113 and specifies the medium M to which the printing order, which, in the stacker switch control, is applied to the medium to be discharged to the second stacker ST2, is applied.

The storage section 114 stores a program PR for controlling the printing device 11. The program PR includes a print control program, a stacker switch control program, and the like. The control section 100 (specifically, the computer 110) executes the program PR to perform print control and stacker switch control. The control section 100 functions as a print control section and a stacker switch control section by executing the program PR.

The storage section 114 includes a storage region 115 that temporarily stores the print job data JD. The storage region 115 may be limited to a storage capacity equal to or less than a certain value. In this case, the storage region 115 does not have a sufficient capacity to store the print job data JD for which the consecutively printing of a plurality of sheets is designated at a time, for example. The control section 100 may intermittently receive the print job data JD from the host device 200 via a communication interface 101 by the print data PD (see FIG. 15) for one page by packet communication or the like. The storage region 115 may have a capacity capable of storing the print data PD of a predetermined number of pages within a range of 2 to 5 pages.

The control section 100 is not limited to a controller that performs software processing for all the processes executed by itself. For example, the control section 100 may include a dedicated hardware circuit (for example, Application Specific Integrated Circuit (ASIC)) that performs a hardware process for at least a part of the process executed by itself. That is, the control section 100 can be configured as a circuit (circuitry) including one or more processors that operate according to a computer program (software), one or more dedicated hardware circuits that execute at least a part of the process of various processes, or a combination thereof. The processor includes a CPU and a memory, such as a RAM and a ROM, and the memory stores program code or instructions configured to cause the CPU to execute processes. The memory, that is, a computer-readable medium, includes any available medium that can be accessed by a general purpose or a special purpose computer.

The control section 100 realizes the stacker switch control section by software, but it is not limited to this, and it may be hardware or may be configured by cooperation of software and hardware.

The host device 200 is, for example, a personal computer, a smartphone, or the like. The host device 200 is communicably connected to the control section 100 via the communication interface 101 of the printing device 11. The host device 200 stores a print driver program. The host device 200 includes a print control unit 200A configured by software by the CPU executing the print driver program.

The print control unit 200A includes a print data generation section 201 and a data reconstruction section 202. The print control unit 200A also has a user interface control section (UI control section) (not shown) that displays a screen for the user to input print commands on a display section (not shown) of the host device 200. The UI control section receives print target data (for example, image file) and print condition information selected by the user operating an operation section (not shown) such as a keyboard or a mouse of the host device 200. The print condition information includes selection values for each item such as a print color (color/monochrome), a medium type, a medium size, a print surface (single surface/both surface), a number of print sheets, a printing quality (printing resolution), and a stacker (tray) of the discharge destination.

The print data generation section 201 generates the print job data JD (see FIG. 15) based on the print target data and the print condition information. The print job data JD includes one or more pieces of print data PD (see FIG. 15) in units of pages.

The data reconstruction section 202 performs a data reconstruction process of rearranging the order of the print data PD specified by the print job data JD. The data reconstruction section 202 performs, as the data reconstruction process, a pattern switch process of rearranging the printing order of images called pattern PT (see FIG. 15) to be printed on the medium M. The data reconstruction section 202 generates reconstruction data (switching pattern data) by the pattern switch process. In the stacker switch control, the control section 100 uses the reconstruction data RD to print the pattern on the medium M that should be discharged to the second stacker ST2, which is the switch destination. Note that the details of the print job data JD and the reconstruction data will be described later.

### Stacker Switch Condition

Next, the stacker switch condition will be described. The stacker switch control in which the discharge destination of the medium is switched from the first stacker ST1 to the second stacker ST2 during printing is executed by the control section 100 when one of the following conditions (a) to (c) is satisfied.

(a) A case where the stack amount of the first stacker ST1 becomes equal to or larger than a threshold that is smaller than the maximum amount.

(b) A case where a jam is detected during printing, in which the medium M that passed through the branch position DP2 between the first path, which is the discharge path to the first stacker ST1, and the second path, which is the discharge path to the second stacker ST2, cannot be discharged to the first stacker ST1.

(c) A case where a stacking abnormality of the first stacker ST1 is detected during printing.

When at least one of the above conditions (a) to (c) is satisfied, the printing device 11 switches the discharge destination of the medium M from the first stacker ST1 to the second stacker ST2 during printing. The conditions (a) to (c) will be described below.

### About Condition (a)

First, the condition (a) includes a case where one of the stack sensors 77 and 78 shown in FIG. 6 and FIG. 7 detected that the stack amount of the first stacker ST1 became equal to or larger than the threshold that is smaller than the maximum amount.

As shown in FIG. 6, it may detect the stacking height H2 when it reaches full stack. As shown in FIG. 7, it may detect the stacking height H3 when it will soon reach full stack.

Further, when the number of stacked sheets counted by the counter 112 becomes equal to or larger than the threshold (number of sheets threshold) that is smaller than the maximum number of sheets corresponding to the maximum amount, the control section 100 may determine that the stack amount of the first stacker ST1 has become equal to or larger than the threshold that is smaller than the maximum amount. In this manner, the counter 112 may configure a detection section that detects the stack amount.

Here, “maximum amount” applied in the condition (a) may be the actual maximum amount H1 or the nominal maximum amount H2. As long as the threshold is smaller than the actual maximum amount H1, the threshold may be a value less than the nominal maximum amount H2 at the time of full stack, may be the nominal maximum amount H2, or may be a value equal to or greater than the nominal maximum amount H2. The control section 100 detects or measures, for example, a timing when the stack amount of the first stacker ST1 is about to reach the maximum amount, based on the stack amount of the first stacker ST1 becoming equal to or greater than the threshold.

### About Condition (b)

Next, the condition (b) will be described. In the condition (b), it is assumed that a jam of the medium M is a stacker switch cause. Here, jam refers to a phenomenon in which the medium M is jammed in the middle of the transport path 40. In general, when a jam is detected, a jam error occurs and printing is interrupted. After the user removes the jammed medium M from the transport path 40, printing is resumed from the jammed page. In the present embodiment, in a case of the position where the jamming occurs is a path portion downstream of the branch position DP2, the control section 100 switches the discharge destination of the subsequent medium M from the first stacker ST1 to the second stacker ST2.

The printing device 11 may include a detection section that detects the jam of the medium M. The detection section is a jam detection section that detects jams. The jam detection section may be configured by the medium detection section 70 and the first to third sensors 74 to 76. The jam detection section detects jams that occur downstream of the branch position DP2 in the transport direction FD in the discharge paths 44 and 45. When the trailing edge of the medium M that caused the jamming in one of the two discharge paths 44 and 45 passes through the branch position DP2, the other discharge path to the second stacker ST2 is secured without being obstructed by the jam.

The transport path 40 includes, at a downstream position in the transport direction FD from the printing section 20, the first path for discharging the medium M to the first stacker ST1 and the second path for discharging the medium M to the second stacker ST2. When the first stacker ST1 is the FU stacker 50, the first path is the first discharge path 44, and the second path is the second discharge path 45. On the other hand, in a case of the first stacker ST1 is the FD stacker 60, the first path is the second discharge path 45, and the second path is the first discharge path 44.

The transport section 30 includes the path selection member 72 that selects the discharge destination of the medium M at the branch position DP2 between the first discharge path 44 and the second discharge path 45. The path selection member 72 selects either the first discharge path 44 or the second discharge path 45 as the discharge destination of the medium M.

When a jam is detected during printing, if it is detected that the jammed medium M has passed through the branch position DP2, the discharge destination of the medium M subsequent to the jammed medium M is switched from the first stacker ST1 to the second stacker ST2. Here, the jammed medium M has passed through the branch position DP2 refers to the trailing edge of the medium M passing through the branch position DP2 in the transport direction FD. That is, when the first sensor 74, which is capable of detecting the medium M at the branch position DP2, detects the trailing edge of the jammed medium M, the discharge path (second path) to the second stacker ST2 is secured.

The first counter 111 counts the position of the medium M on the transport path 40, with the position at which the medium detection section 70 detects the medium M as the origin. After the first sensor 74 detects that the trailing edge of the medium M has passed the branch position DP2, the control section 100 monitors the trailing edge position of the medium M from the count value of the first counter 111. When the second sensor 75 does not detect the trailing edge of the medium M even though the trailing edge position of the medium M has a value that has already passed the detection position of the second sensor 75 by a predetermined margin distance, it is determined that a jam of the medium M has occurred on the first discharge path 44.

On the other hand, in a case of the FD stacker 60 is the first stacker ST1, the control section 100 monitors the position of the trailing edge of the medium M on the transport path 40 from the count value of the first counter 111 after the first sensor 74 detects the passage of the trailing edge of the medium M at the branch position DP2. When the third sensor 76 does not detect the trailing edge of the medium M even though the trailing edge position of the medium M has a value that has already passed the detection position of the third sensor 76 by a predetermined margin distance, the control section 100 determines that a jam of the medium M has occurred on the second discharge path 45.

### About Condition (c)

Next, the condition (c) will be described. In the condition (c), in a case of a stacking abnormality of the first stacker ST1 is detected, the switch condition to the second stacker ST2 is satisfied. The printing device 11 includes a detection section that detects an abnormality of the first stacker ST1. An abnormality of the first stacker ST1 refers to a stacking abnormality in which the medium M cannot be appropriately stacked on the first stacker ST1. The detection section is a stacking abnormality detection section that detects stacking abnormalities. An abnormality of the first stacker ST1 may include an abnormality of the first stacker ST1 itself and an abnormality of the medium M discharged to the first stacker ST1. That is, an abnormality of the first stacker ST1 includes at least one of these two types of abnormalities.

When the first stacker ST1 is provided on the side surface of the housing 12, it may be of an openable and closable type, a detachable type, an assembling type, or the like. A first abnormality, which is an abnormality of the first stacker ST1 itself, may include a state in which the first stacker ST1 of the openable and closable type is in a closed state (storage state) or a half-open state. Further, the first abnormality may include an unmounted state in which the detachable first stacker ST1 is detached or it is mounted in the wrong manner. The first abnormality may include incomplete assembly of the assembly type first stacker ST1, a positional deviation of a predetermined amount or more from a normal position due to disengagement of a movable portion, or the like.

A second abnormality, which is an abnormality of the medium M discharged to the first stacker ST1, may include an abnormality in which the medium M is caught by the first stacker ST1 or a member or the like in the vicinity of the discharge port. Furthermore, the second abnormality may include a state in which the medium M is in an oblique posture in a state of floating from the stack surface of the first stacker ST1 or the upper surface of the preceding medium, excessive stacking deviation of the medium M, and the like. This type of second abnormality prevents the subsequent medium M from being appropriately stacked on the first stacker ST1. Therefore, when the abnormality of the first stacker ST1 is detected during printing, the printing device 11 switches the discharge destination of the medium M from the first stacker ST1 to the second stacker ST2.

The stacking abnormality detection section is provided for each of the FU stacker 50 and the FD stacker 60, and detects the first abnormality or the second abnormality of each of the FU stacker 50 and the FD stacker 60. The stack sensors 77 and 78 may also serve as the stacking abnormality detection section, for example. For example, when the state in which the stack sensors 77 and 78 detect the medium M continues for a predetermined time or more even though the number of stacked sheets in the first stacker ST1 based on the count value of the second counter 112 is less than the threshold, the control section 100 may determine that a stacking abnormality was detected. Note that a sensor dedicated to detecting stacking abnormalities, which detects at least one of the first abnormality and the second abnormality, may be provided separately from the stack sensors 77 and 78.

### Operation of the First Embodiment

Hereinafter, an example of performing the stacker switch control by applying the conditions (a) to (c) will be described.

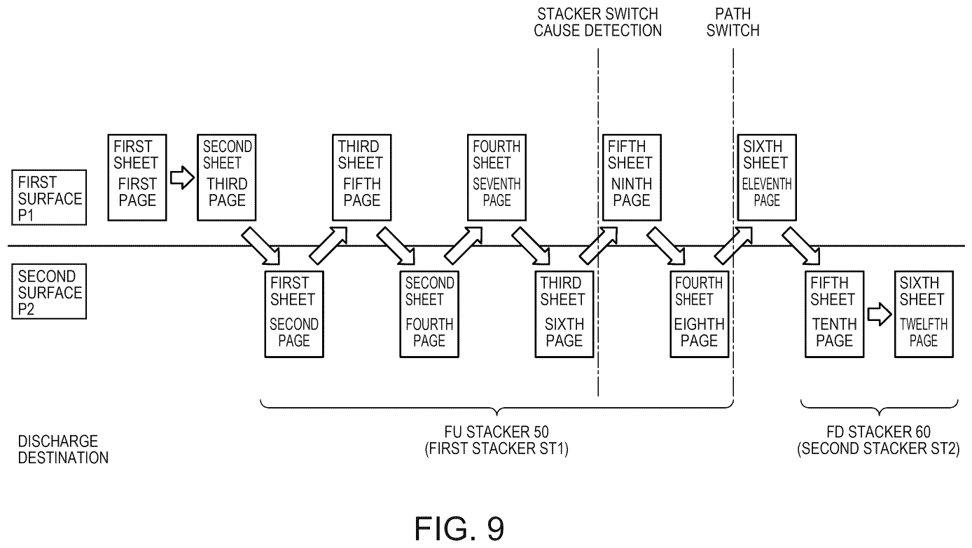

First, with reference to FIG. 9 to FIG. 20, an example will be described in which the stacker switch control is performed during execution (during printing) of the print job JD for which an instruction to consecutively print on n sheets of medium M using double-sided printing is given. A first example will be described in order in which the first stacker ST1 is the FU stacker 50 and a second example in which the first stacker ST1 is the FD stacker 60. Note that a comparative example in which the stacker is simply switched will be described first, and then the examples that solve the problem of the comparative example will be described.

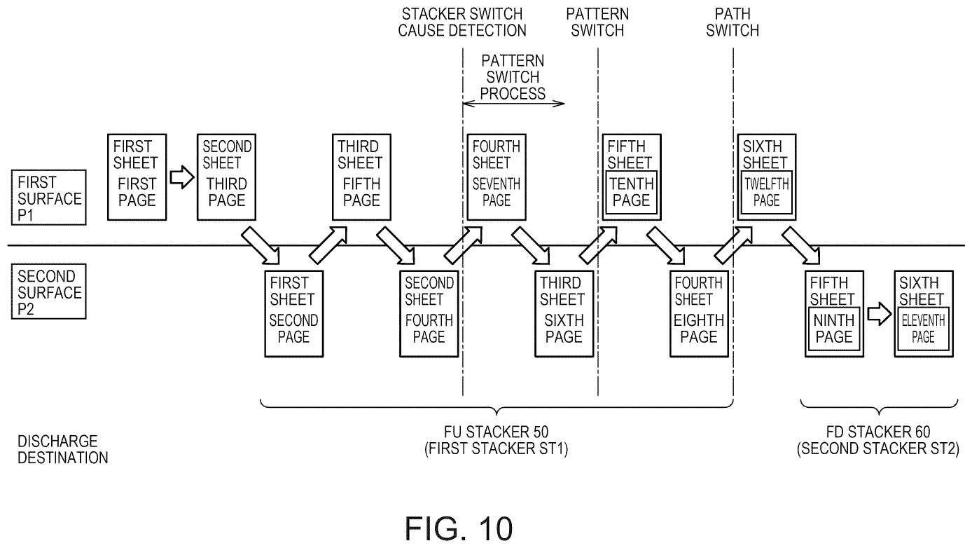

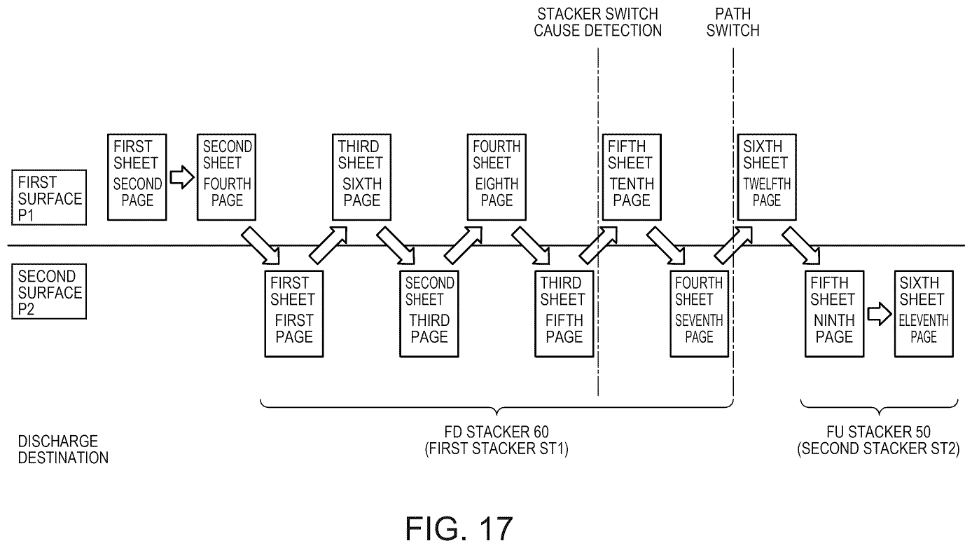

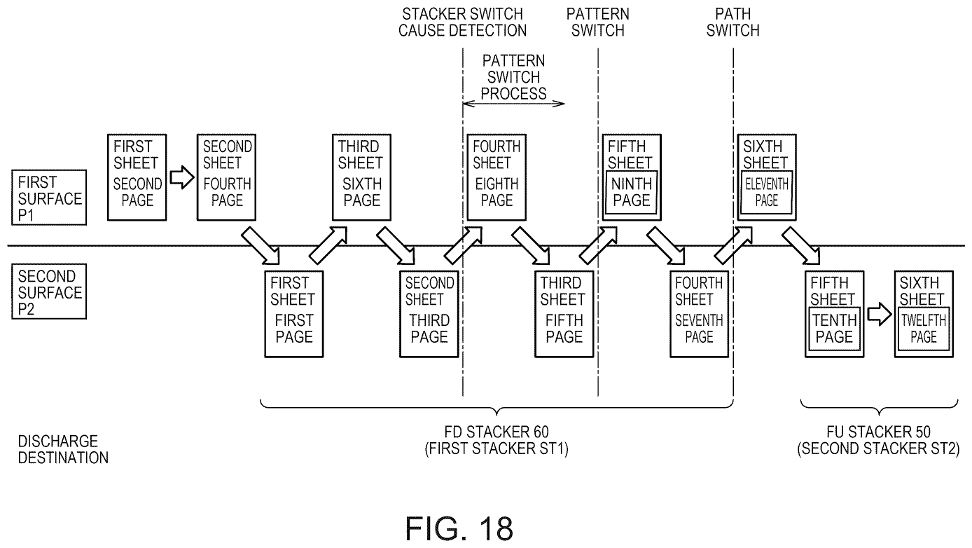

FIG. 9, FIG. 10, FIG. 17, and FIG. 18 show page numbers of patterns to be printed on a first surface P1 and a second surface P2 of the first sheet to the nth sheet (for example, n=12) of medium, in a case where as an example printing is performed based on a print job JD that instructs consecutive printing of n sheets using double-sided printing. The page numbers of the patterns to be printed correspond to the page order in ascending order from a first page to an nth page (for example, n=12) in the file of the print target instructed by the print job JD. In order to stack the printed objects from the first page to the nth page in the page order on the first stacker ST1, it is necessary to rearrange the printing order of the pages. FIG. 9 and FIG. 10 show an example in which the FU stacker 50 is the first stacker ST1, FIG. 9 shows a first comparative example, and FIG. 10 shows the first example. FIG. 17 and FIG. 18 show an example in which the FD stacker 60 is the first stacker ST1, FIG. 17 shows a second comparative example, and FIG. 18 shows the second example.

### First Comparative Example

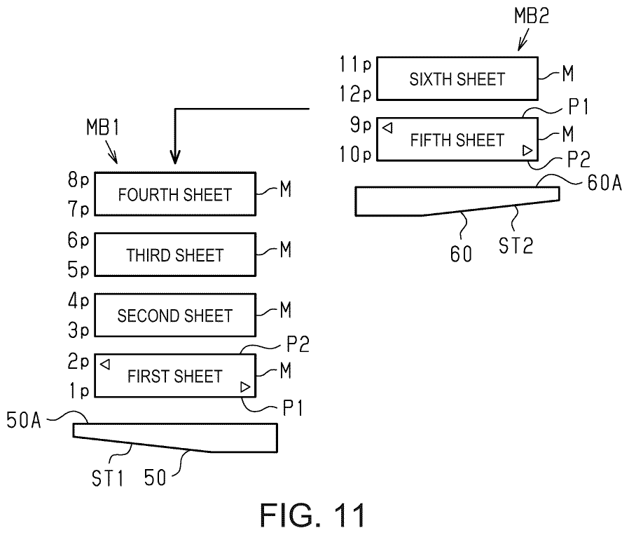

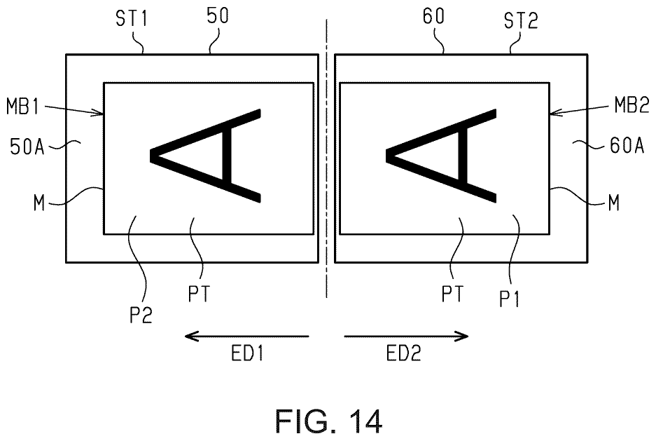

First, the first comparative example will be described with reference to FIG. 9 and FIG. 11. The first comparative example is an example in which the FU stacker 50 is the first stacker ST1 and the FD stacker 60 is the second stacker ST2. As shown in FIG. 9, assuming that in a case of double-sided printing, among the surfaces of the medium M, a surface to be printed first is the first surface P1 and a surface to be printed later is the second surface P2. First, the first page is printed on the first surface P1 of the first sheet. That is, the image of the first page is printed on the first surface P1 of the first sheet. The image is also referred to as the pattern PT (see FIG. 14 and FIG. 15). While the first sheet of medium is being inverted via the inversion path 47, the third page is printed on the first surface P1 of the second sheet. Further, the second page is printed on the second surface P2 of the first sheet after it was inverted. While the second sheet is being inverted, the fifth page is printed on the first surface P1 of the third sheet. The fourth page is printed on the second surface P2 of the second sheet that was inverted. In this way, the odd-numbered pages (=(2k−1) pages) are printed on the first surface P1 of the kth sheet (where k=123, . . . , n) of medium, and the even-numbered pages (=2k pages) are printed on the second surface P2.

For example, when a stacker switch cause such as full stack (full) of the first stacker ST1 is detected, the discharge destination is switched from the first stacker ST1 to the second stacker ST2. In the first comparative example, the discharge destination is switched from the FU stacker 50 to the FD stacker 60. Even after the stacker switch, printing is continued in the printing order designated by the print job JD. After a stacker switch cause is detected, the ninth page is printed on the first surface P1 of the fifth sheet, the eighth page is printed on the second surface P2 of the fourth sheet, the eleventh page is printed on the first surface P1 of the sixth sheet, the tenth page is printed on the second surface P2 of the fifth sheet, and the twelfth page is printed on the second surface P2 of the sixth sheet. The four sheets of medium M of the first sheet to the fourth sheet are discharged to the first stacker ST1 through the first discharge path 44 in the unchanged orientation. The two sheets of medium M of the fifth sheet and the sixth sheet are discharged to the second stacker ST2 through the second discharge path 45 in the inverted orientation.

As shown in FIG. 11, the first to the fourth sheets of medium M are stacked on the stack surface 50A of the first stacker ST1 as a medium bundle MB1 stacked in an orientation in which the first surface P1 is the lower surface and the second surface P2 is the upper surface. The medium M of the fifth and the sixth sheets are stacked on the stack surface 60A of the second stacker ST2 as a medium bundle MB2 stacked in an orientation in which the second surface P2 is the lower surface and the first surface P1 is the upper surface.

When the medium bundle MB2 is stacked on the medium bundle MB1 as they are to collect the n sheets of medium M into one, the page order is not aligned. Even if the medium bundle MB1 is inverted and stacked on the medium bundle MB2, the page order is not aligned in the same manner. Therefore, the user needs to perform an operation of aligning the medium bundle MB in the page order. Note that in FIG. 11, the orientation indicated by a triangle mark “Δ” shown for each of the surfaces P1 and P2 in the medium M is the orientation (leading edge direction) of the pattern printed on each of the first surface P1 and the second surface P2.

### First Example

Next, the first example will be described with reference to FIG. 10 and FIG. 12 to FIG. 16. In the first example, the FU stacker 50 is the first stacker ST1, and the FD stacker 60 is the second stacker ST2. In the first example, the stacker switch cause is exemplified by a case where the stack amount of the first stacker ST1 becomes equal to or larger than the threshold. Note that the stacker switch cause may be a jam in the first discharge path 44 or an abnormality (stacking abnormality) of the first stacker ST1.

As shown in FIG. 10, before a stacker switch cause is detected, printing is performed in the same page order as that of the first comparative example. That is, the first page is printed on the first surface P1 of the first sheet. While the medium of the first sheet is being inverted, the third page is printed on the first surface P1 of the second sheet. Further, the second page is printed on the second surface P2 of the first sheet after it was inverted. While the second sheet is being inverted, the fifth page is printed on the first surface P1 of the third sheet. The fourth page is printed on the second sheet that was inverted. In this way, the odd-numbered pages (=(2k−1) pages) are printed on the first surface P1 of the kth sheet (where k=123, . . . , n) of medium, and the even-numbered pages (=2k pages) are printed on the second surface P2.

In the printing order of double-sided printing, the second surface P2 of the k−1th sheet and the first surface P1 of the k+1th sheet are printed in this order between the first surface P1 and the second surface P2 of the kth sheet. However, on the first sheet, the k−1th sheet does not exist, and in the nth sheet, the k+1th sheet does not exist.

Assuming that in a case where the discharge destination of the medium M is the first stacker ST1, a page to be printed on the first surface P1 is set to the first page, and a page to be printed on the second surface P2 is set to the second page. In this case, the first page corresponds to an odd-numbered page (=(2k−1) page), and the second page corresponds to an even-numbered page (=2k page). From the first sheet, the odd-numbered pages are printed in ascending page order on the first surface P1, and the even-numbered pages are to be printed in ascending page order on the second surface P2.

When the stack amount of the first stacker ST1 becomes equal to or more than the threshold and a stacker switch cause is detected during printing, the discharge destination is switched from the first stacker ST1 to the second stacker ST2. The control section 100 first determines switching of the stacker at the time of detection. The stacker switch includes three steps of the pattern switch process, a pattern switch, and a path switch.

When the discharge destination of the medium M is to be switched from the first stacker ST1 to the second stacker ST2 during printing, the page order of the patterns printed on the medium M is switched from the medium M to be discharged to the second stacker ST2. That is, the page to be printed on the first surface P1 is set as the second page, and the page to be printed on the second surface P2 is set to the first page. In other words, in the medium M to be discharged to the second stacker ST2, the page to be printed on the first surface P1 is set to an even-numbered page (=2k page) as the second page. The page to be printed on the second surface P2 is set to an odd-numbered page (=(2k−1) page) as the first page.

In this way, in the first example, the page to be printed on the first surface P1 and the page to be printed on the second surface P2 are reversed before and after the stacker switch of the discharge destination. As the process of reversing the page, the pattern switch process is executed. The pattern switch process is a process of switching the page order to be printed so that the page order is aligned when the medium bundles MB1 and MB2 stacked on the stackers ST1 and ST2 are stacked as they are even when the stacker is switched from the first stacker ST1 to the second stacker ST2.

The second page is printed on the second surface P2 on the medium M on which the first page is printed on the first surface P1 before the stack amount is detected to be equal to or greater than the threshold. Among the medium M present in the transport path 40 at the time the stacker switch cause is detected, for the medium M that was already partially printed on the first surface P1, the first page is printed in the printing order applied to the medium to be discharged to the first stacker ST1. Therefore, before detection, for the medium M on which the first page is printed on the first surface P1 in the printing order applied to the medium M to be discharged to the first stacker ST1, the second page is printed on the second surface P2 in the printing order applied so far. Furthermore, there are cases in which the first page is printed on the first surface P1 of the medium M after the stack amount is detected equal to or greater than the threshold and before the pattern switch process (data reconstruction process) is completed. In this case, the second page is also printed on the second surface P2 of this medium M.

Here, the pattern switch process is a process of switching the pattern PT (print data PD) in the printing order applied to the medium to be discharged to the second stacker ST2. In the pattern switch process of the present embodiment, the arrangement order of the print data PD is changed so that the second page is to be printed on the first surface P1 and the first page is to be printed on the second surface P2. Further, the pattern switch process may include a process of changing the orientation of the print data PD.

The pattern switch process is executed by the data reconstruction section 202 or the control section 100 on the host device 200 side shown in FIG. 8. The data reconstruction section 202 may prepare one of reconstruction data RD1 and RD2 (see FIG. 5), which are obtained by rearranging the print data PD, when the print job JD is received, or may create the reconstruction data RD2 by executing the pattern switch process when the stacker switch cause is detected. A data reconstruction section 122 in the control section 100 may create one of the reconstruction data RD1 and RD2 instead of the data reconstruction section 202. Note that the pattern switch process in which the data reconstruction sections 202 and 122 switch the printing order of double-sided printing after the stacker switch of the discharge destination is determined will be described in detail later.

For example, in FIG. 10, the fifth page has already been printed on the first surface P1 of the third sheet before detection of the stacker switch cause. Further, after detection and before the pattern switch process is completed, the seventh page is printed on the first surface P1 of the fourth sheet. That is, before the pattern switch process is completed, the first page (an odd-numbered page) is printed on the first surface P1 of the fourth sheet in the printing order that should be applied to the medium to be discharged to the first stacker ST1. Therefore, the second page (even-numbered page) is printed on the second surface P2 in the printing order applied until then up to the fourth sheet.

The second page (even-numbered page) is printed on the first surface P1 of the fifth sheet, on which printing has not been started yet at the time when the pattern switch process is finished, in the printing order that should be applied to the medium to be discharged to the second stacker ST2. That is, the pattern switch is performed from the fifth sheet, and on the fifth and subsequent sheets of medium M, the second page (even-numbered page) is printed on the first surface P1, and the first page (odd-numbered page) is printed on the second surface P2. Note that information indicating the ordinal number of sheets of medium M at which the pattern switch is started may be acquired from the count value of the third counter 113. The count value of the third counter 113 is a value indicating the number of sheets for which printing has already been started. When the value obtained by adding 1 to the count value of the third counter 113 is “5”, the control section 100 performs the pattern switch from the fifth sheet.

In the example shown in FIG. 10, in the medium M up to the fourth sheets discharge to the first stacker ST1, the odd-numbered pages are printed on the first surface P1, and the even-numbered pages are printed on the second surface P2. Then, on the fifth and subsequent sheets of medium after the pattern switch, the even-numbered pages are printed on the first surface P1 in ascending order, and the odd-numbered pages are printed on the second surface P2 in ascending order. That is, after the pattern switch, the pattern PT of the 2k page is printed on the first surface P1 of the kth sheet (where k is a positive integer equal to or greater than 5 and equal to or less than the number of print sheets n), and the pattern PT of the (2k−1) page is printed on the second surface P2. Note that in FIG. 10, the page number of the page changed in the pattern switch process is surrounded by a square frame.

When the last medium M among the medium M on which the first page is printed on the first surface P1 after the stack amount is detected equal to or greater than the threshold passes through the branch position DP2, it switches from the first stacker ST1 to the second stacker ST2. That is, the control section 100 performs the path switch after the pattern switch. The branch position DP2 is a position where the first path (for example, the first discharge path 44) to the first stacker ST1 and the second path (for example, the second discharge path 45) to the second stacker ST2 branch off from each other. The control section 100 switches the path selected by the second path selection member 72 at the branch position DP2 from the first discharge path 44 toward the first stacker ST1 to the second discharge path 45 toward the second stacker ST2. By this path switch, the medium M on which the second page is printed on the first surface P1 and the first page is printed on the second surface P2 are discharged to the second stacker ST2. As a result, the medium M of the first to fourth sheets are discharged to the FU stacker 50, which is the first stacker ST1, and the medium M of the fifth and the sixth sheets are discharged to the FD stacker 60, which is the second stacker ST2.

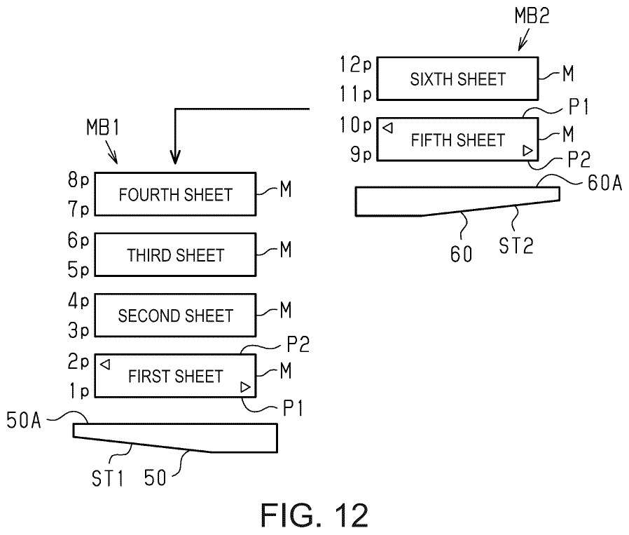

As a result, as shown in FIG. 12, in the FU stacker 50, which is the first stacker ST1, the medium M of the first to fourth sheets are stacked on the stack surface 50A as the medium bundle MB1 stacked in an orientation in which the first surface P1 is the lower surface and the second surface P2 is the upper surface. The page order is arranged in ascending order from 1p to 8p from the bottom.

In the FD stacker 60, which is the second stacker ST2 of the discharge destination after the stacker switch, the medium bundle MB2 in which the medium M of the fifth and the sixth sheets are stacked in the orientation in which the second surface P2 is the lower surface and the first surface P1 is the upper surface is stacked on the stack surface 60A. The page order is arranged in ascending order from 9p to 12p from the bottom. Note that in FIG. 12, the orientations (leading edge directions) of the patterns indicated by mark “Δ” on the first surface P1 and the second surface P2 of the medium M are such that the odd-numbered pages (pages 2k−1) are oriented to the right and the even-numbered pages (pages 2k) are oriented to the left in both the medium bundles MB1 and MB2.

When the medium bundle MB2 is stacked on the second stacker ST2 is stacked on the medium bundle MB1 is stacked on the first stacker ST1 in the unchanged orientation, the medium bundles MB are collected into one medium bundle MB in which the page order is aligned. In the medium bundle MB that is collected into one, 1p to 12p are arranged in ascending order from the bottom. Even when the two medium bundles MB1 and MB2 are separately stacked on the two stackers ST1 and ST2, the medium bundles MB1 and MB2 can be easily combined into one medium bundle MB with alignment.

### About Orientation of Pattern (Orientation of Print Data PD)

Here, in the first example shown in FIG. 12, if the two medium bundles MB1 and MB2 are stacked as they are, the medium bundles are arranged in the page order, and the orientations of the patterns printed on the respective surfaces P1 and P2 are also aligned. That is, when the page order of the pattern is switched, the orientation of the pattern for each of the surfaces MB1 and MB2 becomes the same between the two medium bundles P1 and P2.

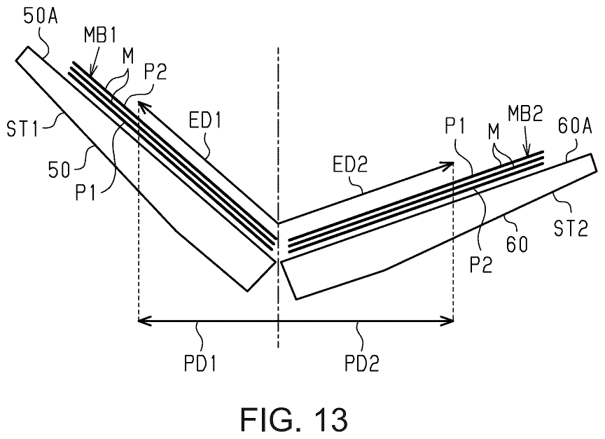

As shown in FIG. 13, in the first stacker ST1 and the second stacker ST2, the discharge direction of the medium M is in opposite directions. That is, in the FU stacker 50 and the FD stacker 60, the discharge direction of the medium M is in opposite directions. A direction from an upstream edge to a downstream edge in the discharge direction of the medium M discharged to the FU stacker 50 is defined as a first discharge direction ED1. A direction from the upstream edge to the downstream edge in the discharge direction of the medium M discharged to the FD stacker 60 is defined as a second discharge direction ED2. The first discharge direction ED1 and the second discharge direction ED2 are in opposite directions each other.

The “opposite direction” mentioned here can be defined as follows. As shown in FIG. 13, a direction when the first discharge direction ED1 is projected on a horizontal plane is assumed a first projection direction PD1, and a direction when the second discharge direction ED2 is projected on the horizontal plane is assumed a second projection direction PD2. The first projection direction PD1 and the second projection direction PD2 are in a relationship of directions (orientations) opposite to each other by 180°. In this way, if the two directions projected on the horizontal plane are opposite directions, the two discharge directions ED1 and ED2 before being projected are defined as opposite directions.

As shown in FIG. 13, the medium M are discharged to the FU stacker 50 in an orientation in which the first surface P1 is the lower surface and the second surface P2 is the upper surface. The medium M are discharged to the FD stacker 60 in an orientation in which the first surface P1 is the upper surface and the second surface P2 is the lower surface. In the medium M on the first stacker ST1, the orientation of the pattern of the second surface P2, which is the upper surface, is the downstream side (left orientation in FIG. 13) in the first discharge direction ED1. The orientation of the pattern of the first surface P1, which is the lower surface, is the upstream side (right orientation in FIG. 13) in the first discharge direction ED1. On the other hand, in the medium M on the second stacker ST2, the orientation of the pattern of the first surface P1, which is the upper surface, is the upstream side (left orientation in FIG. 13) in the second discharge direction ED2. The orientation of the pattern of the second surface P2, which is the lower surface, is the downstream side (right orientation in FIG. 13) in the second discharge direction ED2. That is, in both of the medium bundles MB1 and MB2, the pattern on the upper surface of the medium M is oriented leftward, and the pattern on the lower surface is oriented rightward.

As shown in FIG. 14, the discharge directions ED1 and ED2 of the medium M discharged to the stackers 50 and 60 are opposite directions, but the orientations of the pattern PT printed on the same side of the upper and lower surfaces of the medium M are the same in both of the two medium bundles MB1 and MB2. That is, as shown in FIG. 14, the orientation of the pattern PT on the upper surface of the medium M discharged to the FU stacker 50 is the left orientation, and the orientation of the pattern PT on the upper surface of the medium M discharged to the FD stacker 60 is the left orientation. That is, in the present embodiment, the pattern switch process is performed in which the pages to be printed are switched between the first surface P1 and the second surface P2 before and after the stacker switch. Therefore, in a case of the stacker of the discharge destination is switched between the FU stacker 50 and the FD stacker 60, the orientations of the medium M become the same between the medium bundles MB1 and MB2 only by switching the pages to be printed on the first surface P1 and the second surface P2 without changing the orientation of the pattern PT.

Therefore, in a case of the discharge destination of the medium M is to be switched from the first stacker ST1 to the second stacker ST2, the medium M to be discharged to the second stacker ST2 maintain the orientation of the print data PD. That is, the orientation of the pattern PT to be printed on the medium M to be discharged to the second stacker ST2 is maintained. In the pattern switch process, the orientation of the print data PD is maintained by only switching the order of the print data PD (see FIG. 15) in page units.

In the present embodiment, the discharge destination of the medium M is switched from the first stacker ST1 to the second stacker ST2 during printing. The subject that sets the page to be printed on the first surface P1 to the second page and the page to be printed on the second surface P2 to the first page at the time of switching the stacker is not limited to the host device 200. It may be the control section 100 on the printing device 11 side. That is, in a case of the discharge destination of the medium M is to be switched from the first stacker ST1 to the second stacker ST2 during printing, the control section 100 may set the page to be printed on the first surface P1 to the second page and set the page to be printed on the second surface P2 to the first page. The control section 100 on the printing device 11 side may include the data reconstruction section 122 (see FIG. 8). The data reconstruction section 122 switches the order (printing order) of the print data PD for each page as the pattern switch process.

### About Print Job Data JD and Reconstruction Data RD

Next, the print job data JD and the reconstruction data RD will be described with reference to FIG. 15. The print data generation section 201 of the host device 200 generates the print job data JD based on the file of the print target selected by the user and the print condition information. The output destination stacker specified by the print condition information is the first stacker ST1. The data reconstruction section 202 generates the reconstruction data RD by reconstructing the data in which the print data PD for each page in the print job data JD is rearranged by the pattern switch process. The output destination stacker is changed from the first stacker ST1 designated by the print condition information to the second stacker ST2. Note that the reconfiguration referred to here may include a process of generating the reconstruction data RD by arranging the print data PD in the printing order determined under the condition that the discharge destination is the second stacker ST2, based on the file and the print condition information, without using the print job data JD.

As shown in FIG. 15, the print job data JD includes a header HD in which a print command is described, and print data PD in which the pattern PT to be printed for each page is represented by dot data of the CMYK color system. The print job data JD at the time of the consecutively printing of a plurality of sheets includes a plurality of pieces of print data PD in which the print data PD for each page is arranged in the printing order determined from the print condition information. The plurality of print data PD is arranged in the printing order determined from information of the print surface (single surface/both surface) and the output destination stacker. In the print job data JD in the example shown in FIG. 15, the plurality of print data PD is arranged in the printing order in which the medium M can be discharged in an order in which 1p to 12p are arranged in ascending order from the bottom side in the FU stacker 50.

In FIG. 15, the triangle mark “A” in the print data PD indicates the orientation of the leading edge side of the pattern PT (print data PD). The pattern PT is printed by the printing section 20 in order from the leading edge side.

There are two methods, a first method and a second method, for the data reconstruction section 202 to reconstruct the print data PD. The reconstruction data RD includes the reconstruction data RD1 created by the first method and the reconstruction data RD2 created by the second method. The first method is a method of in a case of the print job JD is received, preparing in advance the reconstruction data RD1 in which all the print data PD are arranged in the printing order in the case of discharging to the second stacker ST2. The second method is a method of reconstructing the print data PD of the amount to be used for printing after the pattern switch when the stacker switch cause is detected in the middle of printing based on the print job JD. Two methods will be described below.

In the first method, the print control unit 200A of the host device 200 generates the reconstruction data RD together with the print job data JD when generating the print job data JD. Before the switching of the discharge destination of the medium M from the first stacker ST1 to the second stacker ST2 is determined, the print control unit 200A generates the print data PD in a case of discharging to the first stacker ST1 and generates the print data PD in a case of discharging to the second stacker ST2. That is, the print control unit 200A generates the print job data JD including the plurality of print data PD arranged in the printing order for the case of discharging to the first stacker ST1, and the reconstruction data RD including the print data PD arranged in the printing order for the case of discharging to the second stacker ST2.

Specifically, before the switching of the discharge destination is determined, the print data generation section 201 creates the print job data JD, and the data reconstruction section 202 creates the reconstruction data RD. In this case, first reconstruction data RD1 or second reconstruction data RD2 may be created before the stacker switch determination timing. The print job data JD and the reconstruction data RD may be prepared at the same time, or may be prepared with a priority order in which the print job data JD is created first and the reconstruction data RD is created next. If it is before the switching of the stacker of discharge destination has been determined, the reconstruction data RD may be prepared during printing. Note that in a case of the stacker switch determination time cannot be predicted, the reconstruction data RD may be created before the first sheet of the medium M is completely discharged to the first stacker ST1 from the start of printing based on the print job JD. For example, the reconstruction data RD may be created before the medium M of the first sheet has passed through the branch position DP2 or before the first sheet of the medium M reaches the branch position DP2.

When the discharge destination of the medium M is to be switched from the first stacker ST1 to the second stacker ST2, the medium M to be discharged to the second stacker ST2 maintains the orientation of the print data PD. As shown in FIG. 15, the orientation of the print data PD in the reconstruction data RD1 and RD2 is the same orientation that maintains the orientation of the print data PD in the print job data JD. Before and after the discharge destination of the medium M is switched from the first stacker ST1 to the second stacker ST2, the print data PD maintains the orientation of the pattern PT indicated by the mark “A”. In this manner, in the first method, the pattern switch process (data reconstruction process) including the rearrangement of the page order of the print data PD is executed in advance before the stacker switch determination.

Note that the pattern switch process may be performed after the print start instruction is received and before printing is started, may be performed before and after printing is started, or may be performed during printing after printing is started. In short, the execution time of the pattern switch process may be any time as long as the reconstruction data RD is created before the pattern switch determination.

The first method does not substantially require the pattern switch process to be performed during printing. The pattern switch process is completed within mainly a processing time required for the exchange of communication with the print control unit 200A on the host device 200 side and the writing of a part of the print data PD such as the current or next page after the pattern switch in the storage region 115 of the storage section 114. Therefore, even in a case of the processing amount is relatively large, a delay in printing or a delay in stacker switch timing due to a waiting time for the processing is less likely to occur. On the other hand, even in a case of the stacker switch is not necessary, the data reconstruction process is always performed, and thus the process and the reconstruction data RD are likely to be wasted.

In the second method, when the switching of the discharge destination of the medium M from the first stacker ST1 to the second stacker ST2 is determined, the print control unit 200A of the host device 200 generates the print data PD in a case of discharging to the second stacker ST2, such as the print data PD in the reconstruction data RD2 shown in FIG. 15. When discharge is to the second stacker ST2, the print control unit 200A generates the print data PD, for example, only for the number of sheets that had their discharge destination switched to the second stacker ST2. The medium M to be discharged to the second stacker ST2 is maintained in the orientation of the print data PD. In the print data PD in a case of it is discharged to the second stacker ST2, the orientation of the pattern PT indicated by the mark “A” is maintained. In this manner, in the second method, the page order of the print data PD (pattern PT) is rearranged only for the print data PD after the pattern switch.

In the second method, the pattern switch process is performed only when the stacker switch is necessary, and thus the process and the reconstruction data RD are less likely to be wasted. The process performed before printing is simpler than that of the first method. Further, since the target of the pattern switch process is limited to a part of the print data PD, the processing load is easily reduced. On the other hand, since the pattern switch process is performed during printing, in a case of the amount of processing is very large, a delay in printing or a delay in the stacker switch timing may occur due to the waiting time. Note that when the print job JD is received, in a case of it is possible to predict that the stack amount of the first stacker ST1 will become equal to or larger than the threshold during the execution of the current print job JD, the reconstruction data RD2 may be created in advance.

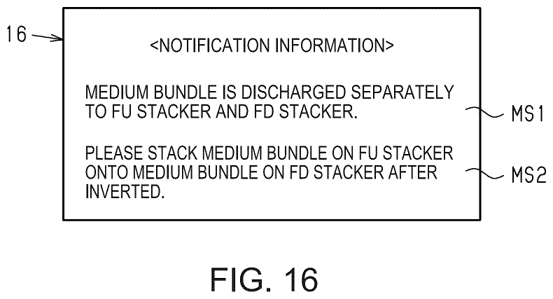

As shown in FIG. 16, the display section 16, which is an example of the notification section, may notify that the discharge destination is to be switched. When the stacker switch control is executed, the control section 100 may cause the display section 16 to display that the discharge destination is to be switched.

For example, as shown in FIG. 16, the display section 16 displays a first message MS1 as information indicating that the medium bundle is to be discharged separately to two stackers 50 and 60. Further, the display section 16 may display a second message MS2 as information on a method of stacking two medium bundles MB1 and MB2, which are separately discharged to the two stackers 50 and 60, on one medium bundle having a consistent page order. In the example shown in FIG. 16, in the display section 16, display “PLEASE STACK MEDIUM BUNDLE ON FD STACKER ONTO MEDIUM BUNDLE ON FU STACKER IN UNCHANGED ORIENTATION.” as the second message MS2.

The two types of messages MS1 and MS2 shown in FIG. 16 may be displayed on the display section 16 on different screens at different timings according to the contents of the messages. The control section 100 may display the first message MS1 at the time when the switching of the stacker of the discharge destination is determined. The user can visually recognize that the discharge destination is to be switched or has been switched by the first message MS1 during printing. That is, the user who views the first message MS1 can know that the medium bundle MB is discharged separately to the two stackers 50 and 60. The control section 100 may display the second message MS2 on the display section 16 immediately before or after the printing based on the print job JD is finished. The user who views the second message MS2 can know a method of collecting the two medium bundles MB1 and MB2, which are separated and discharged to the two stackers 50 and 60, into one in a state where they are aligned in the page order.

Note that when jamming is detected or when a stacking abnormality is detected, in FIG. 10, the third and subsequent sheets of medium including the medium M printed in the printing order before the stacker switch are discharged to the first stacker ST1. Therefore, the display section 16 may display the following information in addition to the two types of messages MS1 and MS2. For example, in the display section 16, it may display information on the stacker switch cause indicating which sheet is abnormal, and information prompting the user to invert the two sheets (third sheet and fourth sheet) from the bottom of the medium bundle MB2 on the second stacker ST2.

### Second Comparative Example

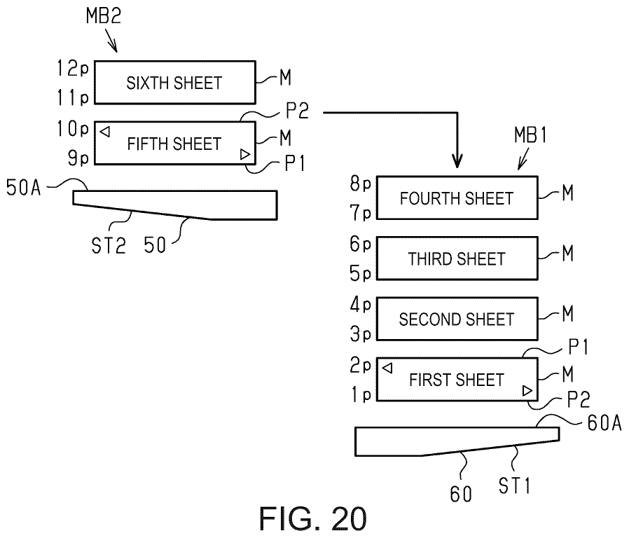

Next, the second comparative example will be described with reference to FIG. 17 and FIG. 20. In the second comparative example, the FD stacker 60 is the first stacker ST1, and the FU stacker 50 is the second stacker ST2. As shown in FIG. 17, assuming that in a case of double-sided printing, among the surface of medium M, a surface to be printed first is the first surface P1, and a surface to be printed later is the second surface P2. First, the second page is printed on the first surface P1 of the first sheet. While the medium M of the first sheet is being inverted via the inversion path 47, the fourth page is printed on the first surface P1 of the second sheet. Further, the first page is printed on the second surface P2 of the first sheet that has been inverted. While the second sheet is being inverted, the sixth page is printed on the first surface P1 of the third sheet. The third page is printed on the second surface P2 of the second sheet that has been inverted. In this way, the even-numbered pages (=2k pages) are printed on the first surface P1 of the kth sheet (where k=123, . . . , n) of medium, and the odd-numbered pages (=(2k−1) pages) are printed on the second surface P2.

For example, when a stacker switch cause such as full stack (full) of the first stacker ST1 is detected, the discharge destination is switched from the first stacker ST1 to the second stacker ST2. In the second comparative example, the discharge destination is switched from the FD stacker 60 to the FU stacker 50. Even after the stacker switch, printing is continued in the printing order designated by the print job JD. After the stacker switch cause is detected, the tenth page is printed on the first surface P1 of the fifth sheet, the seventh page is printed on the second surface P2 of the fourth sheet, the twelfth page is printed on the first surface P1 of the sixth sheet, the ninth page is printed on the second surface P2 of the fifth sheet, and the eleventh page is printed on the second surface P2 of the sixth sheet. For example, the four sheets of medium M of the first sheet to the fourth sheet are discharged to the first stacker ST1 through the second discharge path 45 in the inverted orientation. The two sheets of medium M of the fifth sheet and the sixth sheet are discharged to the second stacker ST2 through the first discharge path 44 in the unchanged orientation.

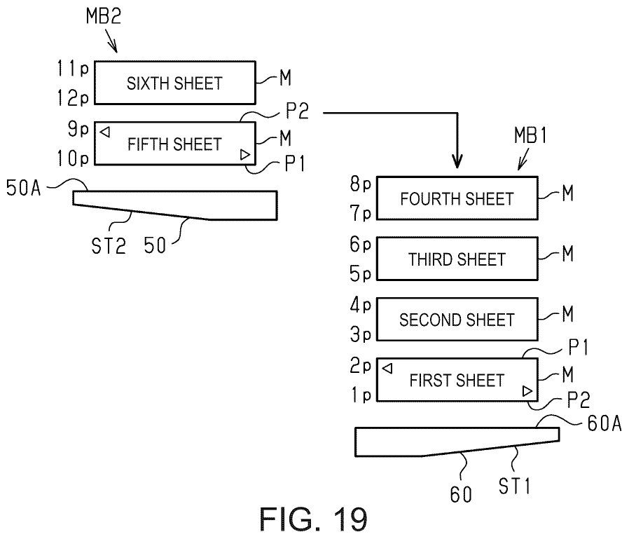

As shown in FIG. 19, the medium M of the first to the fourth sheets are stacked on the stack surface 50A of the first stacker ST1 as the medium bundle MB1 stacked in an orientation in which the second surface P2 is the lower surface and the first surface P1 is the upper surface. The medium M of the fifth and the sixth sheets are stacked on the stack surface 60A of the second stacker ST2 as the medium bundle MB2 stacked in an orientation in which the first surface P1 is the lower surface and the second surface P2 is the upper surface. Even if the medium bundle MB2 is stacked on the medium bundle MB1 as they are, the page order cannot be aligned when the n sheets of medium M are collected into one. Even if the medium bundle MB1 is inverted and stacked on the medium bundle MB2, the page order cannot be aligned in the same manner. Therefore, the user needs to perform an operation of aligning the medium bundle MB in the page order.

### Second Example

Next, the second example will be described with reference to FIG. 18 and FIG. 20. In the second example, as in the second comparative example, the FD stacker 60 is the first stacker ST1, and the FU stacker 50 is the second stacker ST2. In the first example, the stacker switch cause is, for example, a case where the stack amount of the first stacker ST1 becomes equal to or more than the threshold. Note that the stacker switch cause may be a jam in the first discharge path 44 or an abnormality (stacking abnormality) of the first stacker ST1.

As shown in FIG. 18, before the stacker switch cause is detected, printing is performed in the same page order as that of the first comparative example. That is, the second page is printed on the first surface P1 of the first sheet. While the medium of the first sheet is being inverted, the fourth page is printed on the first surface P1 of the second sheet. Further, the first page is printed on the second surface P2 of the first sheet that has been inverted. While the second sheet is being inverted, the sixth page is printed on the first surface P1 of the third sheet. The third page is printed on the second surface P2 of the second sheet that has been inverted. In this way, the even-numbered pages (=2k pages) are printed on the first surface P1 of the kth sheet (where k=123, . . . , n) of medium, and the odd-numbered pages (=(2k−1) pages) are printed on the second surface P2.

Assuming that in a case where the discharge destination of the medium M is the first stacker ST1, a page to be printed on the first surface P1 is set to the first page, and a page to be printed on the second surface P2 is set to the second page. In this case, the first page corresponds to an even-numbered page (=2k page), and the second page corresponds to an odd-numbered page (=(2k−1) page).

When the stack amount of the first stacker ST1 becomes equal to or more than the threshold and a stacker switch cause is detected during printing, the discharge destination is switched from the first stacker ST1 to the second stacker ST2. The control section 100 first determines switching of the stacker at the time of detection. The stacker switch includes three steps of the pattern switch process, the pattern switch, and the path switch.

in a case of the discharge destination of the medium M is to be switched from the first stacker ST1 to the second stacker ST2 during printing, the page to be printed on the first surface P1 of the medium M to be discharged to the second stacker ST2 are set to the second page, and the page to be printed on the second surface P2 are set to the first page. In other words, in the medium M to be discharged to the second stacker ST2, the page to be printed on the first surface P1 is set to an odd-numbered page (=(2k−1) page) as the second page. The page to be printed on the second surface P2 is set to the even-numbered page (=2k page) as the first page.

In this way, in the second example, the page to be printed on the first surface P1 and the page to be printed on the second surface P2 are reversed before and after the stacker switch of the discharge destination. As the process of reversing the page, the pattern switch process (data reconstruction process) of switching the pattern PT (print data PD) is executed. The pattern switch process is a process of switching the page order to be printed so that the page order is aligned when the medium bundles MB1 and MB2 stacked on the stackers ST1 and ST2 are stacked as they are even when the stacker is switched from the first stacker ST1 to the second stacker ST2. In the second example, as in the first example, the orientation of the page to be printed is reversed in the pattern switch process.

The medium M on which the first page is printed on the first surface P1 before the stack amount is detected equal to or greater than the threshold, the second page is printed on the second surface P2. Among the medium M present on the transport path 40 at the time of detection of the stacker switch cause, the medium M on which the first page has already been printed, even if only partially, on the first surface P1, the second page is printed on the second surface P2. Further, the medium M on which the first page is printed on the first surface P1 after the stack amount is detected equal to or greater than the threshold and before the pattern switch process (data reconstruction process) is completed, the second page is printed on the second surface P2. Here, the pattern switch process is a process of switching the pattern PT (print data PD) in the printing order that should be applied to the medium to be discharged to the second stacker ST2.

For example, in FIG. 18, at the time of detection of the stacker switch cause, printing of the fifth page on the first surface P1 of the third sheet has already been completed. After detection and before the started pattern switch process is completed, the seventh page is printed on the first surface P1 of the fourth sheet. That is, before the pattern switch process is completed, the first page (odd-numbered page) that should be printed in the printing order applied to the medium to be discharged to the first stacker ST1 is printed on the first surface P1 of the fourth sheet. Therefore, up to the fourth sheet, the second page (even-numbered page) is printed on the second surface P2 in the printing order applied so far, and then the fourth sheet is discharged to the first stacker ST1.

In the first stacker ST1 and the second stacker ST2, the discharge direction of the medium M is in opposite directions. Therefore, in a case of the discharge destination of the medium M is to be switched from the first stacker ST1 to the second stacker ST2, the orientation of the print data PD is reversed in the medium M to be discharged to the second stacker ST2. The data reconstruction section 202 in the host device 200 performs switching of the page order of the pattern PT and switching of the orientation of reversing the orientation of the pattern PT in the pattern switch process. Note that in the second example, the second method is adopted as the method for the data reconstruction section 202 to reconstruct the print data PD, but the first method may be adopted.

Then, as shown in FIG. 20, in the FD stacker 60, which is the first stacker ST1, the medium M of the first to the fourth sheets are stacked on the stack surface 60A in an orientation in which the second surface P2 is the lower surface and the first surface P1 is the upper surface. The page order is arranged in ascending order from 1p to 8p from the bottom.

In the FU stacker 50, which is the second stacker ST2 of the discharge destination after the stacker switch, the medium M of the fifth and the sixth sheets are stacked on the stack surface 50A in an orientation in which the first surface P1 is the lower surface and the second surface P2 is the upper surface. The page order is arranged in ascending order from 9p to 12p from the bottom.

When the medium bundle MB2 is stacked on the second stacker ST2 is stacked on the medium bundle MB1 is stacked on the first stacker ST1 in the unchanged orientation, the medium bundles MB are collected into one medium bundle MB in which the page order is aligned. In the medium bundle MB that is collected into one, 1p to 12p are arranged in ascending order from the bottom. Even when the two medium bundles MB1 and MB2 are separately stacked on the two stackers ST1 and ST2, the medium bundles MB1 and MB2 can be easily combined into one medium bundle MB with alignment without much labor.

The display section 16, which is an example of a notification section, may notify that the discharge destination is to be switched. When the stacker switch control is executed, the control section 100 may cause the display section 16 to display that the discharge destination is to be switched. The control section 100 may display a screen including the first message MS1 and the second message MS2 on the display section 16, similarly to the screen shown in FIG. 16 in the first example. However, it displays the second message MS2 is “Please stack the medium bundle on the FU stacker onto the medium bundle on the FD stacker in the unchanged orientation.” The user who views the first message MS1 can know that the medium bundle MB is discharged separately to the two stackers 50 and 60. The user who views the second message MS2 can know a method of collecting the two medium bundles MB1 and MB2, which are separated and discharged to the two stackers 50 and 60, into one in a state where they are aligned in the page order.

### Effects of First Embodiment

According to the first embodiment, the following effects are obtained.

(1-1) The printing device 11 includes the printing section 20 that performs printing on the medium M, the transport section 30 that transports the medium M in the transport direction FD, and the first stacker ST1 and the second stacker ST2 that are provided downstream of the printing section 20 in the transport direction FD. The first stacker ST1 is discharged in a state where one surface of the medium M faces upward. The second stacker ST2 is discharged in a state where the other surface opposite to the one surface faces upward. Assuming that in a case of double-sided printing, among the surfaces of the medium M, a surface to be printed first is the first surface P1, and a surface to be printed later is the second surface P2. Assuming that in a case where the discharge destination of the medium M is the first stacker ST1, a page to be printed on the first surface P1 is set to the first page, and a page to be printed on the second surface P2 is set to the second page. When the discharge destination of the medium M is switched from the first stacker ST1 to the second stacker ST2 during printing, with respect to the medium M that is to be discharged to the second stacker ST2, a page to be printed on the first surface P1 is set to the second page and a page to be printed on the second surface P2 is set to the first page. According to this configuration, the medium bundle MB1 discharged to the first stacker ST1 and the medium bundle MB2 discharged to the second stacker ST2 can be aligned. Therefore, even when the discharge destination to which the medium M are discharged is switched from the first stacker ST1 to the second stacker ST2, the workability of the user can be improved.

(1-2) Before the switching of the discharge destination of the medium M from the first stacker ST1 to the second stacker ST2 is determined, print data PD in a case of discharging to the first stacker ST1 is generated, and print data PD in a case of discharging to the second stacker ST2 is generated. According to this configuration, since two types of the print data PD corresponding to the stacker ST1 and the ST2 before and after the switching of the discharge destination are prepared, it is possible to shorten the generation time (image processing time) of the print data PD corresponding to the stacker ST2 of the switching destination during printing. Therefore, the stacker to which the discharge destination can be smoothly switched.

(1-3) When the switching of the discharge destination of the medium M from the first stacker ST1 to the second stacker ST2 is determined, print data PD in a case of discharging the medium M to the second stacker ST2 is generated. According to this configuration, since the print data PD is generated only in a case of the switching is performed, it is possible to simplify the process before printing.

(1-4) The printing device 11 includes the detection section that detects the stack amount of the first stacker ST1. When the detection section detects that the stack amount of the first stacker ST1 is equal to or greater than a threshold during printing, the discharge destination of the medium M is switched from the first stacker ST1 to the second stacker ST2. According to this configuration, there is a concern that the medium M may overflow from the first stacker ST1 when continuously used even when it is full, but it is possible to suppress that.

(1-5) The threshold is smaller than a maximum amount that the first stacker ST1 is configured to have stacked thereon. The medium M on which the first page is printed on the first surface P1 before the stack amount is detected equal to or greater than the threshold, the second page is printed on the second surface P2. According to this configuration, since the first stacker ST1 is detected to be full (full stack) in a state where there is a margin, it is possible to suppress waste of the medium M by discharging the medium M on which printing has already been started as they are.

(1-6) When the last medium M among the medium M on which the first page is printed on the first surface P1 passes through a branch position DP2 of a first path to the first stacker ST1 and a second path to the second stacker ST2 after it is detected that the stack amount is equal to or greater than the threshold, then the first stacker ST1 is switched to the second stacker ST2. According to this configuration, since the first stacker ST1 is detected in a state where there is a margin until the first stacker LA is full, it is possible to suppress waste of the medium M by leaving the medium M on which printing has already been started as they are. When the medium M that should be discharged to the first stacker ST1 passes the branch position, the stacker of the discharge destination is switched, and thus, the medium M on which printing has already been started at the time of detection can be reliably discharged to the first stacker ST1.

(1-7) The control section 100 is provided that is configured to, when the discharge destination of the medium is switched from the first stacker to the second stacker during printing, set the page to be printed on the first surface to the second page and set the page to be printed on the second surface to the first page. According to this configuration, in order to switch the stacker, the control section 100 performs the setting change for rearranging the order of the pages to be printed on the first surface P1 and the pages to be printed on the second surface P2. Therefore, compared to a configuration in which an external device changes the setting, the time required for communication can be saved. Therefore, it is easy to more quickly switch the stacker of the discharge destination.

(1-8) In the first stacker ST1 and the second stacker ST2, a discharge direction of the medium M is in opposite directions and when the discharge destination of the medium M is switched from the first stacker ST1 to the second stacker ST2, an orientation of print data is maintained with respect to the medium M that is to be discharged to the second stacker ST2. According to this configuration, the orientations of the pages are aligned only by switching the first page and the second page to be printed on the first surface P1 and the second surface P2, without reversing the orientations of the print data PD, and thus, it is possible to easily perform the work of aligning the medium bundle.

(1-9) The detection section that detects a jam of the medium M is provided. The transport section 30 includes the transport path 40 along which the medium M is transported. The transport section 30 includes, at a position in the transport path 40 that is downstream from the printing section 20 in the transport direction FD, the first path configured to discharge the medium M to the first stacker ST1, the second path configured to discharge the medium M to the second stacker ST2, and the path selection member 72. The path selection member 72 selects one of the first path and the second path as a discharge destination of the medium M at the branch position DP2 between the first path and the second path. When a jam is detected during printing, if it is detected that the jammed medium M has passed through the branch position DP2, the discharge destination of the medium M subsequent to the jammed medium M is switched from the first stacker ST1 to the second stacker ST2. According to this configuration, by switching in a case of there is an abnormality in the first stacker ST1, it is possible to continue printing of one job without stopping the operation of the device.

(1-10) The printing device 11 includes the detection section that detects an abnormality of the first stacker ST1. When an abnormality of the first stacker ST1 is detected during printing, the discharge destination of the medium M is switched from the first stacker ST1 to the second stacker ST2. According to this configuration, by switching the stacker of the discharge destination in a case of there is an abnormality in the first stacker ST1, it is possible to continue printing of one job without stopping the operation of the device.

(1-11) The printing device 11 includes the notification section that notifies that the discharge destination is to be switched. According to this configuration, since the switching of the discharge destination can be known by the notification, the workability of the user can be improved.

### Second Embodiment

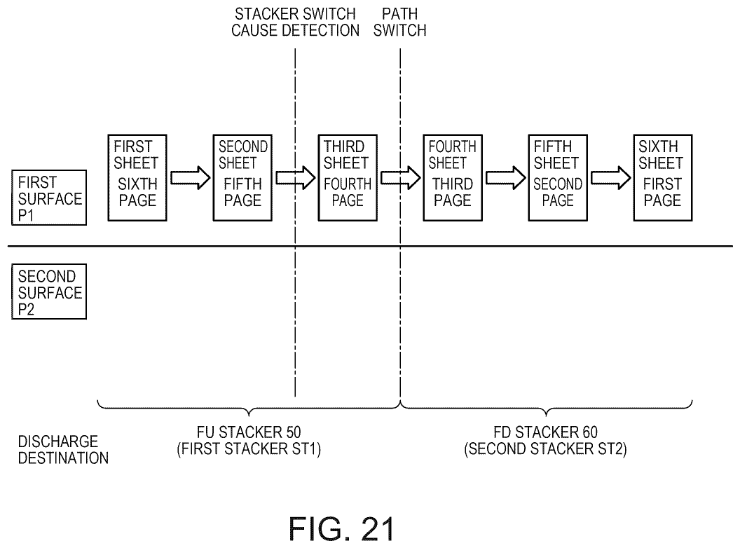

Next, a second embodiment will be described with reference to FIG. 21 to FIG. 24. The second embodiment is an example in which the stacker switch control is applied to single-sided printing in the printing device 11 of the first embodiment. The configuration of the printing device 11 is the same as that of the first embodiment. The pattern switch process that is performed after the stacker switch cause is detected corresponding to single-sided printing, and is different from that using double-sided printing. Therefore, the following description will be made mainly on the points that are particularly different in the stacker switch control.

An example in which the discharge destination of the medium M is switched from the first stacker ST1 to the second stacker ST2 by the stacker switch condition is satisfied during printing based on the print job for which consecutively printing of n sheets in single-sided printing is instructed will be described. A third example in which the FU stacker 50 is the first stacker ST1 and a fourth example in which the FD stacker 60 is the first stacker ST1 will be described below in order. Before describing each example, a comparative example in which the stacker is simply switched will be described, and then each example that solves the problem of the comparative example will be described.

The printing device 11 has the same configuration as that shown in FIG. 1 and the same electrical configuration as that shown in FIG. 8 in the first embodiment. That is, the printing device 11 includes the printing section 20, the transport section 30, the FU stacker 50, and the FD stacker 60. The transport section 30 includes the transport path 40 including the inversion path 47. The printing device 11 includes the inversion path 47 that is provided downstream of the printing section 20 in the transport direction FD and that is configured to invert the front and back of the medium M.

In single-sided printing, a surface to be printed is set as the first surface P1. In a case of the discharge destination of the medium M is to be switched from the first stacker ST1 to the second stacker ST2 during printing, the medium M to be discharged to the second stacker ST2 are set to be discharged after being transported to the inversion path 47 after the first surface P1 is printed. The print control unit 200A of the host device 200 includes the print data generation section 201 and the data reconstruction section 202. The printing device 11 may include the data reconstruction section 122. FIG. 21 to FIG. 24 show an example of performing single-sided printing based on the print job JD of n-sheet consecutively printing. In this single-sided printing, printing is performed on the first surface P1 of the first sheet to the nth sheet (for example, n=6) of medium M.

### Third Comparative Example

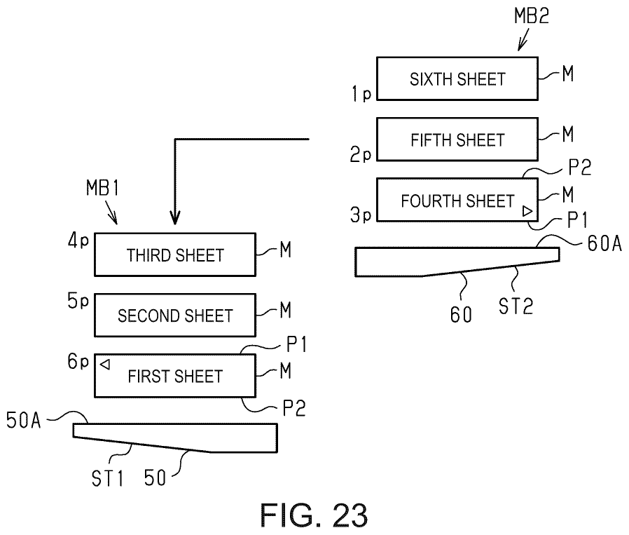

First, the third comparative example will be described with reference to FIG. 21 and FIG. 23. In the third comparative example, the FU stacker 50 is the first stacker ST1, and the FD stacker 60 is the second stacker ST2.

As shown in FIG. 21, first, the sixth page is printed on the first surface P1 of the first sheet. That is, the pattern PT of the sixth page is printed on the first surface P1 of the first sheet. Next, the fifth page is printed on the first surface P1 of the second sheet. Further, the fourth page is printed on the first surface P1 of the third sheet. In this way, the (n+1−k)th page is printed on the first surface P1 of the kth sheet (where k=123, . . . , n) of medium M.

For example, when the stacker switch cause such as the first stacker ST1 being full is detected, the discharge destination is switched from the first stacker ST1 to the second stacker ST2. In the third comparative example, the discharge destination is switched from the FU stacker 50 to the FD stacker 60. After the stacker is switched, printing on the first surface P1 of the medium M is similarly continued. After the stacker switch cause is detected, the fourth page is printed on the first surface P1 of the third sheet, the third page is printed on the first surface P1 of the fourth sheet, the second page is printed on the first surface P1 of the fifth sheet, and the first page is printed on the first surface P1 of the sixth sheet. The three medium M of the first to the third sheets are discharged to the first stacker ST1 through the first discharge path 44 in the unchanged orientation. The three medium M of the fourth to the sixth sheets are discharged to the second stacker ST2 through the second discharge path 45 in the inverted orientation.

As shown in FIG. 23, the medium M of the first to the third sheets are stacked on the stack surface 50A of the first stacker ST1 as the medium bundle MB1 stacked in an orientation in which the second surface P2 is the lower surface and the first surface P1 is the upper surface. That is, the medium bundle MB1 is stacked in an orientation in which the first surface P1, which is the print surface, is the upper surface. The medium M of the fourth to the sixth sheets are stacked on the stack surface 60A of the second stacker ST2 as the medium bundle MB2 stacked in an orientation in which the first surface P1 is the lower surface and the second surface P2 is the upper surface. That is, the medium bundle MB2 is stacked in an orientation in which the first surface P1, which is the print surface, is the lower surface.

Even if the medium bundle MB2 is stacked on the medium bundle MB1 as they are, the page order (also distinguishing between front and back pages) cannot be aligned when the n sheets of medium M are collected into one. Even if the medium bundle MB1 is inverted and stacked on the medium bundle MB2, the page order cannot be aligned in the same manner. Therefore, the user needs to perform an operation of aligning the medium bundle MB in the page order.

### Third Example

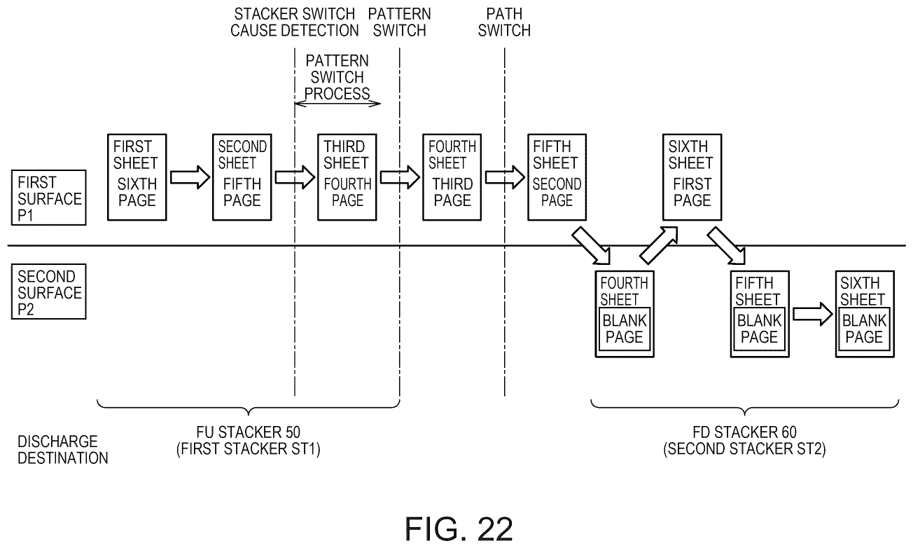

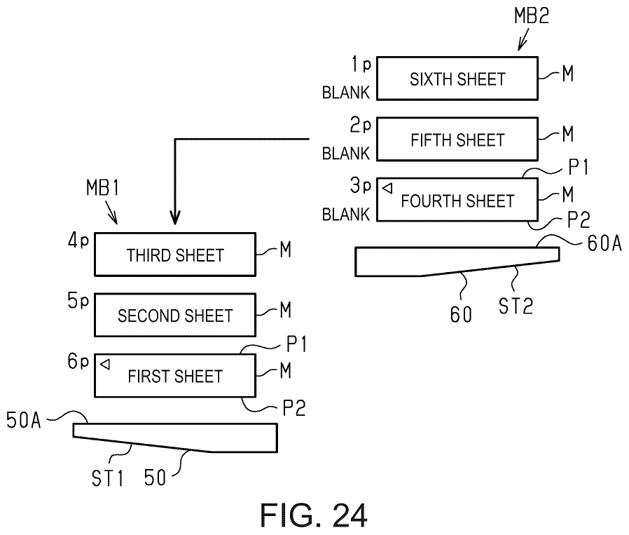

Next, the third example will be described with reference to FIG. 22 and FIG. 24. In the third example, the FU stacker 50 is the first stacker ST1, and the FD stacker 60 is the second stacker ST2.

In single-sided printing, a surface to be printed is set as the first surface P1. Before the discharge destination of the medium M is switched from the first stacker ST1 to the second stacker ST2 during printing, the medium M to be discharged to the first stacker ST1 are set to be discharged after printing is performed on the first surface P1. In a case of the discharge destination of the medium M is to be switched from the first stacker ST1 to the second stacker ST2 during printing, the medium M to be discharged to the second stacker ST2 are set to be discharged after being transported to the inversion path 47 after the first surface P1 is printed.

The printing device 11 includes the detection section that detects the stack amount of the first stacker ST1, similarly to the first embodiment. When it detects that the stack amount of the first stacker ST1 is equal to or greater than the threshold during printing, the discharge destination of the medium M is set to be switched from the first stacker ST1 to the second stacker ST2.

The printing device 11 includes the detection section that detects a jam of the medium M, similarly to the first embodiment. In a case of a jam is detected during printing, and the jammed medium M is detected to be passing through the branch position DP2, the discharge destination of the medium M subsequent to the jammed medium M is set to be switched from the first stacker ST1 to the second stacker ST2.

Further, the printing device 11 includes the detection section that detects an abnormality of the first stacker ST1. When an abnormality of the first stacker ST1 is detected during printing, the discharge destination of the medium M is set to be switched from the first stacker ST1 to the second stacker ST2.

In FIG. 22, the stacker switch cause is exemplified by a case where the stack amount of the first stacker ST1 becomes equal to or larger than the threshold. Note that the stacker switch cause may be a jam in the first discharge path 44 or an abnormality (stacking abnormality) of the first stacker ST1.

As shown in FIG. 22, before the stacker switch cause is detected, printing is performed in the same page order as in the third comparative example. That is, the sixth page is printed on the first surface P1 of the first sheet, and the fifth page is printed on the first surface P1 of the second sheet. In this way, the (n+1−k)th page is printed on the first surface P1 of the kth sheet (where k=123, . . . , n) of medium M.

For example, when the stack amount of the first stacker ST1 becomes equal to or larger than the threshold and the stacker switch cause is detected, the pattern switch process is performed first. During the pattern switch process, the printing of the third sheet proceeds. The fourth page is printed on the first surface P1 of the third sheet.

Here, the pattern switch process may be performed by the print control unit 200A on the host device 200 side. As described in the first embodiment, the reconstruction data RD1 may be created in advance by the first method, or the reconstruction data RD2 may be created by the second method when the stacker switch cause is detected. In addition, when the print job JD is received, in a case of it is possible to predict that the stack amount of the first stacker ST1 will become equal to or larger than the threshold during the execution of the current print job JD, the reconstruction data RD2 may be created in advance.

The pattern switch process may be performed by the control section 100 of the printing device 11, instead of the print control unit 200A of the host device 200 side. That is, in a case of the discharge destination of the medium M is to be switched from the first stacker ST1 to the second stacker ST2 during printing, the control section 100 may set the medium M to be discharged after transporting the medium M to the inversion path 47 after printing on the first surface P1. As described in the first embodiment, the control section 100 that performs such setting, in a case of the storage region 115 has a sufficient storage space, may create the reconstruction data RD1 by the first method, or when the stacker switch cause is detected or predicted, may create the reconstruction data RD2 by the second method.

When the first reconstruction data RD1 or the second reconstruction data RD2 can be created in advance, the pattern switch process does not require the process of rearranging the print data PD for each pattern PT, and thus the processing time is shortened.

When a new pattern is determined by the pattern switch process, the pattern switch is performed. In the example shown in FIG. 22, the pattern to be printed on the fourth and subsequent medium M is switched. By the pattern switch, printing is performed on the first surface P1 as before the pattern switch, and printing of a blank page is set on the second surface P2. Printing of the blank page refers to an operation in which the medium M is transported so as to pass through the print path 43 facing the printing section 20, but the printing section 20 does not substantially perform printing since the pattern PT is blank. The pattern PT being a blank sheet may be a blank sheet image of the image of the print data PD, or may be the print command corresponding to a blank sheet such as a line feed command or a page feed command without an image.

Since printing of the blank page is set to the second surface P2, the medium M is transported to the inversion path 47 after the first surface P1 is printed. That is, the medium M is inverted through the inversion path 47, and thus the surface that faces the printing section 20 is changed from the first surface P1 to the second surface P2. That is, printing of the blank page is set on the second surface P2 for the purpose of inverting the medium M.

Even after the pattern switch, printing on the first surface P1 of the medium M is continued. The third page is printed on the first surface P1 of the fourth sheet, the second page is printed on the first surface P1 of the fifth sheet, and the first page is printed on the first surface P1 of the sixth sheet. For the fourth to sixth sheets after the pattern switch, the blank page is set for the second surface P2, and thus the first surface P1 is printed, and then the fourth to sixth sheets are transported to the inversion path 47 and discharged. In this way, in a case of the discharge destination of the medium M is to be switched from the first stacker ST1 to the second stacker ST2 during printing, by setting the blank page in the second surface P2, the medium M discharged to the second stacker ST2 are discharged after being transported to the inversion path 47 after the first surface P1 is printed.

The medium M of the fourth to the sixth sheets of the pattern switch target are transported to the inversion path 47 and then discharged. Therefore, the total path length of the medium M transported during printing is longer than that of the medium M of the first to third sheets before the pattern switch. The transport speed of the medium in a case of printing on the first surface P1 is assumed a first speed V1, and the transport speed of the medium in the inversion path 47 is assumed a second speed V2. In the second embodiment, the second speed V2 is set to a value higher than the first speed V1. Therefore, although the medium M to be discharged to the second stacker ST2 after the first surface P1 is printed on is transported along a relatively long path length including the inversion path 47, the time required for it to be discharged to the second stacker ST2 is relatively short. While the preceding medium M is transported through the inversion path 47, printing is performed on the first surface P1 of the subsequent medium M. Therefore, the total required time required for the consecutively printing of n sheets in single-sided printing can be shortened as compared with a configuration in which the subsequent medium M is transported to the print path 43 after waiting until the preceding medium M transported through the inversion path 47 passes through the print path 43.

On the other hand, as shown in FIG. 22, the path switch is performed after a while from the pattern switch. When the first sensor 74 detects that the third sheet of medium M, which is the last sheet medium M to be discharged to the first stacker ST1, has passed through the branch position DP2, the path switch is performed. Specifically, when it is detected that the third sheet of the medium M has passed through the branch position DP2, by driving the path selection member 72 by the control section 100, and thus the path that selected by path selection member 72 is switched from the first discharge path 44 to the second discharge path 45. By this path switch, the discharge destination of the medium M is switched from the first stacker ST1 to the second stacker ST2. In the third example, the discharge destination is switched from the FU stacker 50 to the FD stacker 60.

The three medium M of the first to the third sheets are discharged to the first stacker ST1 through the first discharge path 44 while keeping the orientation of the time of printing in which the first surface P1 is the upper surface. On the other hand, the three sheets of medium M of the fourth sheet to the sixth sheet are discharged to the second stacker ST2 with their orientation changed from the orientation at the time of printing, in which the first surface P1 is the upper surface, by inversion in the inversion path 47 and inversion in the second discharge path 45. Therefore, the medium M of the fourth to the sixth sheets are discharged to the second stacker ST2 in an orientation in which the first surface P1 is the upper surface.

As shown in FIG. 24, the medium M of the first to the third sheets are stacked on the stack surface 50A of the first stacker ST1 as a medium bundle MB1 stacked in an orientation in which the second surface P2 is the lower surface and the first surface P1 is the upper surface. That is, the medium bundle MB1 is stacked in an orientation in which the first surface P1, which is the print surface, is the upper surface. The medium M of the fourth to the sixth sheets are stacked on the stack surface 60A of the second stacker ST2 as the medium bundle MB2 stacked in an orientation in which the second surface P2 is a lower surface and the first surface P1 is an upper surface. That is, the medium bundle MB2 is stacked in an orientation in which the second surface P2, which is the blank page (non-print surface), is the lower surface and the first surface P1, which is a print surface, is the upper surface. In FIG. 24, the orientation of the pattern indicated by the mark “A” in the lowermost medium M on each stacker 50 and 60 is also aligned between the stackers 50 and 60.

If the medium bundle MB2 is stacked on the medium bundle MB1 as they are, when the n sheets of medium M are collected into one, the print surfaces are facing upward, the orientations of the patterns are the same, and the medium M can be aligned in the descending page order from the bottom. Therefore, the user does not need to perform work such as aligning the front and back orientations of the print surfaces of the medium bundle MB, the page order, and the orientation of the pattern.

Note that even in a case where the stacker switch cause is jamming on the first discharge path 44 or an abnormality (stacking abnormality) of the first stacker ST1, the medium M subsequent to the jammed or stacking abnormality medium M are transported to the inversion path 47 and then discharged to the second stacker ST2. Therefore, when the medium bundle MB2 on the second stacker ST2 is stacked on the medium bundle MB1 on the first stacker ST1 as they are, the medium bundle MB in which the orientation of the print surface, the page order, and the orientation of the pattern are aligned can be acquired.

### Fourth Comparative Example

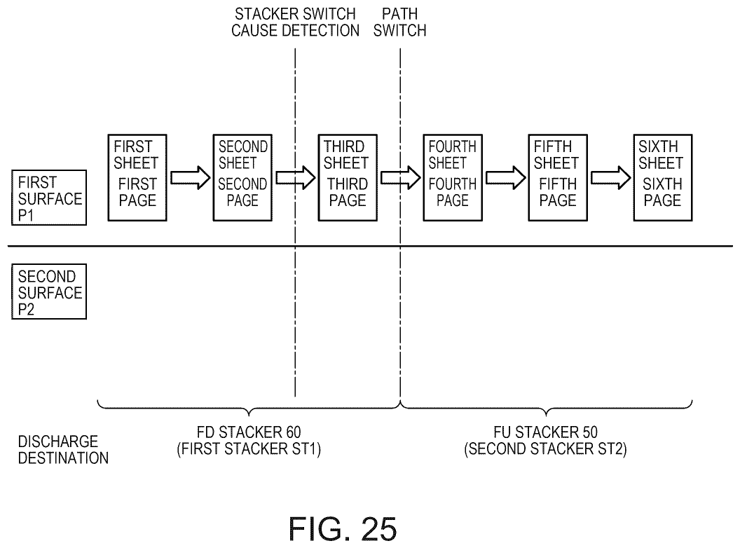

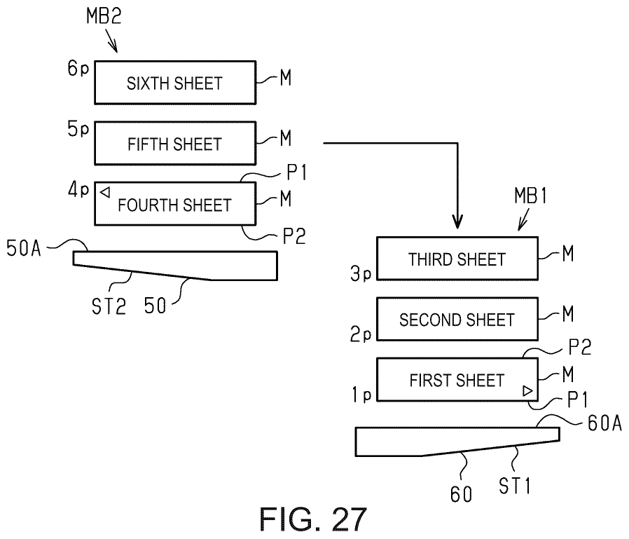

Next, the fourth comparative example will be described with reference to FIG. 25 and FIG. 27. In the fourth comparative example, the FD stacker 60 is the first stacker ST1, and the FU stacker 50 is the second stacker ST2.

As shown in FIG. 25, first, the first page is printed on the first surface P1 of the first sheet. Next, the second page is printed on the first surface P1 of the second sheet. In this way, the kth page is printed on the first surface P1 of the kth sheet (where k=123, . . . , n) of medium M.

For example, when the stacker switch cause such as the first stacker ST1 being full is detected, the discharge destination is switched from the first stacker ST1 to the second stacker ST2. In the third comparative example, the discharge destination is switched from the FD stacker 60 to the FU stacker 50. After the stacker is switched, printing on the first surface P1 of the medium M is similarly continued. After the stacker switch cause is detected, the third page is printed on the first surface P1 of the third sheet, the fourth page is printed on the first surface P1 of the fourth sheet, the fifth page is printed on the first surface P1 of the fifth sheet, and the sixth page is printed on the first surface P1 of the sixth sheet. The three medium M of the first to the third sheets are discharged to the first stacker ST1 with inversion through the second discharge path 45, and the three medium M of the fourth to sixth sheets are discharged to the second stacker ST2 with the orientation unchanged through the first discharge path 44.

As shown in FIG. 27, the medium M of the first to the third sheets are stacked on the stack surface 60A of the first stacker ST1 as a medium bundle MB1 stacked in an orientation in which the first surface P1 is the lower surface and the second surface P2 is the upper surface. That is, the medium bundle MB1 is stacked in an orientation in which the first surface P1, which is the print surface, is the lower surface. The medium M of the fourth to the sixth sheets are stacked on the stack surface 50A of the second stacker ST2 as the medium bundle MB2 stacked in an orientation in which the second surface P2 is the lower surface and the first surface P1 is the upper surface. That is, the medium bundle MB2 is stacked in an orientation in which the first surface P1, which is the print surface, is the upper surface.

Even if the medium bundle MB2 is stacked on the medium bundle MB1 as they are, the page order (in a case of the front and back pages are distinguished) cannot be aligned when the n sheets of medium M are collected into one. Even if the medium bundle MB1 is inverted and stacked on the medium bundle MB2, the page order cannot be aligned in the same manner. Therefore, the user needs to perform an operation of aligning the medium bundle MB in the page order.

### Fourth Example

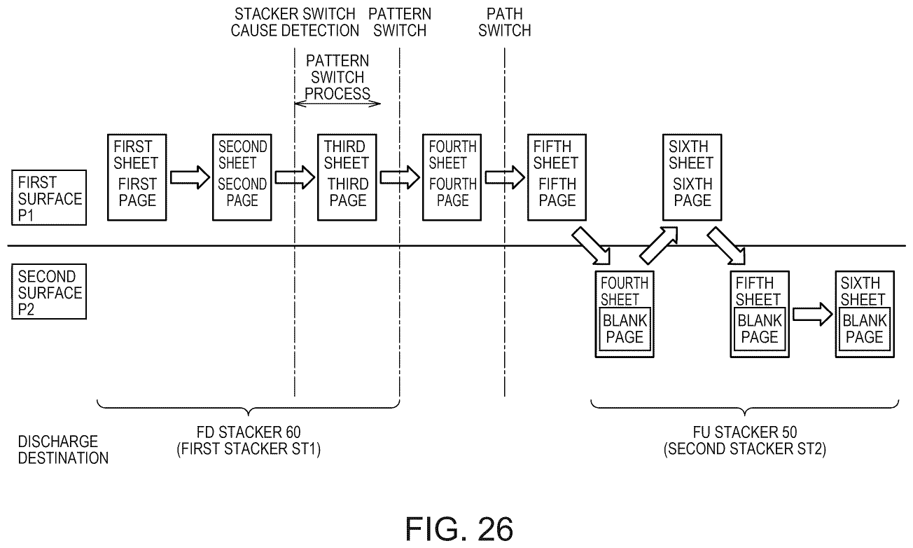

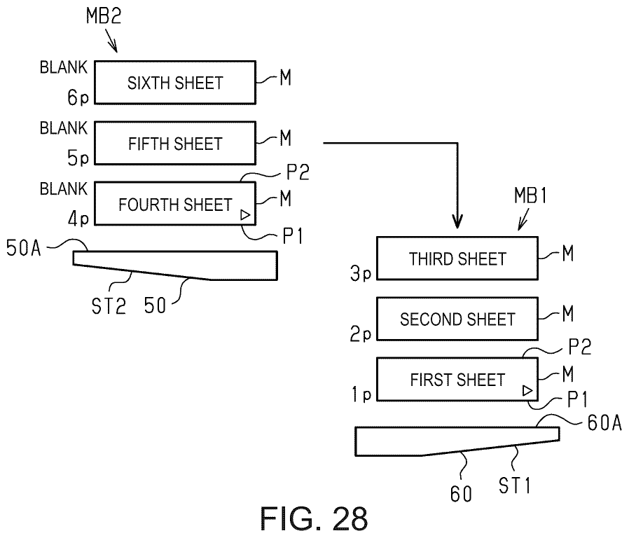

Next, the fourth example will be described with reference to FIG. 26 and FIG. 28. In the fourth example, the first stacker ST1 is the FD stacker 60, and the second stacker ST2 is the FU stacker 50.

Before the discharge destination of the medium M is switched from the first stacker ST1 to the second stacker ST2 during printing, the medium M to be discharged to the first stacker ST1 are set to be discharged after printing is performed on the first surface P1. In a case of the discharge destination of the medium M is to be switched from the first stacker ST1 to the second stacker ST2 during printing, the medium M to be discharged to the second stacker ST2 are set to be discharged after being transported to the inversion path 47 after the first surface P1 is printed.

As shown in FIG. 26, first, the first page is printed on the first surface P1 of the first sheet. Next, the second page is printed on the first surface P1 of the second sheet. In this way, the kth page is printed on the first surface P1 of the kth sheet (where k=123, . . . , n) of medium M.

For example, when the stack amount of the first stacker ST1 becomes equal to or greater than the threshold and the stacker switch cause is detected, the discharge destination is switched from the first stacker ST1 to the second stacker ST2. In the fourth example, the discharge destination is switched from the FD stacker 60 to the FU stacker 50. The control section 100 first determines switching of the stacker at the time of detection. The stacker switch includes three steps of the pattern switch process, the pattern switch, and the path switch.

During the pattern switch process, printing of the third sheet is started, and the third page is printed on the first surface P1 of the third sheet. Therefore, the medium M up to the third sheet are to be discharged to the first stacker ST1.

As a result of the pattern switch process, the pattern to be printed on the fourth and subsequent sheets of medium M is switched. By the pattern switch, the printing is continued on the first surface P1 of the fourth and subsequent sheets in the same manner as before the pattern switch. Further, printing of the blank page is set for the second surface P2 of the fourth and subsequent sheets. Printing the blank page is the same process as in the third example, and is switching (changing) the pattern content for the second surface P2 for the purpose of only inverting the medium M without printing on the second surface P2.

In the present embodiment, even after the pattern switch, printing on the first surface P1 of the medium M is continued. Therefore, the fourth page is printed on the first surface P1 of the fourth sheet, the fifth page is printed on the first surface P1 of the fifth sheet, and the sixth page is printed on the first surface P1 of the sixth sheet. For the fourth to sixth sheets after the pattern switch, the blank page is set for the second surface P2, and thus the first surface P1 is printed, and then the fourth to sixth sheets are transported to the inversion path 47 and discharged. In this way, in a case of the discharge destination of the medium M is to be switched from the first stacker ST1 to the second stacker ST2 during printing, by setting the blank page in the second surface P2, the medium M discharged to the second stacker ST2 are discharged after being transported to the inversion path 47 after the first surface P1 is printed.

In this manner, the three medium M of the first to the third sheets are transported to the second discharge path 45, and thus are discharged to the first stacker ST1 (FD stacker 60) with inversion. The three medium M from the fourth to the sixth sheets are transported to the inversion path 47 according to the setting of the blank page, are transported to the first discharge path 44, and are discharged to the second stacker ST2 (FU stacker 50) in the unchanged orientation. Accordingly, the medium M discharged to the second stacker ST2 are inverted through the inversion path 47 after the first surface P1 is printed, and further inverted through the second discharge path 45, and thus, the medium M are discharged to the second stacker ST2 in an orientation in which the first surface P1 is the upper surface.

As shown in FIG. 28, the medium M of the first to the third sheets are stacked on the stack surface 60A of the first stacker ST1 as the medium bundle MB1 stacked in an orientation in which the first surface P1 is the lower surface and the second surface P2 is the upper surface. That is, the medium bundle MB1 is stacked in an orientation in which the first surface P1, which is the print surface, is the lower surface. The medium M of the fourth to the sixth sheets are stacked on the stack surface 50A of the second stacker ST2 as the medium bundle MB2 stacked in an orientation in which the first surface P1 is the lower surface and the second surface P2 is the upper surface. That is, the medium bundle MB2 is stacked in an orientation in which the first surface P1, which is the print surface, is the lower surface.

Even if the medium bundle MB2 is stacked on the medium bundle MB1 as they are, the orientation of the print surfaces and the page order are aligned when the n sheets of medium M are collected into one. Therefore, the user does not need to perform an operation of aligning the orientation of the print surface of the medium bundle MB or the page order.

Note that even in a case where the stacker switch cause is jamming on the first discharge path 44 or an abnormality (stacking abnormality) of the first stacker ST1, the medium M subsequent to the jammed or stacking abnormality medium M are transported through the inversion path 47 and then discharged to the second stacker ST2. Therefore, when the medium bundle MB2 on the second stacker ST2 is stacked on the medium bundle MB1 on the first stacker ST1 as they are, the medium bundle MB in which the orientation of the print surface and the page order are aligned can be acquired.

### Effects of Second Embodiment

According to the second embodiment, the effects (1-9) to (1-11) in the first embodiment are similarly obtained and the following effects are obtained.

(2-1) The printing device 11 includes the printing section 20 that performs printing on the medium M, the transport section 30 that transports the medium M in the transport direction FD, and the first stacker ST1 and the second stacker ST2 that are provided downstream of the printing section 20 in the transport direction FD. The first stacker ST1 is discharged in a state where one surface of the medium M faces upward. the second stacker ST2 is discharged in a state where the other surfaces of the medium M, which is surfaces opposite to the one surfaces, face upward. The printing device 11 includes the inversion path 47 that is provided downstream of the printing section 20 in the transport direction FD and that is configured to invert the front and back of the medium M. The surface of the medium M on which printing is performed is set as the first surface P1. In single-sided printing, in a case of the discharge destination of the medium M is to be switched from the first stacker ST1 to the second stacker ST2 during printing, the medium M to be discharged to the second stacker ST2 are set to be discharged after being transported to the inversion path 47 after the printing is performed on the first surface P1. According to this configuration, the medium bundle MB1 discharged to the first stacker ST1 and the medium bundle MB2 discharged to the second stacker ST2 can be aligned. Therefore, even when the discharge destination to which the medium Mare discharged is switched from the first stacker ST1 to the second stacker ST2, the workability of the user can be improved.

(2-2) When the transport speed in a case of printing on the first surface P1 is set as the first speed V1 and the transport speed in the inversion path 47 is assumed the second speed V2, the second speed V2 is faster than the first speed V1. According to this configuration, although the path length is increased by the amount by which the medium M passes through the inversion path 47, it is possible to suppress a decrease in work efficiency by increasing the transport speed.

(2-3) It includes the detection section that detects the stack amount of the first stacker ST1. When it detects that the stack amount of the first stacker ST1 is equal to or greater than the threshold during printing, the discharge destination of the medium M may be switched from the first stacker ST1 to the second stacker ST2. According to this configuration, there is a concern that the medium M may overflow from the first stacker ST1 when continuously used even when it is full, but it is possible to suppress that.

(2-4) The control section 100 is provided that sets the medium M to be transported to the inversion path 47 and then discharged after printing on the first surface P1 in a case of the discharge destination of the medium M is to be switched from the first stacker ST1 to the second stacker ST2 during printing. According to this configuration, in order to switch the stacker, the control section 100 performs a setting change in which the medium M are transported to the inversion path 47 and then discharged after printing is performed on the first surface P1. Therefore, compared to a configuration in which the external device such as the host device 200 changes the setting, the time required for communication can be saved. Therefore, it is easy to more quickly switch the stacker of the discharge destination.

### Third Embodiment

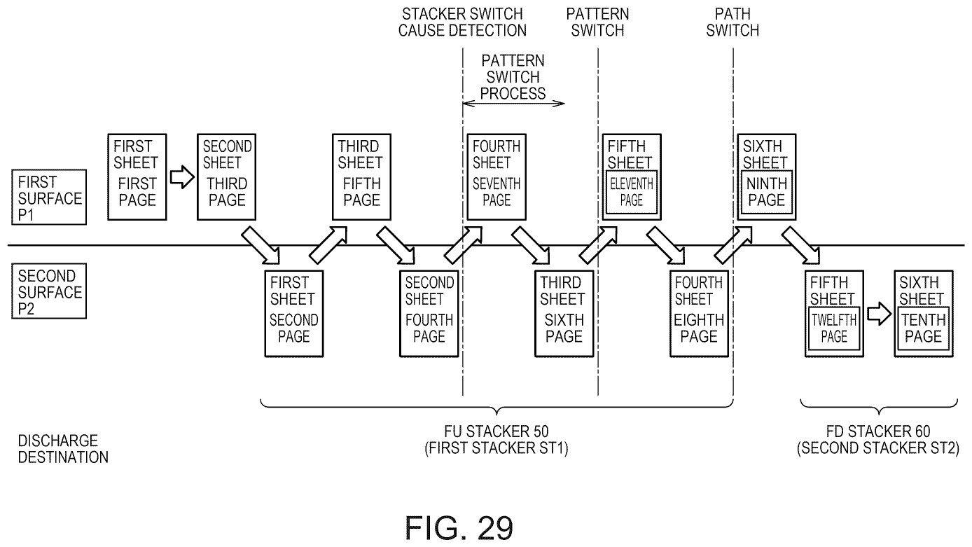

Next, a third embodiment will be described with reference to FIG. 29 to FIG. 34. The third embodiment is an example in which the front and back orientations of the medium M to be discharged to the second stacker ST2 are inverted in the printing device 11 of the first embodiment.

The printing device 11 has the same configuration as that shown in FIG. 1 and the same electrical configuration as that shown in FIG. 8 in the first embodiment. That is, the printing device 11 includes the printing section 20, the transport section 30, the FU stacker 50, and the FD stacker 60. The printing device 11 is communicably connected to the host device 200. The control section 100 in the printing device 11 performs printing on the medium M and discharging of the medium M after printing to the designated first stacker ST1 based on the print job data JD received from the print control unit 200A in the host device 200.

The printing device 11 may include the detection section that detects that the stack amount of the first stacker ST1 is equal to or greater than the threshold, the detection section that detects jam of the medium M, and the detection section that detects an abnormality of the first stacker ST1, similarly to the first embodiment. When the detection section detects the stacker switch cause during printing, the discharge destination of the medium M is set to switch from the first stacker ST1 to the second stacker ST2.

When the stacker switch cause of one of the conditions (a) to (c) (for example, condition (a)) is detected during printing, the control section 100 receives the reconstruction data from the data reconstruction section 202 of the print control unit 200A. In a case where the control section 100 includes the data reconstruction section 122, the data reconstruction section 122 may generate the reconstruction data. The data reconstruction section 202 and 122 restructures all or part of the plurality of print data PD in the print job data JD shown in FIG. 15 described in the first embodiment, thereby generating one of two types of reconstruction data RD1 and RD2. Note that the specific contents of the reconstruction data RD1 and RD2 used in the third embodiment are different from those in the first embodiment (FIG. 15).

As in the first embodiment, assuming that in a case of double-sided printing, among the surfaces of the medium M, a surface to be printed first is a first surface P1 and a surface to be printed later is the second surface P2. Assuming that in a case where the discharge destination of the medium M is the first stacker ST1, a page to be printed on the first surface P1 is set to the first page, and a page to be printed on the second surface P2 is set to the second page. When the discharge destination of the medium M is to be switched from the first stacker ST1 to the second stacker ST2 during printing, the following settings are made for the medium M to be discharged to the second stacker ST2. The printing order is set in descending order from the last page of the entire pages, and the page to be printed on the first surface P1 is set as the first page, and the page to be printed on the second surface P2 is set as the second page.

Hereinafter, an example in which the stacker switch control is performed by mainly applying the condition (a) among the conditions (a) to (c) will be described. The following description will be made mainly on the differences from the first embodiment in the stacker switch control.

Hereinafter, an example in which the stacker is switched from the first stacker ST1 to the second stacker ST2 when the stacker switch condition is satisfied by the detection of the stacker switch cause during the execution of the print job JD in which the consecutively printing of printing on both sides of the first sheet to the nth sheet of medium M is instructed using double-sided printing will be described with reference to FIG. 29 to FIG. 34. A fifth example in which the FU stacker 50 is the first stacker and a sixth example in which the FD stacker 60 is the first stacker will be described below in order.

### Fifth Example

Next, the fifth example will be described with reference to FIG. 29 to FIG. 31. The fifth example is an example in which the first stacker is the FU stacker 50 and the second stacker is the FD stacker 60. In the fifth example, the stacker switch cause is, for example, a case where the stack amount of the first stacker ST1 becomes equal to or greater than the threshold. Note that the stacker switch cause may be a jam in the first discharge path 44 or an abnormality (stacking abnormality) of the first stacker ST1.

As shown in FIG. 29, using double-sided printing, printing is performed on the first surface P1 and the second surface P2 of the medium M. After printing is performed on the first surface P1, the medium M are transported to the inversion path 47 and inverted. By this inversion, the printing section 20 can print on the second surface P2.

Before the detection of the stacker switch cause, the first page is printed on the first surface P1 of the first sheet. While the medium of the first sheet is being inverted, the third page is printed on the first surface P1 of the second sheet. Further, the second page is printed on the second surface P2 of the first sheet after it was inverted. While the second sheet is being inverted, the fifth page is printed on the first surface P1 of the third sheet. The fourth page is printed on the second surface P2 of the second sheet that was inverted. In this way, the odd-numbered pages (=(2k−1) pages) are printed on the first surface P1 of the kth sheet (where k=123, . . . , n) of medium, and the even-numbered pages (=2k pages) are printed on the second surface P2.

Assuming that in a case where the discharge destination of the medium M is the first stacker ST1, a page to be printed on the first surface P1 is set to the first page, and a page to be printed on the second surface P2 is set to the second page. In this case, the first page corresponds to an odd-numbered page (=(2k−1) page), and the second page corresponds to an even-numbered page (=2k page). In this way, in the fifth example, before the stacker switch of the discharge destination is determined, the odd-numbered pages are printed on the first surface P1 and the even-numbered pages are printed on the second surface P2 in the ascending printing order from the first page of the entire pages.

In the printing order of double-sided printing before the stacker switch of the discharge destination is determined, the second surface P2 of the k−1th sheet and the first surface P1 of the k+1th sheet are printed in this order between the first surface P1 and the second surface P2 of the kth sheet. However, in the first sheet (k=1), the k−1th sheet does not exist, and in the nth sheet (k=n) sheet, the k+1th sheet does not exist.

When the stack amount of the first stacker ST1 becomes equal to or more than the threshold and a stacker switch cause is detected during printing, the discharge destination is switched from the first stacker ST1 to the second stacker ST2. The control section 100 first determines switching of the stacker at the time of detection. The stacker switch includes three steps of the pattern switch process, the pattern switch, and the path switch.

The pattern switch process is a process of switching the order of pages to be printed so that the page order is matched when one of the medium bundles MB1 and MB2 stacked on the stackers ST1 and ST2 is inverted and then overlapped on the other even when the discharge destination is switched from the first stacker ST1 to the second stacker ST2.

In a case of the discharge destination of the medium M is to be switched from the first stacker ST1 to the second stacker ST2 during printing, the contents to be printed on the first surface P1 and the second surface P2 are set as follows for the medium M to be discharged to the second stacker ST2. That is, the printing order is set in descending order from the last page of the entire pages, and the page to be printed on the first surface P1 is set as the first page, and the page to be printed on the second surface P2 is set as the second page. In the present embodiment, the odd-numbered pages are set to the first surface P1 and the even-numbered pages are set to the second surface P2 in descending printing order from the last page of the print job JD.

Specifically, since the page order to be printed is descending from the last page, in the medium M of the kth sheet, the odd-numbered page (=(2 (n+1−k)−1) page) is set as the first page on the first surface P1 and the even-numbered page (=2 (n+1−k) page) is set as the second page on the second surface P2.

The pattern switch process is executed by the data reconstruction section 202 or the control section 100 on the host device 200 side. The data reconstruction section 202 may prepare one of the reconstruction data RD1 and RD2 obtained by rearranging the print data PD when the print job JD is received, or may create the reconstruction data RD2 when detected. The data reconstruction section 122 may prepare one of the reconstruction data RD1 and RD2 instead of the data reconstruction section 202. The data reconstruction section 202 and 122 creates the first reconstruction data RD1 or the second reconstruction data RD2 (see FIG. 15) that defines the printing order of double-sided printing after the stacker switch of the discharge destination is determined by arranging the print data PD according to the above described rule.

As shown in FIG. 29, during the pattern switch process, the seventh page is printed on the first surface P1 of the fourth sheet. Therefore, the pattern switch is performed from the first surface P1 of the fifth sheet. The discharge destination of medium M up to the fourth sheets is the first stacker ST1.

When the pattern switch is performed from the mth sheet (k=m), the printing order before the pattern switch is applied up to the m−1th sheet, and the printing order after the pattern switch is applied from the mth sheet. The first page (odd-numbered page) to be printed on the first surface P1 of the kth sheet (k=m, m+1, . . . , n) after the mth sheet is the 2(n−k+m)−1th page, and the second page (even-numbered page) to be printed on the second surface P2 is the 2(n-k+m)th page.

As shown in FIG. 29, after the pattern switch, the pages selected in descending page order from the last page (for example, page 12) among the pages of the entire print job JD are set, and the first page (odd-numbered page) is set in the first surface P1. The first surface P1 of the fifth sheet is set to the maximum odd-numbered page, for example, page 11. When the eleventh page is printed on the first surface P1 of the fifth sheet, and next, the eighth page is printed on the second surface P2 of the fourth sheet that has been inverted. Up to the fourth sheet, the page order before the stacker switch is applied.

In this manner, when the printing on both sides of the fourth sheet is completed, the path switch is performed. When the first sensor 74 detects that the trailing edge of the medium M of the fourth sheet has passed through the branch position DP2, the control section 100 switches the path selected by the path selection member 72 (see FIG. 1 for both) from the first discharge path 44 to the second discharge path 45. In this manner, path switching is performed to switch the discharge destination to the second stacker ST2.

Thereafter, in the page order after the stacker switch, the ninth page is printed on the first surface P1 of the sixth sheet, the twelfth page is printed on the second surface P2 of the fifth sheet, and the tenth page is printed on the second surface P2 of the sixth sheet. Then, the fifth and the sixth sheets, which have been printed on both sides, are sequentially discharged to the FD stacker 60, which is the second stacker ST2.

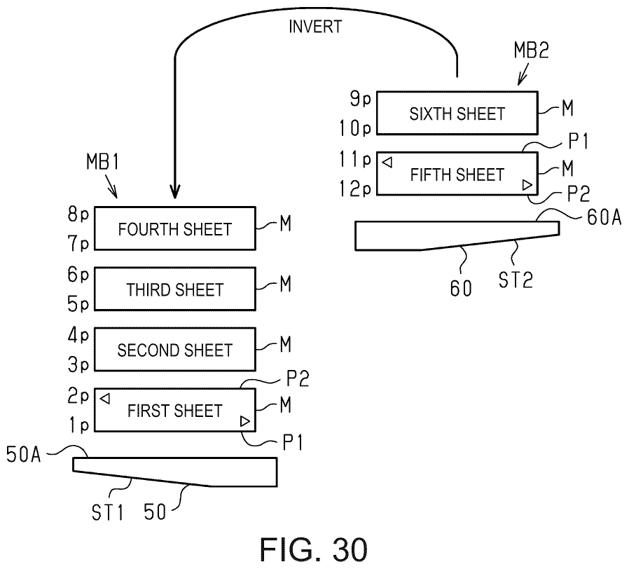

Then, as shown in FIG. 30, the medium M of the first to the fourth sheets are stacked on the stack surface 50A of the first stacker ST1 as the medium bundle MB1 stacked in an orientation in which the first surface P1 is the lower surface and the second surface P2 is the upper surface. The medium bundle MB1 is stacked in the page order in which 1p to 8p are arranged in ascending order from the bottom.

The medium M of the fifth and the sixth sheets are stacked on the stack surface 60A of the second stacker ST2 as the medium bundle MB2 stacked in an orientation in which the second surface P2 is the lower surface and the first surface P1 is the upper surface. The medium bundle MB2 is stacked in the page order in which 12p to 9p are arranged in descending order from the bottom.

In general, the FD stacker 60 tends to be easily recognized by the user when the medium bundle MB is stacked with the print surface facing the lower surface. Therefore, the user inverts the medium bundle MB when taking out the medium bundle MB from the FD stacker 60. In the fifth example, when the medium bundle MB1 is inverted by 180° and stacked on the medium bundle MB2, the medium bundles are collected into one medium bundle MB in which the page order is aligned. In the medium bundle MB that is collected into one, 1p to 12p are arranged in ascending order from the bottom. Two medium bundles MB1 and MB2 discharged separately to two stackers ST1 and ST2 can be easily collected into one aligned medium bundle MB without much labor.

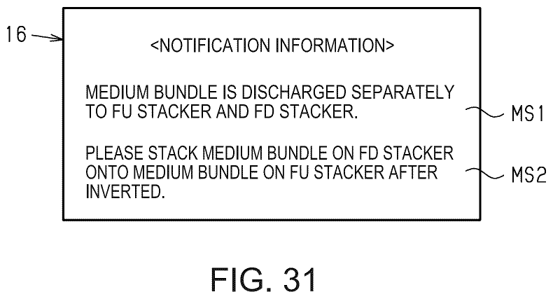

As shown in FIG. 31, the display section 16, which is an example of the notification section, may notify that the discharge destination is to be switched. When the stacker is to be switched in the stacker switch control, the control section 100 may display that the discharge destination is to be switched on the display section 16.

For example, as shown in FIG. 31, the display section 16 displays a first message MS1 as information indicating that the medium bundle is to be discharged separately to two stackers 50 and 60. Further, as information on the method of stacking two medium bundles MB1 and MB2, which are separately discharged to the two stackers 50 and 60, on one medium bundle in which the page order is aligned, the second message MS2 may be displayed on the display section 16. In the example shown in FIG. 31, in the display section 16, display “PLEASE STACK MEDIUM BUNDLE ON FD STACKER ONTO MEDIUM BUNDLE ON FU STACKER AFTER INVERTED.” as the second message MS2. Note that the two types of messages MS1 and MS2 may be displayed on different screens or at different timings on the display section 16.

### Stacker Switching Control at Jam Occurrence

Even in a case where the stacker switch cause is jamming on the first discharge path 44, the medium M subsequent to the jammed medium M are discharged to the second stacker ST2. For example, in a case of a jam or a stacking abnormality occurs in the Jth sheet, the path selected by the path selection member 72 is switched. For example, from the medium M of the subsequent J+1th sheets are discharged to the second stacker ST2.

At this time, all of the medium M after the J+1th sheet including the medium M on which printing has already been started in the order of the pages before the stacker switch are discharged to the second stacker ST2. After the pattern switch process, the printing is performed with the switched pattern from the mth sheet, for example. After the pattern switch, the first page (odd-numbered page) selected in the descending page order from the last page of the entire pages is printed on the first surface P1, and the second page (even-numbered page) selected in the descending page order from the last page is printed on the second surface P2.

As shown in FIG. 29, as described above, the first surface P1 and the second surface P2 are printed in the page order before the stacker switch up to the fourth sheet. After the pattern switch, the eleventh page is printed on the first surface P1 of the fifth sheet, the eighth page is printed on the second surface P2 of the fourth sheet, the ninth page is printed on the first surface P1 of the sixth sheet, the twelfth page is printed on the second surface P2 of the fifth sheet, and the tenth page is printed on the second surface P2 of the sixth sheet. Then, the J+1th and subsequent sheets of medium M on which printing on both sides is completed are sequentially discharged to the FD stacker 60, which is the second stacker ST2. In the example shown in FIG. 29, for example, when the second sheet (Jth sheet) is jammed, the medium M of the third to twelfth sheets are sequentially discharged to the FD stacker 60, which is the second stacker ST2.

Here, the control section 100 acquires the print data PD of the pages selected in descending order also from the sixth page sheet onward. That is, each print data PD is acquired in the order of the seventh page of the first surface P1 of the seventh sheet, the eighth page of the second surface P2 of the seventh sheet, the fifth page of the first surface P1 of the eighth sheet, the sixth page of the second surface P2 of the eighth sheet, the third page of the first surface P1 of the ninth sheet, and the fourth page of the second surface P2 of the ninth sheet. The control section 100 has discharged up to the third sheet to the second stacker ST2 after the stacker switch cause detection that is a jam or a stacking abnormality, and has acquired information indicating that the Jth sheet of the medium M that caused the jam is the second sheet in the example shown in FIG. 29. When the control section 100 completes the printing on both sides of the sixth sheet, the control section 100 skips the seventh and the eighth sheets, and sequentially prints the third page of the first surface P1 of the ninth sheet and the fourth page of the second surface P2 of the ninth sheet. The medium M on which the third page is printed on the first surface P1 and the fourth page is printed on the second surface P2 have the same print content as the second sheet that caused the jam. Therefore, the same print content as the medium M that caused the jam is printed on the last (nominally the ninth) sheet of medium M. Therefore, it is possible to omit reprinting with the same print content as the medium M that caused the jam.

Note that the printing device 11 may have a function of printing the seventh and the eighth sheets that have been skipped, according to the setting selected by the user. When the stacking abnormality is detected as the stacker switch cause, the control section 100 similarly executes the stacker switch control in the same processing procedure.

The display section 16 also notifies that the discharge destination is to be switched when a jam is detected or when a stacking abnormality is detected. In addition to the two types of messages MS1 and MS2, may be displayed the following information on the display section 16. For example, in a case of the jam detection, information on the stacker switch cause (for example, jam), information on the Jth sheet being the jam, information for notifying the user that the printing content of the Jth sheet has been reprinted on the last (uppermost) medium M of the medium bundle MB2 on the second stacker ST2, and information for prompting the user to invert the front and back of the two sheets (third and fourth sheets) from the bottom of the medium bundle MB2 may be displayed. Note that in a case of the stacking abnormality, the reprinting is not performed. The display section 16 may display information indicating that there are medium with a stacking abnormality on the first stacker ST1.

### Sixth Example

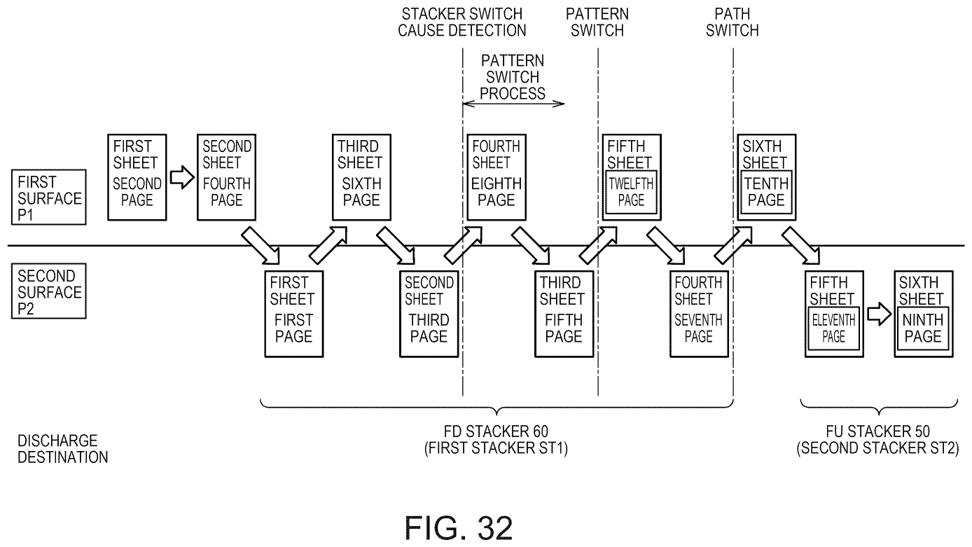

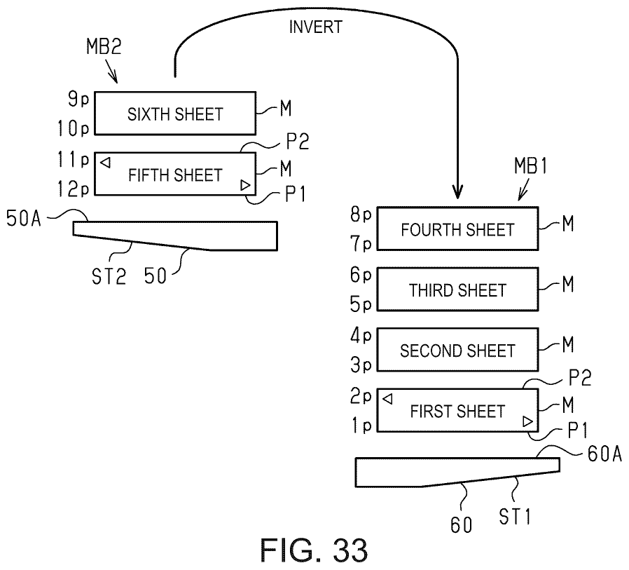

Next, the sixth example will be described with reference to FIG. 32 to FIG. 34. The sixth example is an example in which the FD stacker 60 is the first stacker and the FU stacker 50 is the second stacker. As shown in FIG. 33, the medium M on which double-sided printing has been performed are discharged to the FD stacker 60, which is the first stacker ST1, in an orientation in which the second surface P2 is the lower surface and the first surface P1 is the upper surface. Therefore, on the medium M, the even-numbered page is printed on the second surface P2, which is the lower surface, and the odd-numbered page is printed on the first surface P1, which is the upper surface. When the plurality of medium M are sequentially stacked on the stack surface 60A from the first sheet, printing is performed such that pages are arranged in ascending order from the bottom.

Assuming that in a case where the discharge destination of the medium M is the first stacker ST1, a page to be printed on the first surface P1 is set to the first page, and a page to be printed on the second surface P2 is set to the second page. In the sixth example, the first page is the even-numbered page (=2k page), and the second page is the odd-numbered page (=(2k−1) page).

As shown in FIG. 32, before the stacker switch cause is detected, the second page is printed on the first surface P1 of the first sheet. While the medium of the first sheet is being inverted, the fourth page is printed on the first surface P1 of the second sheet. Further, the first page is printed on the second surface P2 of the first sheet that has been inverted. While the second sheet is being inverted, the sixth page is printed on the first surface P1 of the third sheet. The third page is printed on the second surface P2 of the second sheet that has been inverted. In this way, the even-numbered pages (=2k pages) are printed on the first surface P1 of the kth sheet (where k=123, . . . , n) of medium, and the odd-numbered pages (=(2k−1) pages) are printed on the second surface P2.

In the printing order of double-sided printing, the second surface P2 of the k−1th sheet and the first surface P1 of the k+1th sheet are printed in this order between the first surface P1 and the second surface P2 of the kth sheet. However, on the first sheet, the k−1th sheet does not exist, and in the nth sheet, the k+1th sheet does not exist.

When the stack amount of the first stacker ST1 becomes equal to or more than the threshold and a stacker switch cause is detected during printing, the discharge destination is switched from the first stacker ST1 to the second stacker ST2. The control section 100 first determines switching of the stacker at the time of detection. The stacker switch includes three steps of the pattern switch process, the pattern switch, and the path switch.

The pattern switch process is a process of switching the order of pages to be printed so that the page order is matched when one of the medium bundles MB1 and MB2 stacked on the stackers ST1 and ST2 is inverted and then overlapped on the other even when the discharge destination is switched from the first stacker ST1 to the second stacker ST2.

In the sixth example, as a result of the pattern switch process, the printing order is set in descending order from the last page of the entire pages, and the page to be printed on the first surface P1 is set as the first page, and the page to be printed on the second surface P2 is set as the second page. In the present embodiment, the even-numbered pages are set as the first page to be printed on the first surface P1 in descending printing order from the last page of the print job JD. An odd-numbered page is set as the second page to be printed on the second surface P2.

The pattern switch process is executed by the data reconstruction section 202 or the control section 100 on the host device 200 side. The data reconstruction section 202 may prepare one of the reconstruction data RD1 and RD2 obtained by rearranging the print data PD when the print job JD is received, or may create the reconstruction data RD2 when detected. The data reconstruction section 122 may prepare one of the reconstruction data RD1 and RD2 instead of the data reconstruction section 202. The data reconstruction section 202 and 122 creates the first reconstruction data RD1 or the second reconstruction data RD2 (see FIG. 15) that defines the printing order of double-sided printing after the stacker switch of the discharge destination is determined by arranging the print data PD according to the above described rule.

As shown in FIG. 32, during the pattern switch process, the eighth page is printed on the first surface P1 of the fourth sheet. Therefore, the pattern switch is performed from the first surface P1 of the fifth sheet. The discharge destination of medium M up to the fourth sheets is the first stacker ST1.

When the pattern switch is performed from the mth sheet (k=m), the printing order before the pattern switch is applied up to the m−1th sheet, and the printing order after the pattern switch is applied from the mth sheet. The first page (even-numbered page) to be printed on the first surface P1 of the kth sheet (k=m, m+1, . . . , n) after the mth sheet is the 2(n−k+m)th page, and the second page (odd-numbered page) printed on the second surface P2 is the 2(n−k+m)−1th page.

As shown in FIG. 32, after the pattern switch, the pages selected in descending page order from the last page (for example, page 12) among the pages of the entire print job JD are set, and the first page (even-numbered page) is set in the first surface P1. For example, the twelfth page, which is the maximum even-numbered page, is set as the first surface P1 of the fifth sheet. When the twelfth page is printed on the first surface P1 of the fifth sheet, the seventh page, which is the page order before the stacker switch, is printed on the second surface P2 of the fourth sheet that has been inverted next. The medium M of the fourth sheet on which double-sided printing is completed is discharged to the first stacker ST1. When the first sensor 74 detects that the medium M of the fourth sheet has passed through the branch position DP2, the control section 100 switches the path selected by the path selection member 72 (see FIG. 1 for both) from the second discharge path 45 to the first discharge path 44. In this manner, path switching is performed to switch the discharge destination to the second stacker ST2.

Thereafter, in the page order after the pattern switch, the tenth page is printed on the first surface P1 of the sixth sheet, the eleventh page is printed on the second surface P2 of the fifth sheet, and the ninth page is printed on the second surface P2 of the sixth sheet. Then, the fifth and the sixth sheets, which have been printed on both sides, are sequentially discharged to the FD stacker 60, which is the second stacker ST2.

Then, as shown in FIG. 33, the medium M of the first to the fourth sheets are stacked on the stack surface 60A of the first stacker ST1 as the medium bundle MB1 stacked in an orientation in which the first surface P1 is the upper surface and the second surface P2 is the lower surface. The medium bundle MB1 is stacked in the page order in which 1p to 8p are arranged in ascending order from the bottom.

The medium M of the fifth and the sixth sheets are stacked on the stack surface 50A of the second stacker ST2 as the medium bundle MB2 stacked in an orientation in which the first surface P1 is the lower surface and the second surface P2 is the upper surface. The medium bundle MB2 is stacked in the page order in which 12p to 9p are arranged in descending order from the bottom.

In general, the user tends to recognize that the medium bundle MB is stacked on the FU stacker 50 in an orientation in which the first page is positioned on the uppermost surface, and the medium bundle MB is stacked on the FD stacker 60 in an orientation in which the first page is positioned on the lowermost surface. Therefore, in a case of the user stacks the medium bundle MB1 taken out from the FD stacker 60 and the medium bundle MB2 taken out from the FU stacker 50 into one, tries to invert one over and then place it on top of the other. As shown in FIG. 33, in the sixth example, when the medium bundle MB1 is inverted by 180° and stacked on the medium bundle MB2, the medium bundles are collected into one medium bundle MB in which the page order is aligned. In the medium bundle MB that is collected into one, 1p to 12p are arranged in ascending order from the bottom. Two medium bundles MB1 and MB2 discharged separately to two stackers ST1 and ST2 can be easily collected into one aligned medium bundle MB without much labor.

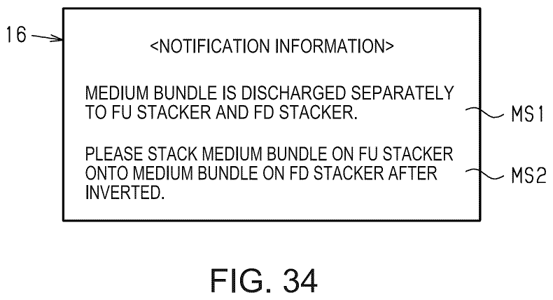

As shown in FIG. 34, the display section 16 notifies that the discharge destination is to be switched. Two types of messages MS1 and MS2 may be displayed on the display section 16. In the example shown in FIG. 34, in the display section 16, display “PLEASE STACK MEDIUM BUNDLE ON FU STACKER ONTO MEDIUM BUNDLE ON FD STACKER AFTER INVERTED.” as the second message MS2.

The user who views these messages MS1 and MS2 inverts the medium bundle MB2 by 180° and stacks it on the medium bundle MB1. Accordingly, one medium bundle MB in which the page order is aligned can be acquired. In the medium bundle MB that is collected into one, 1p to 12p are arranged in ascending order from the bottom. Two medium bundles MB1 and MB2 discharged separately to two stackers ST1 and ST2 can be easily collected into one aligned medium bundle MB without much labor.

Note that in a case of a jam that may stacker switch cause is detected, the control section 100 executes the stacker switch control in the same processing procedure as that of the fifth example. When the abnormality of the first stacker ST1 is detected as the stacker switch cause, the control section 100 also executes the stacker switch control in the same processing procedure as that of the fifth example.

### Effects of Third Embodiment

According to the third embodiment, the effects (1-1) to (1-11) in the first embodiment are similarly obtained and the following effects are further obtained. Note that specifically, the effects (1-2) to (1-6) and (1-8) to (1-11) in the first embodiment are similarly obtained by the fifth example, and the effects (1-1) to (1-11) in the first embodiment are similarly obtained by the sixth example.

(3-1) The printing device 11 includes the printing section 20, the transport section 30, the first stacker ST1, and the second stacker ST2. Assuming that in a case of double-sided printing, among the surfaces of the medium M, a surface to be printed first is the first surface P1, and a surface to be printed later is the second surface P2. Assuming that in a case where the discharge destination of the medium M is the first stacker ST1, a page to be printed on the first surface P1 is set to the first page, and a page to be printed on the second surface P2 is set to the second page. In a case of the discharge destination of the medium M is to be switched from the first stacker ST1 to the second stacker ST2 during printing, the medium M to be discharged to the second stacker ST2, the printing order is set in descending order from the last page of the entire pages, and the page to be printed on the first surface P1 is set as the first page, and the page to be printed on the second surface P2 is set as the second page. According to this configuration, the medium bundle MB1 discharged to the first stacker ST1 and the medium bundle MB2 discharged to the second stacker ST2 can be aligned. For example, when one of the medium bundle MB1 discharged to the first stacker ST1 and the medium bundle MB2 discharged to the second stacker ST2 is inverted and stacked on the other medium bundle, the two medium bundles MB1 and MB2 can be collected into one aligned medium bundle MB. Therefore, even when the discharge destination to which the medium M are discharged is switched from the first stacker ST1 to the second stacker ST2, the workability of the user can be improved.

### Fourth Embodiment

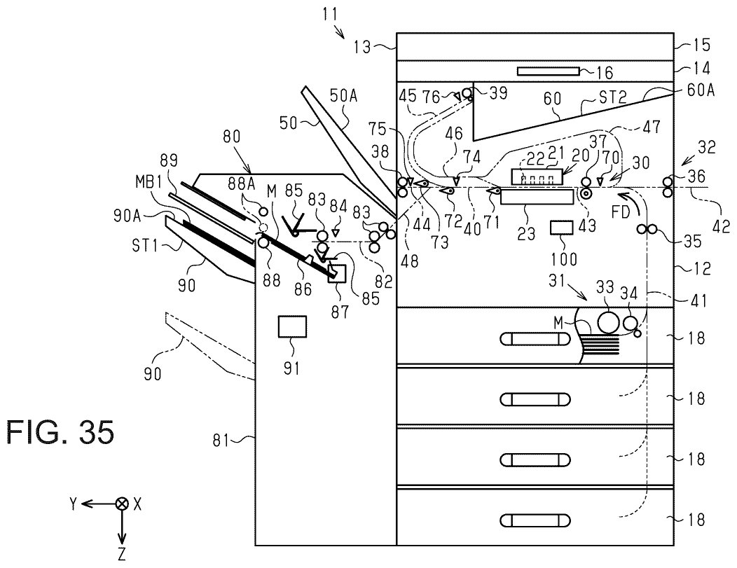

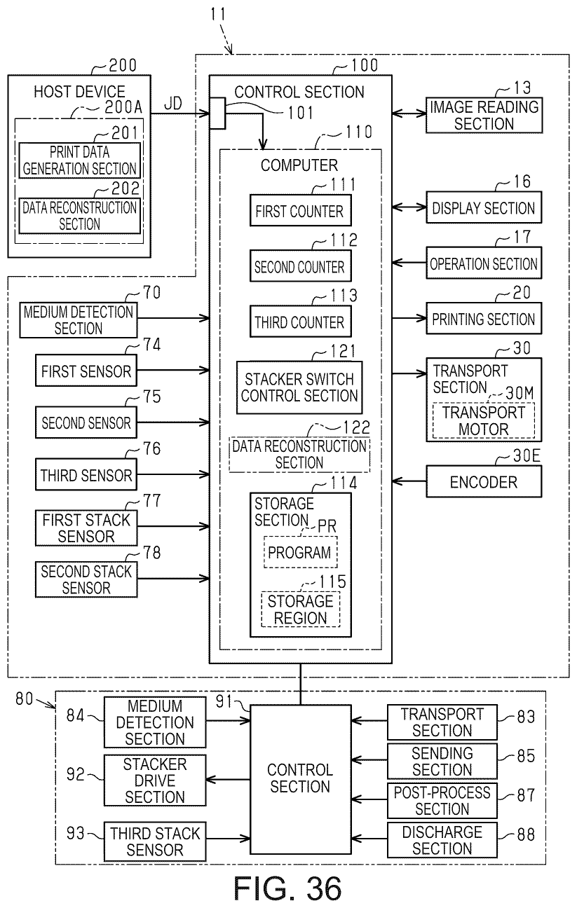

Next, a fourth embodiment will be described with reference to FIG. 35 and FIG. 36.

The printing device 11 of the fourth embodiment includes a post-processing device 80 that performs a post-process on the printed medium M. The post-processing device 80 performs the post-process on the medium M discharged from inside the housing 12 via the third discharge path 48. The post-processing device 80 includes a discharge stacker 90 to which the medium M after the post-process is discharged. The discharge stacker 90 is a face-up stacker to which the medium M is discharged in a state where the print surface, which is a surface on which the printing section 20 has performed printing last, of the two front and back surfaces of the medium M to be discharged faces upward. When the printing in the housing 12 is single-sided printing, the medium M is stacked on a stack surface 90A of the discharge stacker 90 in a state in which the first surface faces upward. When the printing in the housing 12 is double-sided printing, the medium M is stacked on the stack surface 90A of the discharge stacker 90 in a state where the second surface faces upward.

The post-processing device 80 includes a housing 81. The housing 81 has a substantially rectangular parallelepiped shape. The housing 81 is connected to the housing 12 in a state where the medium M can be delivered. The post-processing device 80 includes a transport path 82, a transport section 83, a feed section 85, an intermediate tray 86, and a post-processing section 87 in the housing 81. The post-processing device 80 may include a medium detection section 84 that can detect the medium M at a predetermined position on the transport path 82.

The transport path 82 is formed in a path including a path section having an angle at which the medium M discharged from the third discharge path 48 can be received. The transport section 83 is formed of a roller pair that transports the medium M along the transport path 82. A plurality of (for example, three) transport sections 83 each including a roller pair are provided along the transport path 82.

The intermediate tray 86 is disposed near the lower side of the transport section 83, which is made up of the transport roller, positioned on the most downstream side. The intermediate tray 86 is a tray on which the medium M to be subjected to the post-process is placed. The feed section 85 is disposed at a position near the downstream edge of the transport path 82. The feed section 85 is controlled to be driven at a predetermined timing based on a signal indicating that the medium detection section 84 has detected the medium M. The feed section 85 performs a feeding operation of guiding the medium M discharged from the transport path 82 to the intermediate tray 86. The feed section 85 guides the medium M discharged from the transport path 82 to the intermediate tray 86 positioned below.

The feed section 85 may be a paddle having a plurality of blades (vane sections) as shown in FIG. 35. The paddle is configured of an elastic material such as rubber or elastomer. The feed section 85 rotates in the counterclockwise direction in FIG. 35. The feed section 85 guides the medium M to the intermediate tray 86 by an operation of tapping the upper surface of the medium M discharged substantially horizontally. Further, the plurality of feed sections 85 feed the medium M to the upstream side (lower right in FIG. 35) along the upper surface of the intermediate tray 86 until the medium M contacts a stopper. A plurality of medium M is stacked on the intermediate tray 86 in a state where the upstream edges thereof are aligned.

When the number of stacked sheets of the medium bundle on the intermediate tray 86 reaches the target number of sheets, the post-processing section 87 performs post-process on the upstream edge section of the medium bundle. The post-process is, for example, a staple process for binding with a needle. Note that the post-process may be punching, shifting, saddle stitching, folding, or the like.

A discharge section 88 performs a discharge operation of sending out the medium bundle on which the post-process has been performed from the intermediate tray 86 to the downstream side. The discharge section 88 includes a discharge roller pair. The discharge roller pair includes a drive roller and a driven roller 88A that is contactable to and separable from the drive roller. The driven roller 88A is retracted to the retracted position indicated by the solid line in FIG. 35 before the post-process is performed on the medium bundle. The driven roller 88A moves to a drive position indicated by a two dot chain line in FIG. 35 at the time of discharge after the post-process. The medium bundle after the post-process is discharged from the intermediate tray 86 to the downstream side (upper left in FIG. 35) by driving the discharge section 88.

The medium M discharged by the discharge section 88 fall onto the discharge stacker 90 or onto the medium bundle on the stack surface 90A after both edge sections of the medium M are guided partway along a guide member 89. The discharge stacker 90 is a moving type that is movable along the vertical direction Z. The discharge stacker 90 moves downward as the stack amount of the medium bundle increases. In this manner, the medium bundle is stacked on the discharge stacker 90.

FIG. 36 shows an electrical configuration of the printing device 11 according to the present embodiment. The control section 100 of the printing device 11 is connected to a control section 91 of the post-processing device 80 in a communicable state. The medium detection section 84, the transport section 83, the feed section 85, the post-processing section 87, the discharge section 88, the stacker drive section 92, and a third stack sensor 93 are electrically connected to the control section 91. The print job data JD received by the control section 100 from the print control unit 200A of the host device 200 includes the print condition information and post-process condition information. The post-process condition information includes post-process information for designating the content 4 the post-process and post-process sheet number information for designating the number of sheets of the medium bundle to be subjected to the post-process. The post-process information is, for example, the staple process or the like. The post-process sheet number information determines a target number of sheets of medium bundles to be stacked on the intermediate tray 86. The control section 100 sends a post-process request based on the post-process condition information to the control section 91.

The control section 91 controls the transport section 83, the feed section 85, the post-processing section 87, and the discharge section 88 based on the post-process request. The control section 91 stacks the medium M on the intermediate tray 86, and performs post-process on the medium bundle every time the number of medium in the stacked medium bundle reaches the target number of sheets. Further, the control section 91 drives the discharge section 88 after the post-process, thereby discharging the medium bundle to the discharge stacker 90. The third stack sensor 93 detects the stack amount of the medium bundle on the discharge stacker 90. The stacker drive section 92 raises and lowers the discharge stacker 90 according to the stack amount. The third stack sensor 93 is a detection section that detects that the stack amount of the discharge stacker 90 reaches equal to or greater than a threshold. The threshold is smaller than the maximum amount of the stack amount of the discharge stacker 90. The threshold may be set to a value smaller than the maximum amount by a distance corresponding to a predetermined number of sheets of medium M. The stacker drive section 92 lowers the discharge stacker 90 so that the falling distance of the discharged medium bundle falls within a certain range based on the stack amount detected by the third stack sensor 93. The maximum stacking height at which the medium bundle can be stacked in a state where the discharge stacker 90 is at the lowest position at the time of stacking shown by the two dot chain line in FIG. 35 is the maximum amount.

The contents of the stacker switch control are basically the same as those of the first to the third embodiments. In the present embodiment, the discharge stacker 90 of the post-processing device 80 is a first stacker ST1, and the FD stacker 60 is a second stacker ST2. In the case of double-sided printing, the control section 100 executes the stacker switch control similar to that of the first embodiment (FIG. 10) or the third embodiment (FIG. 29). In the case of single-sided printing, the control section 100 executes the stacker switch control similar to that of the second embodiment (FIG. 22). It is different from the above described embodiments in that the stack to be stacked on the discharge stacker 90, which is the first stacker ST1, is the medium M or the medium bundle after the post-process. Therefore, in the present embodiment, since medium are discharged in a unit of medium bundle to the discharge stacker 90, which is the first stacker ST1, the timing of pattern switch is adjusted according to the target number of sheets.

The control section 100 of the printing device 11 performs stacker switch control. The stacker switch cause is the conditions (a) to (c) described in the first embodiment. The target for jam detection is a path range including the third discharge path 48 and the transport path 82, which are downstream of the branch position DP2. This target path range may include a path from the transport path 82 to the discharge path of the discharge section 88 via the intermediate tray 86. The abnormality of the first stacker ST1 may be detected by the third stack sensor 93 or a sensor dedicated to the abnormality detection.

Hereinafter, the stacker switch control in which the discharge stacker 90 of the post-processing device 80 is set as the first stacker ST1 will be described. As an example, the medium M on which double-sided printing has been performed are sequentially fed to the post-processing device 80, the post-process is performed on the medium bundle in which a predetermined number of sheets of medium are stacked, and then the medium bundles after the post-process are sequentially discharged to the first stacker ST1 (discharge stacker 90). An example of the stacker switch control in the printing operation involving such the post-process will be described with reference to FIG. 10.

The control section 100 transmits the post-process request together with the post-process condition information to the control section 91 of the post-processing device 80. The control section 91 performs the requested post-process according to the post-process conditions. For example, the staple process is performed as an example of the post-process, in which the edge section of the medium bundle of a predetermined number of sheets is stapled together with the needle.

Hereinafter, a case where the stacker switch control similar to that of the first example of the first embodiment is performed will be described as an example with reference to FIG. 10 and the like. When the post-processing device 80 is used, a multi-copy printing is often selected. The print job JD includes information on the number of copies of the multi-copy printing. FIG. 10 shows the printing procedure of one copy when the stacker switch cause is detected in the multi-copy printing. In printing multiple copies, the printing procedure shown in FIG. 10 is repeated the same number of times as the number of copies designated. FIG. 10 corresponds to one printing procedure in which the stacker switch cause is detected among the plurality of printing procedures. Note that in the following description, the number of print sheets in one printing procedure (printing of one copy) is assumed to be eight sheets instead of six sheets in FIG. 10. In this example, the post-process is performed on every four sheets of the eight sheets. In this way, the post-process may be performed with the number of sheets obtained by equally dividing the number of print sheets of one copy into a plurality of sheets as one copy, or the post-process may be performed with the number of print sheets of one copy as one copy.

As shown in FIG. 10, before the stacker switch cause detection, the first page is printed on the first surface P1 of the first sheet, the third page is printed on the first surface P1 of the second sheet, the second page is printed on the second surface P2 of the first sheet, the fifth page is printed on the first surface P1 of the third sheet, and the fourth page is printed on the second surface P2 of the second sheet. In this way, the odd-numbered pages (=(2k−1) pages) are printed on the first surface P1 of the kth sheet (where k=123, . . . , n) of medium, and the even-numbered pages (=2k pages) are printed on the second surface P2.

Assuming that in a case where the discharge destination of the medium M is the first stacker ST1, a page to be printed on the first surface P1 is set to the first page, and a page to be printed on the second surface P2 is set to the second page. In this case, the first page corresponds to an odd-numbered page (=(2k−1) page), and the second page corresponds to an even-numbered page (=2k page).

The detection section detects that the stack amount of the discharge stacker 90 reaches equal to or greater than the threshold during printing. The control section 100 detects this stacker switch cause by the notification from the control section 91 on the post-processing device 80 side. By this detection, the discharge destination of the medium M is switched from the first stacker ST1 to the second stacker ST2. First, the stacker switch is determined. The stacker switch includes three steps of the pattern switch process, the pattern switch, and the path switch.

The pattern switch process is the same as that of the above embodiments. In the example shown in FIG. 10, the same pattern switch process as that of the first embodiment is performed. That is, one of the data reconstruction sections 202 and 122 creates the reconstruction data RD by the pattern switch process. Note that one of the data reconfiguration sections 202 and 122 may create and prepare one of the reconfiguration data RD1 and RD2 in advance before the stacker switch is determined when the print job JD is received. That is, before the switching of the discharge destination of the medium M from the first stacker ST1 to the second stacker ST2 is determined, the print data PD in a case of discharging to the first stacker ST1 and the print data in a case of discharging to the second stacker ST2 may be generated.

By the pattern switch process, the page to be printed on the first surface P1 is set to the second page, and the page to be printed on the second surface P2 is set to the first page, of the medium M to be discharged to the second stacker ST2. In the example shown in FIG. 10, the medium M to be discharged to the second stacker ST2 are set such that the page to be printed on the first surface P1 is set to the even-numbered page (=2k page), which is the second page. The page to be printed on the second surface P2 is set to the odd-numbered page (=(2k−1) page), which is the first page. Next, the pattern switch is performed. In the example shown in FIG. 10, the pattern PT is switched from the fifth sheet based on the first print data PD in the reconstruction data RD created in the pattern switch process.

In the present embodiment, when the detection section (third stack sensor 93) detects that the stack amount of the first stacker ST1 is equal to or greater than the threshold, the control section 100 adjusts the pattern switch timing according to the stack amount of the intermediate tray 86. That is, in a case where the stacker switch cause is a type of stacker switch cause that does not cause a problem even if the medium M are continuously transported toward the first stacker ST1 even after the detection, the control section 100 adjusts the pattern switch timing according to the stack amount of the intermediate tray 86. Specifically, the control section 100 adjusts the pattern switch timing so that one copy of the medium bundle (for example, four sheets) is stacked on the intermediate tray 86. The control section 100 performs an adjustment according to the stack amount on the intermediate tray 86 to delay the timing by a maximum of a predetermined number of sheets from the fastest pattern switch timing. The predetermined number of sheets may be a number of sheets (TN−1) that is one sheet less than the target number of sheets TN. In this manner, the control section 100 adjusts the pattern switch timing between the fastest pattern switching timing and the pattern switch timing delayed by (TN−1) sheets, according to the stack amount of the intermediate tray 86.

After the pattern switch, the control section 100 adjusts the number of sheets of the medium M to be discharged to the second stacker ST2 so that a predetermined number of copies of the medium bundles are stacked on the second stacker ST2 (FD stacker 60). The predetermined number of copies is the number of copies in a case of the target number of sheets to be stacked on the intermediate tray 86 is one copy. That is, the predetermined number of copies is a natural number multiple of the target number of sheets. The predetermined number of copies may be one copy or a plurality of copies. The predetermined number of copies may be, for example, one copy (target number of sheets).

Here, the target number of sheets to be stacked on the intermediate tray 86 is set to, for example, four sheets. In the example shown in FIG. 10, the fourth sheet corresponds to the fourth sheet, which is the target number of sheets of the medium bundle on the intermediate tray 86. Therefore, as shown in FIG. 10, the pattern switch is performed from the fifth sheet.

The tenth page, which is the second page (even-numbered page), is printed on the first surface P1 of the fifth sheet. Next, the eighth page, which is the second page (even-numbered page), is printed on the second surface P2 of the fourth sheet in the printing order before the pattern switch. Further, the twelfth page is printed on the first surface P1 of the sixth sheet, the ninth page is printed on the second surface P2 of the fifth sheet, and the eleventh page is printed on the second surface P2 of the sixth sheet in the order of the print data PD after the pattern switch.

When the last medium M among the medium M on which the first page is printed on the first surface P1 after the stack amount is detected equal to or greater than the threshold passes through the branch position DP2, it switches from the first stacker ST1 to the second stacker ST2. That is, the control section 100 performs the path switch after the pattern switch. The branch position DP2 is a position where the first path (for example, the third discharge path 48) to the first stacker ST1 and the second path (for example, the second discharge path 45) to the second stacker ST2 branch off from each other. The control section 100 switches the path selected by the second path selection member 72 at the branch position DP2 from the first discharge path 44 toward the first stacker ST1 to the second discharge path 45 toward the second stacker ST2. By this path switch, the medium M on which the second page is printed on the first surface P1 and the first page is printed on the second surface P2 are discharged to the second stacker ST2. Then, when the printing section 20 finishes printing the twelfth sheet, the control section 100 interrupts the printing.

As a result, the medium bundle of the amount equal to or larger than the threshold and equal to or smaller than the maximum amount is stacked on the discharge stacker 90, which is the first stacker ST1. One copy of the medium bundle (target number of sheets) is stacked on the intermediate tray 86. That is, a total of four medium M of the first to the fourth sheets, which are the target number of sheets, are stacked on the intermediate tray 86 in the ascending page order from the bottom. This one copy of the medium bundle may perform the staple process. Further, one copy of the medium bundle (target number of sheets) is stacked on the second stacker ST2. That is, the medium bundle of four medium M of the fifth to the eighth sheets, which is the target number of sheets, is stacked on the second stacker ST2 in ascending page order from the bottom.

The display section 16 displays messages MS1 and MS2 having the same meaning as in FIG. 16. That is, the display section 16 displays, as the message MS1, information indicating that the medium bundle is to be discharged separately to the two stackers 90 and 60. The display section 16 displays, as the message MS2, information on a method of stacking the group of medium bundles and the medium bundles discharged separately to the two stackers 90 and 60 on one medium bundle group having a consistent page order. In the display section 16, for example, display “After the staple process is performed on the medium bundle on the FD stacker, please stack the medium bundle onto the medium bundle on the discharge stacker in the unchanged orientation” as the second message MS2.

The user who views the display content of the display section 16 takes out the target number of sheets of the medium bundle from the FD stacker 60, and manually performs the staple process on the medium bundle using the staple process. The stapled medium bundle is placed on the medium bundle group on the discharge stacker 90 in the unchanged orientation. In this manner, the medium bundle that has been manually post-process by the user can be collected into one, in a state where they are aligned, by placing the medium bundles onto the medium bundle group placed on the discharge stacker 90 while keeping the orientation when they were stacked on the FD stacker 60.

The post-processing device 80 may be configured to manually insert the medium bundle into the intermediate tray 86 and cause the post-processing section 87 to perform the post-process. First, the user removes the medium bundle group on the discharge stacker 90. The medium bundle is taken out from the FD stacker 60. For example, after switching the post-processing device 80 to the manual mode, the user inserts the medium bundle from the opened discharge section 88 into the intermediate tray 86 from the downstream edge side of the second stacker ST2 in the discharge direction while keeping the orientation of the medium bundle taken out from the FD stacker 60.

When the user operates the start button, the manual mode is started. For example, when a sensor (not shown) detects the medium bundle, the roller pair of the discharge section 88 is closed and reversely rotated, and thus the medium bundle is carried onto the intermediate tray 86. The feed section 85 may be driven in the carrying-in process. The medium bundle sent upstream in the transport direction FD by driving the feed section 85 is aligned in a state where the upstream edge is aligned by contacting the upstream edge in the transport direction FD (downstream edge in the sending direction) to the stopper. Next, the post-processing section 87 performs the staple process on the upstream edge section of the medium bundle on the intermediate tray 86. After the post-process is completed, the discharge section 88 discharges the medium bundle from the intermediate tray 86. The discharged medium bundle is stacked on the discharge stacker 90. In this manner, the medium bundle group can be collected into one in a state of being aligned by placing the medium bundle subjected to the post-process in the manual mode of the post-processing device 80 on the medium bundle group previously stacked on the discharge stacker 90 while keeping the orientation of the medium bundle discharged to the discharge stacker 90.

Note that in a case of single-sided printing, the control section 100 may perform stacker switch control similar to that in the second embodiment. In a case of double-sided printing, the control section 100 may perform stacker switch control similar to that of the third embodiment. In single-sided printing or double-sided printing, when the stack amount of the first stacker ST1 becomes equal to or greater than the threshold and the stacker switch cause is detected, the control section 100 adjusts the pattern switch timing so that one medium bundle is stacked on the intermediate tray 86 according to the stack amount on the intermediate tray 86, as described above.

### Effects of Fourth Embodiment

According to the fourth embodiment, the effects (1-1) to (1-11) in the first embodiment, the effects (2-1) to (2-4) in the second embodiment, and the effect (3-1) in the third embodiment are similarly obtained, and the following effects are further obtained. The following effects are obtained.

(4-1) Even when an abnormality such as full stack occurs, the printing operation and the post-process operation of the printing device 11 can be continued without stopping. Moreover, the medium bundle MB2 is stacked on the FD stacker 60 of the switching destination in the same order as the medium bundle MB1 on the discharge stacker 90 before the switching. Therefore, when the post-process is manually performed on the medium bundle, or when the medium bundle is manually inserted into the discharge section 88 when the post-processing device 80 is caused to perform the post-process in the manual mode, it is difficult to get the front and back sides of the medium bundles wrong.

Note that the above described embodiment may be changed into the embodiment such as the following modified examples. Further, an appropriate combination of the above described embodiment and the modified examples described below may be used as a further modified example, and an appropriate combination of modified examples described below may be used as a further modified example.
In the above described embodiment, both the jam detection section and the stacking abnormality detection section are provided as the detection section that detects an abnormality, but only one of the jam detection section and the stacking abnormality detection section may be provided. That is, the printing device 11 may be configured to include only the jam detection section or only the stacking abnormality detection section as the detection section.
Conditions other than the conditions (a) to (c) may be adopted. For example, the occurrence of a jam or a stacking abnormality may be predicted from detection information detected during printing, and the pattern switch process may be started at an early stage before the abnormality is confirmed. In the conditions (b) and (c), a waiting time may be required until the jam and the stacking abnormality are confirmed. For example, a waiting time corresponding to a time required for transport of a margin distance occurs until the jam is confirmed. In a case where the stack sensor detects the stacking abnormality of the medium M, a waiting time until the medium M during the falling is out of the detection region of the stack sensor is necessary in order to distinguish the medium M during the falling from the medium M in the inclined posture. Therefore, when a waiting time shorter than the waiting time confirmed for the conditions (b) and (c) to be satisfied has elapsed, stacker switching may be determined, and pattern switch processing (see FIG. 10) may be started to generate reconstruction data RD. In practice, there is a case where no jam or stacking abnormality occurs after a necessary waiting time has elapsed, but in this case, the reconstruction data RD is discarded.
In each of the above described embodiments, the execution timing of the pattern switch process may be used for each stacker switch cause. In a case where the occurrence of the stacker switch cause can be predicted at the stage of receiving the print job JD, the pattern switch process may be executed in advance, and in a case where the prediction cannot be performed, the pattern switch process may be executed at the stage where the stacker switch cause occurs. The stacker switch cause that can be predicted includes the condition (a) in a case of the stack amount of the first stacker ST1 becomes equal to or greater than the threshold. Whether or not the condition (a) is satisfied during the execution of the current print job may be predicted from the information of the current stack amount of the first stacker ST1 and the number of print sheets to be printed instructed by the print job JD. For example, the current stack amount (stacking height) of the first stacker ST1 is acquired by the reflection-type stack sensors 77 and 78 indicated by a two dot chain line in FIG. 6 and FIG. 7. Alternatively, the control section 100 acquires the current stack amount (number of stacked sheets) of the first stacker ST1 using the count value of the second counter 112. The control section 100 specifies the difference in number of sheets Δn corresponding to the difference between the current stack amount and the threshold, and determines whether or not the number of print sheets n designated in the current print job JD is equal to or greater than the difference in number of sheets Δn. In the specification of the difference in number of sheets Δn, the accuracy of prediction may be increased by using the medium thickness information determined from medium type information designated in the current print job JD. If the number of print sheets n is equal to or greater than the difference in number of sheets Δn, in the current print job JD, the sheets up to the Δnth sheet can be discharged to the first stacker ST1, and the discharge destination is switched to the second stacker ST2 from the Δn+1th sheet. The control section 100 can create the reconstruction data RD2 after receiving the print job JD and before the stack amount of the first stacker ST1 reaches the threshold. For example, using double-sided printing of the first embodiment, the control section 100 prepares the reconstruction data RD2 in which the page to be printed on the first surface P1 is set to the second page and the page to be printed on the second surface P2 is set to the first page in advance before the stack amount of the first stacker ST1 reaches the threshold. According to this configuration, when the stack amount of the first stacker ST1 becomes equal to or greater than the threshold, the pattern switch can be quickly performed using the reconstruction data RD2 created in advance, and therefore the discharge destination can be quickly switched from the first stacker ST1 to the second stacker ST2.
The notification section is not limited to the display section 16. The notification section may notify that the stacker is switched by light emission of the light emitting section. For example, each of the stackers 50 and 60 has the light emitting section. The light emitting section is disposed at a position such as the front surface of the stacker 50 and 60 where the user can easily visually recognize the light emitting section. For example, the light emitting section may be provided on a side surface that is the front surface of the stacker. The light emitting section may perform notification by lighting or blinking. The notification section may be a sound generation section. The sound generation section may be a speaker or a buzzer. In the case of the speaker, the sound may be voice. For example, the message may be read aloud by voice.
In the first embodiment, in a case of the discharge destination of the subsequent medium M is to be switched from the first stacker ST1 to the second stacker ST2 after the detection section detects jamming or a stacking abnormality, the medium before the pattern switch, on which the second page is already printed on the second surface P2 at the time of the detection, may be set to be discharged to the second stacker ST2 after being transported to the inversion path 47. In this case, the medium after the pattern switch in which the first page is to be printed on the second surface P2 may temporarily wait at a position upstream of the merging position of the print path 43 and the inversion path 47 so as not to overtake the preceding medium M passing through the inversion path 47 one extra time. Further, the medium after the pattern switch, the medium is set so that after the first page is printed on the second surface P2 in accordance with the reconstruction data RD and discharged to the second stacker ST2 without passing through the inversion path 47. According to this configuration, it is possible to align at least the page order of the medium bundle MB1 discharged to the first stacker ST1 and the medium bundle MB2 discharged to the second stacker ST2. Therefore, the workability of the user can be improved.
In the second embodiment, in a case of the discharge destination of the subsequent medium M is to be switched from the first stacker ST1 to the second stacker ST2 after the detection section detects jamming or a stacking abnormality, the control section 100 may perform the following control. The control section 100 may be set to execute an urgent transport control by executing a program to be executed when a jam is detected or when a stacking abnormality is detected, and to transport the medium before the pattern switch, which have already been printed on the first surface P1, to the inversion path 47 and then discharge the medium to the second stacker ST2 when it is detected. This urgent transport control is not applied to the medium after the pattern switch. The medium after the pattern switch is set to be transported to the inversion path 47 by printing the blank page based on the reconstruction data RD and then discharged to the second stacker ST2. According to this configuration, even when jamming or a stacking abnormality is detected during printing, the number of sheets of the medium M that the user needs to align can be reduced when the user collects the medium bundle MB1 discharged to the first stacker ST1 and the medium bundle MB2 discharged to the second stacker ST2 into one. Therefore, the workability of the user can be improved.
The first embodiment and the second embodiment may be used in combination, or only the first embodiment may be adopted, or only the second embodiment may be adopted. The second embodiment and the third embodiment may be used in combination, or only the third embodiment may be adopted. The first embodiment and the third embodiment may be used in combination, and the user may select one of the first embodiment and the third embodiment.
In each of the embodiments, the stacker switch control is applied to both the case where the FU stacker 50 is the first stacker ST1 and the case where the FD stacker 60 is the first stacker ST1, but may be applied to only one of the cases. It may be applied only to a case where the FU stacker 50 is the first stacker ST1, or may be applied only to a case where the FD stacker 60 is the first stacker ST1.
In the third embodiment, in a case of the medium bundle MB2 is inverted, the inverting may be performed with a side parallel to the discharge direction as the rotation center instead of the inverting with the side intersecting (for example, orthogonal to) the discharge direction of the medium M as the rotation center. In this case, in order to avoid the orientation of the pattern PT from becoming misaligned, the orientation of the print data PD of the reconstruction data RD may be reversed for the medium M after the pattern switch that are discharged to the second stacker ST2.
In the first and third embodiments, double-sided printing is not limited to the short-side binding, but may be the long-side binding. Even in a case of double-sided printing of the long-edge binding, the pattern switch process similar to that in the first and third embodiments may be performed. That is, in the first embodiment, the page to be printed on the first surface P1 may be set as the second page, and the page to be printed on the second surface P2 may be set as the first page. In the third embodiment, the medium M to be discharged to the second stacker ST2, the printing order may be set in descending order from the last page of the entire pages, and the page to be printed on the first surface P1 may be set as the first page, and the page to be printed on the second surface P2 is set as the second page.
In the first embodiment, for example, in a case of the pattern PT to be printed on the medium is printing of a plurality of copies in which only two pages of p1 and p2 are printed on two front and back surfaces P1 and P2 of the medium M, the pages between the medium M may not be in order. After the pattern switch, the second page may be set on the first surface P1 of the medium M, and the first page may be set on the second surface P2. In this case, the order of the first pages (for example, odd-numbered pages) to be printed on the first surface P1 and the order of the second pages (for example, even-numbered pages) printed on the second surface P2 may not be ascending or descending.
The following control may be performed in a case of it is detected that the stack amount of the first stacker ST1 is equal to or larger than the threshold. After the detection, the discharge destination may be switched to the second stacker ST2 to continue printing, and when it is detected that the medium bundle is removed from the first stacker ST1 during the subsequent printing, the discharge destination may be returned to the first stacker ST1 at the time of the detection or in a case of it is detected that the stack amount of the second stacker ST2 is equal to or greater than the threshold. In this case, the display section 16 may display the second message MS2 as information indicating that the medium bundle MB2 on the second stacker ST2 should be inserted between pages of the medium bundle MB1 on the first stacker ST1.
In the fourth embodiment, the printing device 11 may have a configuration in which an intermediate process device (not shown) is interposed between the housing 12 and the post-processing device 80. The intermediate process device includes an inversion mechanism that inverts the medium M. In this case, the discharge stacker 90 is the face-down stacker to which the medium M is discharged in a state where the print surface, which is the surface on which the printing section 20 has performed printing last, of the two front and back surfaces of the medium M to be discharged faces downward. Therefore, the discharge stacker 90 of the post-processing device 80 is the first stacker ST1, and the FU stacker 50 is the second stacker ST2. In the case of double-sided printing, the control section 100 executes the stacker switch control similar to that in the first embodiment (FIG. 18) or the third embodiment (FIG. 32). In the case of single-sided printing, the control section 100 executes the stacker switch control similar to that of the second embodiment (FIG. 26). In this case, the print control unit 200A of the host device 200 or the control section 100 may perform the pattern switch process of rearranging the order of the print data PD so that the page order and the pattern orientation of the medium bundle group and the medium bundle discharged from the first stacker ST1 and the second stacker ST2 are aligned even when the medium M are inverted in the intermediate process device. Further, the pattern switch timing may be adjusted so that one medium bundle (target number of sheets) is stacked on the intermediate tray 86 according to the stack amount of the intermediate tray 86.
The printing device 11 may be configured to print on an elongate medium (for example, roll paper) fed from a roll and include a cutter that cuts the print medium at predetermined lengths. The medium is not limited to a paper sheet such as a roll paper, and may be an elongate fabric. The printing device 11 may be, for example, a textile printing device that performs printing on the medium M formed of the elongate fabric. When the stacker to which the discharge destination of the medium M is discharged after cutting is to be switched from the first stacker ST1 to the second stacker ST2, the order of the print data PD for each page may be rearranged to the order for the second stacker ST2. In this case, the stacker to which the discharge destination may be switched every time the roll is switched. The stack amount when a detection section that detects roll replacement detects roll replacement may be set to a threshold that is smaller than the maximum amount of the stack amount of the first stacker ST1. In this way, the threshold may be a variable value that changes according to the detection result of the detection section. Further, the threshold may be set by the user selecting from among options or inputting a numerical value using the operation section 17.
The medium M is not limited to paper sheet or the like, and may be an envelope, board paper, fabric, a synthetic resin film, a laminate medium, or the like.
The printing device 11 is not limited to a serial printer or a line printer. For example, a lateral type printer in which a carriage constituting the printing section 20 is movable in two directions of the main scanning direction and the sub-scanning direction may be used. The printing device 11 may be a page printer.
The printing device 11 is not limited to an inkjet printing device. The printing device 11 may be an electrophotographic type such as a laser printer, a dot impact type, a thermal transfer type, or the like. Hereinafter, technical ideas grasped from the above described embodiment and the modified examples will be described together with effects.

[1] A printing device includes a printing section configured to perform printing on a medium; a transport section configured to transport the medium in a transport direction; a first stacker that is provided downstream of the printing section in the transport direction and to which the medium is discharged in a state where one surface of the medium faces upward; and a second stacker that is provided downstream of the printing section in the transport direction and to which the medium is discharged in a state where an other surface, which is a surface opposite to the one surface, faces upward, wherein assuming that in a case of double-sided printing, among the surfaces of the medium, a surface to be printed first is a first surface and a surface to be printed later is a second surface and assuming that in a case where a discharge destination of the medium is the first stacker, a page to be printed on the first surface is a first page, and a page to be printed on the second surface is a second page, then when the discharge destination of the medium is switched from the first stacker to the second stacker during printing, with respect to the medium that is to be discharged to the second stacker, a page to be printed on the first surface is set to the second page and a page to be printed on the second surface is set to the first page.

According to this configuration, the medium bundle discharged to the first stacker and the medium bundle discharged to the second stacker can be aligned. Therefore, even when the stacker of the discharge destination to which the medium is discharged is switched, the workability of the user can be improved.

[2] The printing device includes a printing section configured to perform printing on a medium; a transport section configured to transport the medium in a transport direction; a first stacker that is provided downstream of the printing section in the transport direction and to which the medium is discharged in a state where one surface of the medium faces upward; and a second stacker that is provided downstream of the printing section in the transport direction and to which the medium is discharged in a state where an other surface, which is a surface opposite to the one surface, faces upward, wherein assuming that in a case of double-sided printing, among the surfaces of the medium, a surface to be printed first is a first surface and a surface to be printed later is a second surface and assuming that in a case where a discharge destination of the medium is the first stacker, a page to be printed on the first surface is a first page, and a page to be printed on the second surface is a second page, then when the discharge destination of the medium is switched from the first stacker to the second stacker during printing, with respect to the medium that is to be discharged to the second stacker, a printing order is set in a descending order from a last page of all of the medium, and also a page to be printed on the first surface is set to the first page and a page to be printed on the second surface is set to the second page.

According to this configuration, the medium bundle discharged to the first stacker and the medium bundle discharged to the second stacker can be aligned. For example, when one of the medium bundle discharged to the first stacker and the medium bundle discharged to the second stacker is inverted and stacked, the two medium bundles can be aligned. Therefore, even when the stacker of the discharge destination to which the medium is discharged is switched, the workability of the user can be improved.

[3] In the printing device according to [1] or [2] may be such that Before the switching of the discharge destination of the medium from the first stacker to the second stacker is determined, print data in a case of discharging to the first stacker may be generated and print data in a case of discharging to the second stacker may be generated.

According to this configuration, since two types of print data are prepared according to each stacker before and after the switching of the discharge destination are prepared, it is possible to shorten the generation time (image processing time) of the print data corresponding to the stacker of the switching destination during printing. Therefore, the stacker to which the discharge destination can be smoothly switched.

[4] In the printing device according to any one of [1] to [3] may be such that when the switching of the discharge destination of the medium from the first stacker to the second stacker is determined, print data in a case of discharging the medium to the second stacker is generated.

According to this configuration, since the print data is generated only in a case of the switching is performed, it is possible to simplify the process before printing.

[5] In the printing device according to any one of [1] to [4] may further include a detection section configured to detect a stack amount of the first stacker, wherein when the detection section detects that the stack amount of the first stacker is equal to or greater than a threshold during printing, the discharge destination of the medium is switched from the first stacker to the second stacker.

According to this configuration, there is a concern that the medium may overflows from the first stacker when continuously used even when it is full, but it is possible to suppress that.

[6] In the printing device according to [5] may be such that the threshold is smaller than a maximum amount that the first stacker is configured to have stacked thereon and with respect to the medium on which the first page is printed on the first surface before it is detected that the stack amount becomes equal to or greater than the threshold, the second page is printed on a second surface.

According to this configuration, since the first stacker is detected to be full in a state where there is a margin, it is possible to suppress waste of the medium by discharging the medium on which printing has already been started as they are.

[7] In the printing device according to [6] may be such that when the last medium among the medium on which the first page is printed on the first surface passes through a branch position of a first path to the first stacker and a second path to the second stacker after it is detected that the stack amount is equal to or greater than the threshold, then the first stacker is switched to the second stacker.

According to this configuration, since the first stacker is detected to be full in a state where there is a margin, it is possible to suppress waste of the medium by leaving the medium on which printing has already been started as they are. When the medium that should be discharged to the first stacker passes the branch position, the stacker of the discharge destination is switched, and thus, the medium on which printing has already been started at the time of detection can be reliably discharged to the first stacker.

[8] In the printing device according to any one of [1] to [7] may further includes a control section configured to, when the discharge destination of the medium is switched from the first stacker to the second stacker during printing, set the page to be printed on the first surface to the second page and set the page to be printed on the second surface to the first page.

According to this configuration, in order to switch the stacker, the control section performs the setting change for rearranging the order of the pages to be printed on the first surface and the pages to be printed on the second surface. Therefore, compared to a configuration in which an external device changes the setting, the time required for communication can be saved. Therefore, it is easy to more quickly switch the stacker of the discharge destination.

[9] A printing device includes a printing section configured to perform printing on a medium; a transport section configured to transport the medium in a transport direction; a first stacker that is provided downstream of the printing section in the transport direction and to which the medium is discharged in a state where one surface of the medium faces upward; a second stacker that is provided downstream of the printing section in the transport direction and to which the medium is discharged in a state where an other surface, which is a surface opposite to the one surface, faces upward; and an inversion path that is provided downstream of the printing section in the transport direction and that is configured to invert the front and back of the medium, wherein assuming that in single-sided printing, a surface to be printed on is a first surface, then when the discharge destination of the medium is switched from the first stacker to the second stacker during printing, the medium that is to be discharged to the second stacker is set to be, after the first surface is printed on, transported to the inversion path and then discharged.

According to this configuration, the medium bundle discharged to the first stacker and the medium bundle discharged to the second stacker can be aligned. Therefore, even when the stacker of the discharge destination to which the medium is discharged is switched, the workability of the user can be improved.

[10] In the printing device according to [9] may be such that assuming that a transport speed in a case of printing on the first surface is a first speed and a transport speed in the inversion path is a second speed, then the second speed is higher than the first speed.

According to this configuration, although the path length is increased by the amount by which the medium passes through the inversion path, it is possible to suppress a decrease in work efficiency by increasing the transport speed.

[11] In the printing device according to [9] or may be such that a detection section configured to detect a stack amount of the first stacker, wherein when the detection section detects that the stack amount of the first stacker is equal to or greater than a threshold during printing, the discharge destination of the medium is switched from the first stacker to the second stacker.

According to this configuration, there is a concern that the medium may overflows from the first stacker when continuously used even when it is full, but it is possible to suppress that.

[12] In the printing device according to any one of [9] to [11] may further includes a control section configured to, when a discharge destination of the medium is switched from the first stacker to the second stacker during printing, set the medium so as to be transported to the inversion path and then discharged after the first surface is printed on.

According to this configuration, in order to switch the stacker, the control section performs a setting change in which the medium M are transported to the inversion path and then discharged after printing is performed on the first surface. Therefore, compared to a configuration in which an external device changes the setting, the time required for communication can be saved. Therefore, it is easy to more quickly switch the stacker of the discharge destination.

[13] In the printing device according to any one of [1] to [12] may be such that in the first stacker and the second stacker, a discharge direction of the medium is in opposite directions and when the discharge destination of the medium is switched from the first stacker to the second stacker, an orientation of print data is maintained with respect to the medium that is to be discharged to the second stacker.

According to this configuration, the orientations of the pages are aligned only by switching the first page and the second page to be printed on the first surface P1 and the second surface P2, without reversing the orientations of the print data, and thus, it is possible to easily perform the work of aligning the medium bundle.

[14] In the printing device according to any one of [1] to [13] may further include a detection section configured to detect a jam of the medium, wherein the transport section includes a transport path through which the medium is transported, The transport section includes, in a downstream position of the printing section in the transport direction in the transport path, the first path that discharges the medium to the first stacker, the second path that discharges the medium to the second stacker, and the path selection member that selects one of the first path and the second path as a discharge destination of the medium at a branch position of the first path and the second path, and when a jam is detected during printing and it is detected that the jammed medium passed the branch position, the discharge destination of the subsequent medium after the jammed medium is switched from the first stacker to the second stacker.

According to this configuration, by switching in a case of there is an abnormality in the first stacker, it is possible to continue printing of one job without stopping the operation of the device.

[15] In the printing device according to any one of [1] to [14] may further include a detection section configured to detect an abnormality of the first stacker, wherein when an abnormality of the first stacker is detected during printing, the discharge destination of the medium is switched from the first stacker to the second stacker.

According to this configuration, by switching the stacker of the discharge destination in a case of there is an abnormality in the first stacker, it is possible to continue printing of one job without stopping the operation of the device.

[16] In the printing device according to any one of [1] to [15] may further include a notification section configured to notify that the discharge destination is to be switched.

According to this configuration, since the switching of the discharge destination can be known by the notification, the workability of the user can be improved.

What is claimed is:

1. A printing device comprising:
a printing section configured to perform printing on a medium;
a transport section configured to transport the medium in a transport direction;
a first stacker that is provided downstream of the printing section in the transport direction and to which the medium is discharged in a state where one surface of the medium faces upward; and
a second stacker that is provided downstream of the printing section in the transport direction and to which the medium is discharged in a state where an other surface, which is a surface opposite to the one surface, faces upward, wherein
assuming that in a case of double-sided printing, among the surfaces of the medium, a surface to be printed first is a first surface and a surface to be printed later is a second surface and
assuming that in a case where a discharge destination of the medium is the first stacker, a page to be printed on the first surface is a first page, and a page to be printed on the second surface is a second page, then
when the discharge destination of the medium is switched from the first stacker to the second stacker during printing, with respect to the medium that is to be discharged to the second stacker, a page to be printed on the first surface is set to the second page and a page to be printed on the second surface is set to the first page.

2. A printing device comprising:
a printing section configured to perform printing on a medium;
a transport section configured to transport the medium in a transport direction;
a first stacker that is provided downstream of the printing section in the transport direction and to which the medium is discharged in a state where one surface of the medium faces upward; and
a second stacker that is provided downstream of the printing section in the transport direction and to which the medium is discharged in a state where an other surface, which is a surface opposite to the one surface, faces upward, wherein
assuming that in a case of double-sided printing, among the surfaces of the medium, a surface to be printed first is a first surface and a surface to be printed later is a second surface and
assuming that in a case where a discharge destination of the medium is the first stacker, a page to be printed on the first surface is a first page, and a page to be printed on the second surface is a second page, then
when the discharge destination of the medium is switched from the first stacker to the second stacker during printing, with respect to the medium that is to be discharged to the second stacker, a printing order is set in a descending order from a last page of all of the medium, and also a page to be printed on the first surface is set to the first page and a page to be printed on the second surface is set to the second page.

3. The printing device according to claim 1, wherein
before the switching of the discharge destination of the medium from the first stacker to the second stacker is determined, print data in a case of discharging to the first stacker is generated, and print data in a case of discharging to the second stacker is generated.

4. The printing device according to claim 1, wherein
when the switching of the discharge destination of the medium from the first stacker to the second stacker is determined, print data in a case of discharging the medium to the second stacker is generated.

5. The printing device according to claim 1, further comprising:
a detection section configured to detect a stack amount of the first stacker, wherein
when the detection section detects that the stack amount of the first stacker is equal to or greater than a threshold during printing, the discharge destination of the medium is switched from the first stacker to the second stacker.

6. The printing device according to claim 5, wherein
the threshold is smaller than a maximum amount that the first stacker is configured to have stacked thereon and
with respect to the medium on which the first page is printed on the first surface before it is detected that the stack amount becomes equal to or greater than the threshold, the second page is printed on a second surface.

7. The printing device according to claim 6, wherein
when the last medium among the medium on which the first page is printed on the first surface passes through a branch position of a first path to the first stacker and a second path to the second stacker after it is detected that the stack amount is equal to or greater than the threshold, then the first stacker is switched to the second stacker.

8. The printing device according to claim 1, further comprising:
a control section configured to, when the discharge destination of the medium is switched from the first stacker to the second stacker during printing, set the page to be printed on the first surface to the second page and set the page to be printed on the second surface to the first page.

9. A printing device comprising:
a printing section configured to perform printing on a medium;
a transport section configured to transport the medium in a transport direction;
a first stacker that is provided downstream of the printing section in the transport direction and to which the medium is discharged in a state where one surface of the medium faces upward;
a second stacker that is provided downstream of the printing section in the transport direction and to which the medium is discharged in a state where an other surface, which is a surface opposite to the one surface, faces upward; and
an inversion path that is provided downstream of the printing section in the transport direction and that is configured to invert the front and back of the medium, wherein
assuming that in single-sided printing, a surface to be printed on is a first surface, then
when the discharge destination of the medium is switched from the first stacker to the second stacker during printing, the medium that is to be discharged to the second stacker is set to be, after the first surface is printed on, transported to the inversion path and then discharged.

10. The printing device according to claim 9, wherein
assuming that a transport speed in a case of printing on the first surface is a first speed and a transport speed in the inversion path is a second speed, then
the second speed is higher than the first speed.

11. The printing device according to claim 9, further comprising:
a detection section configured to detect a stack amount of the first stacker, wherein
when the detection section detects that the stack amount of the first stacker is equal to or greater than a threshold during printing, the discharge destination of the medium is switched from the first stacker to the second stacker.

12. The printing device according to claim 9, further comprising:
a control section configured to, when a discharge destination of the medium is switched from the first stacker to the second stacker during printing, set the medium so as to be transported to the inversion path and then discharged after the first surface is printed on.

13. The printing device according to claim 1, wherein
in the first stacker and the second stacker, a discharge direction of the medium is in opposite directions and
when the discharge destination of the medium is switched from the first stacker to the second stacker, an orientation of print data is maintained with respect to the medium that is to be discharged to the second stacker.

14. The printing device according to claim 1, further comprising:
a detection section configured to detect a jam of the medium, wherein
the transport section includes a transport path through which the medium is transported,
the transport section includes, at a position in the transport path that is downstream from the printing section in the transport direction, a first path configured to discharge the medium to the first stacker, a second path configured to discharge the medium to the second stacker, and a path selection member configured to select one of the first path and the second path as a discharge destination of the medium at a branch position of the first path and the second path, and
when a jam is detected during printing and it is detected that the jammed medium passed the branch position, the discharge destination of the subsequent medium after the jammed medium is switched from the first stacker to the second stacker.

15. The printing device according to claim 1, further comprising:
a detection section configured to detect an abnormality of the first stacker, wherein
when an abnormality of the first stacker is detected during printing, the discharge destination of the medium is switched from the first stacker to the second stacker.

16. The printing device according to claim 1, further comprising:
a notification section configured to notify that the discharge destination is to be switched.
